(19) United States
(12) Patent Application Publication
(10) Pub. No.: US 2002/0049638 A1
(43) Pub. Date: Apr. 25, 2002

(54) Consumable goods online shopping system, portal server, electronic settlement server, mail order center server, recycling plant server, or server, and consumable goods online shopping method and program, and recording medium

(76) Inventor: Tatsuo Ito, Tokyo (JP)

Correspondence Address: FITZPATRICK CELLA HARPER & SCINTO, 30 ROCKEFELLER PLAZA, NEW YORK, NY, 10112, US

(21) Appl. No.: 09/893,211

(22) Filed: Jun. 28, 2001

(30) Foreign Application Priority Data
Jun. 30, 2000 (JP) 199569/2000
Jun. 20, 2001 (JP) 187241/2001

(51) Int. Cl. G06F 17/60

(52) U.S. Cl. 705/26

(57) ABSTRACT

This mechanism monitors status of use of consumable goods used in a printing device, applies a discount service in accordance with the status of use to the consumable goods at a predetermined Web sale, and pays compensation to a trader that is managing the predetermined Web sale.

### BACKGROUND OF THE INVENTION

1. Field of the Invention

The present invention relates to a consumable goods online shopping system that online performs an order of consumable goods in accordance with the configuration between communication information equipment that can detect the remaining quantity of the consumable goods and various servers connected via a network a portal server, an electronic settlement server, a mail order center server, a recycling plant server, or a server, and a consumable goods online shopping method and program, and a recording medium.

2. Related Background Art

Up to this date, in the technical field of this kind, for the electronic equipment provided with a print function, such as a printer, a facsimile machine, and a copying machine, the processing in which the remaining quantity of consumable goods, such as ink or toner, is detected and error messages, such as a remaining quantity alarm and a remaining quantity error are reported to the user has been executed.

Upon receipt of this notification, the user has purchased the consumable goods by going to a store or order them from it by telephone.

In recent years, with the spread of the Internet, an online shopping purchase form via a network has been increasing, and it is estimated that online services that use the Internet will further be increasing.

In consideration of such flow of art, in the technical field to which the present invention belongs, it is considered that how advantages of the user and a company will be gained when online services are used is becoming the central problem of the future technical development.

Up to this date, as the prior art regarding the purchase of consumable goods, a mechanism that eliminates the need for work, such as a type number check in the purchase of the consumable goods, has been disclosed.

For example, when the remaining quantity of ink that is the consumable goods of printing means and is judged smaller than the predetermined value, the ink in an ink cartridge is assumed insufficient. A mechanism of which the purpose is to allow the user to order the consumable goods and easily purchase the consumable goods without troublesome work by printing a form to which consumable goods information, such as the type number of the ink cartridge, is entered and only entering the number of items to be ordered in the form has been disclosed.

Further, a mechanism of being able to read the consumable goods information stored in a server and always being able to acquire the latest order table from a supplier of the consumable goods by sending a message containing identification information that specifies the ink cartridge to the supplier server of the consumable goods via a network immediately before the ink of the ink cartridge is exhausted has been disclosed.

Moreover, a mechanism of also being able to online order the consumable goods by using the configuration in which the order table is displayed on the display and order data is transferred over the network has been disclosed.

### SUMMARY OF THE INVENTION

However, in the past, only the problem that how the user's labor that occurs in the purchase of consumable goods is saved was solved, and, for example, a mechanism in which each advantage of the user, a wholesaler (manufacturer), and a retail store is considered was not supposed.

The present invention is performed in consideration of the above problems, and an object of the present invention is to provide a mechanism so that each of the user, wholesaler (manufacturer), and retail store can obtain the advantage. A consumable goods online shopping system that comprises communication information equipment that interconnects via a network and consumes the consumable goods, a portal server to which data is sent from the communication information equipment, an electronic settlement server that performs the settlement of the transaction performed in the communication information equipment, a mail order center server for mail-ordering the consumable goods, a recycling plant server installed in the recycling plant of the consumable goods, and a merchandise control center server installed in the merchandise control center of the consumable goods that interconnect via a network are is provided, wherein the communication information equipment comprises first information processing means that performs the processing of various information in the communication information equipment, first screen display means that displays information-processed information on the screen, first input means that inputs information necessary for information processing, first printing means that prints information-processed contents, first communicating means that communicates the information-processed contents through the network, first consumable goods consumption executing means that executes the processing which consumes the consumable goods, and first consumable goods remaining quantity detecting means that detects the remaining quantity of the consumable goods, the portal server comprises second information processing means that performs the processing of various information in the portal server, second screen display means that displays information-processed information on the screen, second input means that inputs information necessary for information processing, second printing means that prints information-processed contents, second communicating means that communicates the information-processed contents via the network, a second mail address database in which the mail address of the communication information equipment connected to the portal server and recovery cartridge information are stored, a second delivery store database in which delivery stores of the consumable goods are stored for each area, a second mail order center registration information database in which the information of the mail order center that is connected to the portal server and from which the order issue of the consumable goods is given, and a second consumable goods price database in which individual merchandise price information is stored for each mail order center, the electronic settlement server comprises third information processing means that performs an electronic settlement based the authentication information input from the first input means on the communication information equipment, third screen display means that displays information-processed information, third input means that inputs information necessary for information processing, third printing means that prints information-processed contents, third communicating means for communicating information necessary for performing the electronic settlement, and a third electronic settlement database in which data necessary for performing the electronic settlement is stored, the mail order center server comprises fourth information means that performs processing of various information in the mail order center server, fourth screen display means that displays information-processed information on the screen, fourth input means that inputs information necessary for information processing, fourth printing means that prints information-processed contents, fourth communicating means that communicates the information-processed contents via the network, a fourth merchandise database in which the data of merchandise necessary for receiving a mail order including the price and the stock quantity of the consumable goods controlled in a mail order center, a fourth customer control database in which the customer information of a customer of which the order request is given, and a fourth order table database for storing the order table to which an order is given, the recycling plant server comprises fifth information processing means that performs processing of various information in a recycling plant server, fifth screen display means that displays that displays information-processed information on the screen, fifth input means that inputs information necessary for information processing, fifth printing means that prints information-processed contents, fifth communicating means that communicates the information-processed contents via the network, a fifth cartridge information reader that reads the owner information stored in the storage area of the cartridge recovered in the recycling plant, and a fifth owner information management database in which the number of recovered cartridges and the owner information are linked and stored, and the merchandise control center server comprises sixth information processing means that performs processing of various information in the merchandise control center server, sixth screen display means that displays information-processed information on the screen, sixth input means that inputs information necessary for information processing, sixth printing means that prints information-processed contents, sixth communicating means that communicates the information-processed contents via the network, and a sixth merchandise inventory control database in which the merchandise inventory control information of the consumable goods is recorded.

Otherwise, a portal server to which data is sent from the communication information equipment that is connected to communication information equipment which consumes consumable goods, an electronic settlement server that performs the settlement of the transaction performed in the communication information equipment, a mail order center server for mail-ordering the consumable goods, a recycling plant server installed in the recycling plant of the consumable goods, and a merchandise control center server installed in the merchandise control center of the consumable goods via a network is provided, wherein it comprises information processing means that performs processing of various information in a portal server, screen display means that displays information-processed information on the screen, input means that inputs information necessary for information processing, printing means that prints information-processed contents, communicating means that communicates the information-processed contents via the network, a mail address database in which a mail address of the communication information equipment connected to the portal server and recovery cartridge information are stored, a delivery store database in which delivery stores of the consumable goods are stored for each area, a mail order center registration information database in which the information of the mail order center connected to the portal server and from which the consumable goods are ordered is stored, and a consumable goods price database in which individual merchandise price information is stored for each mail order center.

Otherwise, the information processing means provides the portal server according to claim 2, comprising mail address notification means that receives a mail address acquisition request issued by mail address automatic registering means of communication information equipment, retrieves the mail address database, allocates an unregistered empty mail address as the mail address of the requested communication information equipment, and reports it, and

automatic mail address allocation means that automatically allocates the empty mail address and empty mail address retrieval means for supporting allocation by a portal server administrator regarding the allocation of the mail address.

Otherwise, a mail order center server for mail-ordering the consumable goods that is connected to communication information equipment that consumes the consumable goods, a portal server to which data is sent from the communication information equipment, an electronic settlement server that performs the settlement of a transaction performed in the communication information equipment, a recycling plant server installed in a recycling plant of the consumable goods, and a merchandise control center server installed in a merchandise control center of the consumable goods is provided, wherein it comprises information processing means that performs processing of various information in the mail order center server, screen display means information-processed information on the screen, input means that inputs information necessary for information processing, printing means that prints information-processed contents, communicating means that communicates the information-processed contents via a network, a merchandise database in which the data of merchandise necessary for receiving a mail order including the price and the stock quantity controlled in the mail order center, a customer management database in which the customer information of a customer of which the order request is given, and a fourth order table database for storing an order table to which an order is given.

Otherwise, a recycling plant server installed in the recycling plant of the consumable goods that is connected to communication information equipment which consumes the consumable goods, a portal server to which data is sent from the communication equipment, an electronic settlement server that performs the settlement of the transaction performed in the communication information equipment, a mail order center server for mail-ordering the consumable goods, and a merchandise control center installed in the merchandise control center of the consumable goods through a network is provided, wherein it comprises information processing means that performs the processing of various information in a recycle plant server, screen display means that displays information-processed information on the screen, input means that inputs the information necessary for information processing, printing means that prints the information-processed contents, communicating means that communicates the information-processed contents via the network, cartridge information reader that reads the owner information stored in the storage area of the cartridge recovered in the recycle plant, and an owner information management database in which the number of recovery cartridges and owner information are linked and stored.

Otherwise, a server that manages status of use of consumable goods a first consumable goods trader who handles the consumable goods is provided, wherein it comprises calculating means that receives the status of use of the consumable goods used in the printer via the predetermined communication line and calculates a point for a customer in accordance with the received status of use and compensation deciding means that decides compensation based on a reduced price that is paid to a second consumable goods trader in accordance with the fact that the customer purchases the merchandise the second consumable goods trader provides via the predetermined purchase screen at the reduced price based on the point.

Another object and feature of the present invention will be evident from the following specifications and drawings.

### BRIEF DESCRIPTION OF THE DRAWINGS

FIG. 1 is a block diagram of an example of a consumable goods online shopping system according to the present invention;

FIG. 2 is a block diagram of an example of another consumable goods online shopping system according to the present invention;

FIG. 3 is a block diagram of an example of another consumable goods online shopping system according to the present invention;

FIG. 4 is a block diagram of an example of another consumable goods online shopping system according to the present invention;

FIG. 5 is a block diagram of an example of another consumable goods online shopping system according to the present invention;

FIG. 6 is a block diagram of an example of another consumable goods online shopping system according to the present invention;

FIG. 7 is a block diagram of an example of another consumable goods online shopping system according to the present invention;

FIG. 8 is a block diagram of an example of another consumable goods online shopping system according to the present invention;

FIG. 9 is a block diagram of an example of another consumable goods online shopping system according to the present invention;

FIG. 10 is a block diagram of an example of another consumable goods online shopping system according to the present invention;

FIG. 11 is a block diagram of an example of another consumable goods online shopping system according to the present invention;

FIG. 12 is a block diagram of an example of another consumable goods online shopping system according to the present invention;

FIG. 13 is a block diagram of an example of another consumable goods online shopping system according to the present invention;

FIG. 14 is a block diagram of an example of another consumable goods online shopping system according to the present invention;

FIG. 15 is a block diagram of an example of another consumable goods online shopping system according to the present invention;

FIG. 16 is a block diagram of an example of another consumable goods online shopping system according to the present invention;

FIG. 17 is a block diagram of an example of another consumable goods online shopping system according to the present invention;

FIG. 18 is a block diagram of an example of another consumable goods online shopping system according to the present invention;

FIG. 19 is a block diagram of an example of another consumable goods online shopping system according to the present invention;

FIG. 20 is a block diagram of an example of another consumable goods online shopping system according to the present invention;

FIG. 21 is a block diagram of an example of another consumable goods online shopping system according to the present invention;

FIG. 22 is a block diagram of an example of another consumable goods online shopping system according to the present invention;

FIG. 23 is a block diagram of an example of another consumable goods online shopping system according to the present invention;

FIG. 24 is a block diagram of an example of another consumable goods online shopping system according to the present invention;

FIG. 25 is a block diagram of an example of another consumable goods online shopping system according to the present invention;

FIG. 26 is a block diagram of an example of another consumable goods online shopping system according to the present invention;

FIG. 27 is a block diagram of an example of another consumable goods online shopping system according to the present invention;

FIG. 28 is a block diagram of an example of another consumable goods online shopping system according to the present invention;

FIG. 29 is a block diagram of an example of another consumable goods online shopping system according to the present invention;

FIG. 30 is a block diagram of an example of another consumable goods online shopping system according to the present invention;

FIG. 31 is a block diagram of an example of another consumable goods online shopping system according to the present invention;

FIG. 32 is a block diagram of an example of another consumable goods online shopping system according to the present invention;

FIG. 33 is a block diagram of an example of another consumable goods online shopping system according to the present invention;

FIG. 34 is a block diagram of an example of another consumable goods online shopping system according to the present invention;

FIG. 35 is a block diagram of an example of another consumable goods online shopping system according to the present invention;

FIG. 36 is a block diagram of an example of another consumable goods online shopping system according to the present invention;

FIG. 37 is a block diagram of an example of another consumable goods online shopping system according to the present invention;

FIG. 38 is a block diagram of an example of another consumable goods online shopping system according to the present invention;

FIG. 39 is a block diagram of an example of another consumable goods online shopping system according to the present invention;

FIG. 40 is a block diagram of an example of another consumable goods online shopping system according to the present invention;

FIG. 41 is a block diagram of an example of another consumable goods online shopping system according to the present invention;

FIG. 42 is a block diagram of an example of another consumable goods online shopping system according to the present invention;

FIG. 43 is a block diagram of an example of another consumable goods online shopping system according to the present invention;

FIG. 44 is a block diagram of an example of another consumable goods online shopping system according to the present invention;

FIG. 45 is a block diagram of an example of another consumable goods online shopping system according to the present invention;

FIG. 46 is a schematic block diagram of embodiment 1 of the consumable goods online shopping system according to the present invention;

FIG. 47 is an operation concept diagram of the initialization processing of the system show in FIG. 46;

FIG. 48 is the operation concept diagram of the order start processing of the system shown in FIG. 46;

FIG. 49 is the operation concept diagram of the order table creation processing of the system shown in FIG. 46;

FIG. 50 is the operation concept diagram of the order issue processing of the system shown in FIG. 46;

FIG. 51 is the operation concept diagram of the received order processing of the system shown in FIG. 46;

FIG. 52 is the operation concept diagram of the order conveyance processing of the system shown in FIG. 46;

FIG. 53 is the operation concept diagram of the settlement processing of the system shown in FIG. 46;

FIG. 54 is the operation concept diagram of the recovery cartridge information registration processing of the system shown in FIG. 46;

FIG. 55 is an operation flowchart of embodiment 2 of the consumable goods online shopping system according to the present invention;

FIG. 56 is an operation flowchart of another embodiment 2 of the consumable goods online shopping system according to the present invention;

FIG. 57 is an operation flowchart of another embodiment 2 of the consumable goods online shopping system according to the present invention;

FIG. 58 is an operation flowchart of another embodiment 2 of the consumable goods online shopping system according to the present invention;

FIG. 59 is an operation flowchart of another embodiment 2 of the consumable goods online shopping system according to the present invention;

FIG. 60 is an operation flowchart of another embodiment 2 of the consumable goods online shopping system according to the present invention;

FIG. 61 is an operation flowchart of embodiment 3 of the consumable goods online shopping system according to the present invention;

FIG. 62 is an operation flowchart of another embodiment 3 of the consumable goods online shopping system according to the present invention;

FIG. 63 is an operation flowchart of another embodiment 3 of the consumable goods online shopping system according to the present invention;

FIG. 64 is an operation flowchart of another embodiment 3 of the consumable goods online shopping system according to the present invention;

FIG. 65 is an operation flowchart of embodiment 4 of the consumable goods online shopping system according to the present invention;

FIG. 66 is an operation flowchart of another embodiment 4 of the consumable goods online shopping system according to the present invention;

FIG. 67 is an operation flowchart of another embodiment 4 of the consumable goods online shopping system according to the present invention;

FIG. 68 is an operation flowchart of embodiment 5 of the consumable goods online shopping system according to the present invention;

FIG. 69 is an operation flowchart of another embodiment 5 of the consumable goods online shopping system according to the present invention;

FIG. 70 is an operation flowchart of another embodiment 5 of the consumable goods online shopping system according to the present invention;

FIG. 71 is an operation flowchart of embodiment 6 of the consumable goods online shopping system according to the present invention;

FIGS. 72A, 72B, 72C and 72D are operation flowcharts of another embodiment 6 of the consumable goods online shopping system according to the present invention;

FIG. 73 is an operation flowchart of another embodiment 6 of the consumable goods online shopping system according to the present invention;

FIG. 74 is an operation flowchart of another embodiment 6 of the consumable goods online shopping system according to the present invention;

FIG. 75 is an operation flowchart of embodiment 7 of the consumable goods online shopping system according to the present invention;

FIG. 76 is an operation flowchart of another embodiment 7 of the consumable goods online shopping system according to the present invention;

FIG. 77 is an operation flowchart of another embodiment 7 of the consumable goods online shopping system according to the present invention;

FIG. 78 is an operation flowchart of another embodiment 7 of the consumable goods online shopping system according to the present invention;

FIG. 79 is an operation flowchart of embodiment 8 of the consumable goods online shopping system according to the present invention;

FIG. 80 is an operation flowchart of embodiment 9 of the consumable goods online shopping system according to the present invention;

FIG. 81 is an operation flowchart of another embodiment 9 of the consumable goods online shopping system according to the present invention;

FIG. 82 is an operation flowchart of another embodiment 9 of the consumable goods online shopping system according to the present invention;

FIG. 83 is an operation flowchart of another embodiment 9 of the consumable goods online shopping system according to the present invention;

FIG. 84 is an operation flowchart of another embodiment 9 of the consumable goods online shopping system according to the present invention;

FIG. 85 is an operation flowchart of another embodiment 9 of the consumable goods online shopping system according to the present invention;

FIG. 86 is an operation flowchart of another embodiment 9 of the consumable goods online shopping system according to the present invention;

FIG. 87 is an operation flowchart of another embodiment 9 of the consumable goods online shopping system according to the present invention;

FIG. 88 is an operation flowchart of another embodiment 9 of the consumable goods online shopping system according to the present invention;

FIG. 89 is an operation flowchart of embodiment 10 of the consumable goods online shopping system according to the present invention;

FIG. 90 is an operation flowchart of another embodiment 10 of the consumable goods online shopping system according to the present invention;

FIG. 91 is an operation flowchart of another embodiment 10 of the consumable goods online shopping system according to the present invention;

FIG. 92 is an operation flowchart of embodiment 11 of the consumable goods online shopping system according to the present invention;

FIG. 93 is an operation flowchart of another embodiment 11 of the consumable goods online shopping system according to the present invention;

FIG. 94 is an operation flowchart of another embodiment 11 of the consumable goods online shopping system according to the present invention;

FIG. 95 is an operation flowchart of embodiment 12 of the consumable goods online shopping system according to the present invention;

FIG. 96 is an operation flowchart of another embodiment 12 of the consumable goods online shopping system according to the present invention;

FIG. 97 is an operation flowchart of another embodiment 12 of the consumable goods online shopping system according to the present invention;

FIG. 98 is an operation flowchart of embodiment 13 of the consumable goods online shopping system according to the present invention;

FIG. 99 is an operation flowchart of another embodiment 13 of the consumable goods online shopping system according to the present invention;

FIG. 100 is an operation flowchart of another embodiment 13 of the consumable goods online shopping system according to the present invention;

FIG. 101 is an operation flowchart of embodiment 14 of the consumable goods online shopping system according to the present invention;

FIG. 102 is an operation flowchart of another embodiment 14 of the consumable goods online shopping system according to the present invention;

FIG. 103 is an operation flowchart of another embodiment 14 of the consumable goods online shopping system according to the present invention;

FIG. 104 is an operation flowchart of another embodiment 14 of the consumable goods online shopping system according to the present invention;

FIG. 105 is an operation flowchart of another embodiment 14 of the consumable goods online shopping system according to the present invention;

FIG. 106 is an internal block diagram of communication information equipment used in each embodiment of the consumable goods online shopping system according to the present invention; and

FIG. 107 is a flowchart showing a flow of information between the communication information equipment, a portal server, and a mail order center server in the embodiment 13.

### DETAILED DESCRIPTION OF THE PREFERRED EMBODIMENTS

The structure of the present invention is described using the function block diagrams.

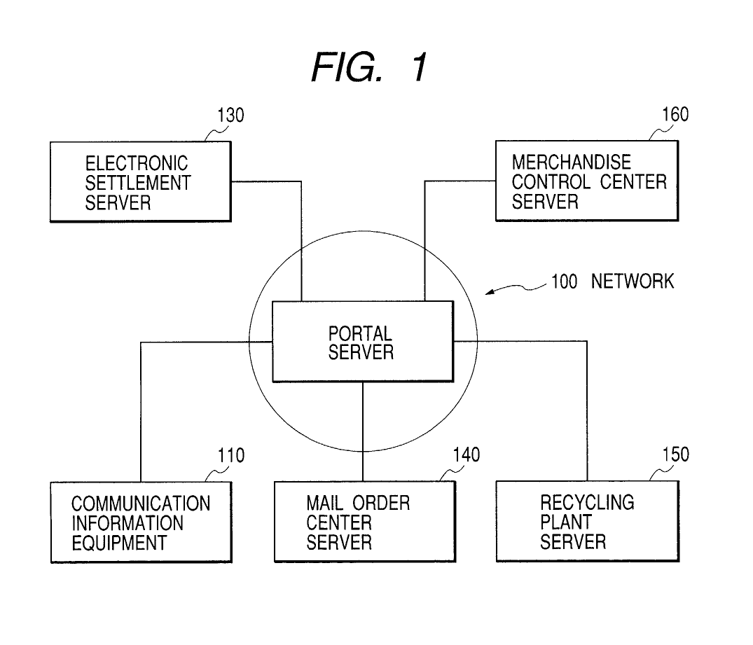

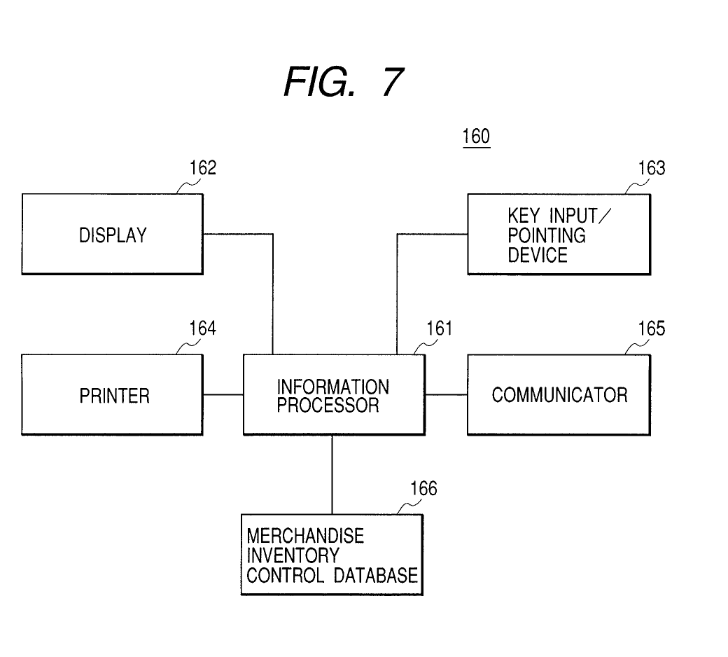

To attain this and other objects, a consumable goods online shopping system according the present invention, for example, as shown in FIG. 1 to FIG. 7, comprises communication information equipment 110 that consumes consumable goods, a portal server 120 to which data is sent from the communication information equipment 110, an electronic settlement server 130 that performs the settlement of the transaction performed in the communication information equipment 110, a mail order center server 140 for mail-ordering the consumable goods, a recycling plant server 150 installed in a recycling plant of the consumable goods, and a merchandise control center server 160 installed in a merchandise control center of the consumable goods that interconnect via a network, wherein the communication information equipment 110 comprises first information processing means 111 that performs processing of various information in the communication information equipment, first screen display means 112 that displays information-processed information on the screen, first key input/pointing means 113 that inputs information necessary for information processing with a key or by a pointing device on the screen, first printing means 114 that prints information-processed contents, first communicating means 115 that communicates the information-processed contents via the network, consumable goods consumption executing means 116 that executes processing which consumes the consumable goods, and first consumable goods remaining quantity detecting means 117 that detects a remaining quantity of the consumable goods, the portal server 120 comprises second information processing means 121 that performs the processing of various information in the portal server 120, second printing means 122 that displays the information-processed information on the screen, second key input/pointing means 123 that inputs the information necessary for information processing with the key or by the pointing device on the screen, second printing means 124 that prints the information-processed contents, second communicating means 125 that communicates the information-processed contents via the network, a second mail address database 126 in which a mail address and recovery cartridge information of the communication information equipment connected to the portal server, a second delivery store database 127 in which delivery stores of the consumable goods are stored for each area, a second mail order center registration information database 128 in which the information of the mail order center that is connected to the portal server and from which the consumable goods are ordered, and a second consumable goods price database 129 in which individual merchandise price information is stored for each mail order center. The electronic settlement server 130 comprises third information processing means 131 that performs an electronic settlement based on authentication information input from the first input means on the communication processing equipment, third screen display means 132 that displays information-processed information, third key input/pointing means 133 that inputs the information necessary for information processing with the key or by the pointing device, third printing means 134 that prints the information-processed contents, third communicating means 135 for communicating the information necessary for the electronic settlement, and a third electronic settlement database 136 in which the data necessary for performing the electronic settlement is stored, the mail order center server 140 comprises fourth information processing means 141 that performs the processing of various information in the mail order center server, fourth screen display means 142 that displays the information-processed information on the screen, fourth key input/pointing means 143 that inputs the information necessary for information processing with the key/by the pointing device on the screen, fourth printing means 144 that prints the information-processed contents, fourth communicating means 145 that communicates the information-processed contents via the network, a fourth merchandise database 146 in which the data of the merchandise necessary for receiving the mail order including the price and the stock quantity of the consumable goods controlled in the mail order center, a fourth customer management database 147 in which the customer information of the customer of which the order request is given, and a fourth order table database 148 for storing the order table to which an order is given. The recycling plant server 150 comprises fifth information processing means 151 that performs the processing of various information in the recycling plant server, fifth screen means 152 that displays the information-processed information on the screen, fifth key input/pointing means 153 that inputs the information necessary for information processing with the key or by the pointing device on the screen, fifth printing means 154 that communicates the information-processed contents, fifth communicating means 155 that communicates the information-processed contents via the network, a fifth cartridge information reader 156 that reads the owner information stored in the storage area of the cartridge that is recovered in the recycling plant, and a fifth owner information management database 157 in which the number of recovery cartridges and the owner information are linked and stored. The merchandise control center server 160 comprises sixth information processing means 161 that performs the processing of various information in the merchandise control center server, sixth screen display means 162 that displays the information-processed information on the screen, sixth key input/pointing means 163 that inputs the information necessary for the information processing with the key or by the pointing device on the screen, sixth printing means 164 that prints the information-processed contents, fifth communicating means 165 that communicates the information-processed contents via the network, and a sixth merchandise inventory control database 166 in which the merchandise inventory control information of the consumable goods is recorded.

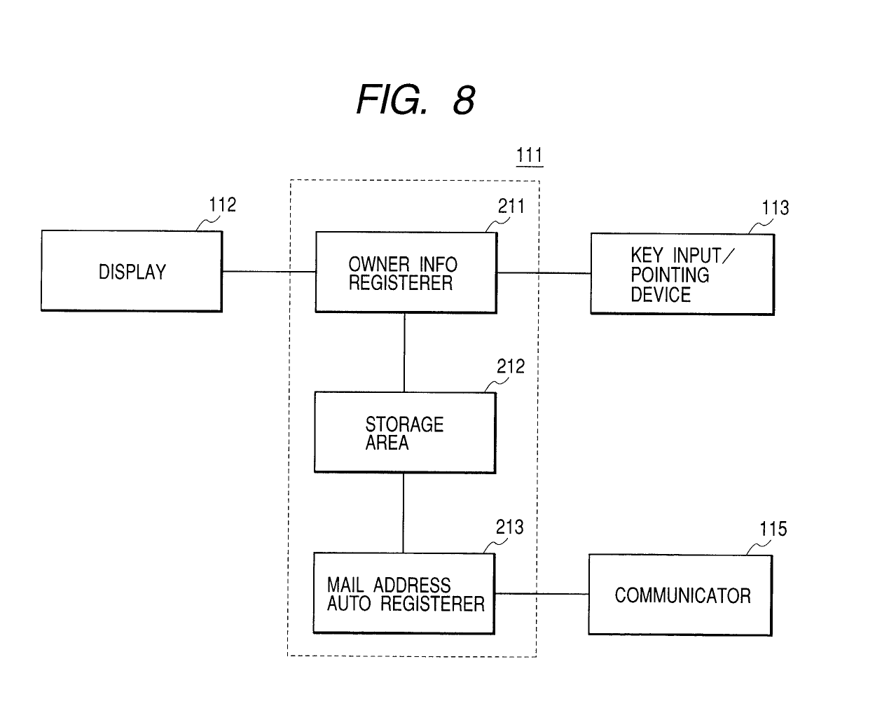

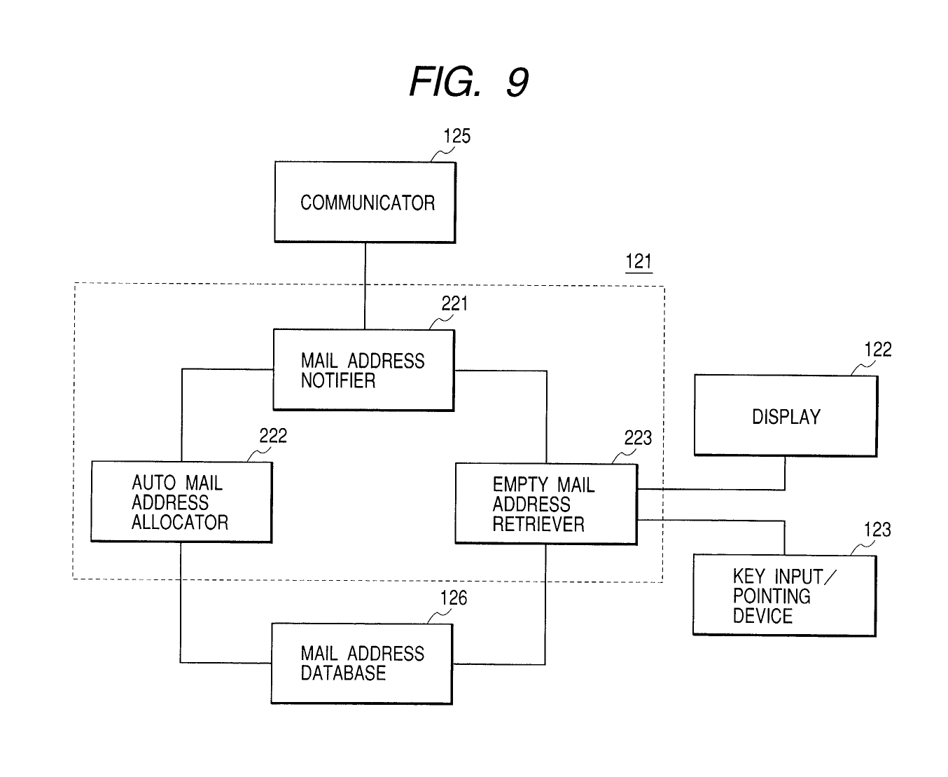

Further, as shown in FIG. 8 and FIG. 9, the information processing means 111 of the communication information equipment comprises owner information registering means 211 that stores the information for identifying an owner including at least any one of a mail address, a postal number, an address, a name, and a telephone number in a storage area 212 as the owner information and mail address automatic registering means 213 that issues a mail address acquisition request to the portal server and automatically registers the mail address allocated and sent from the portal server in the mail address of the owner information by performing automatic connection when the mail address is not registered regarding the mail address. The second information processing means 121 of the portal server comprises mail address notification means 221 that receives the mail address acquisition request issued by the mail address automatic registering means 213 of the communication information equipment, retrieves the second mail address database 126, and allocates and reports an unregistered empty mail address as the mail address of the communication information equipment to which a request is given, automatic mail address allocation means 222 that automatically allocates the empty mail address for the allocation of the mail address, and empty mail address retrieval means 223 for supporting the allocation by the portal server administrator.

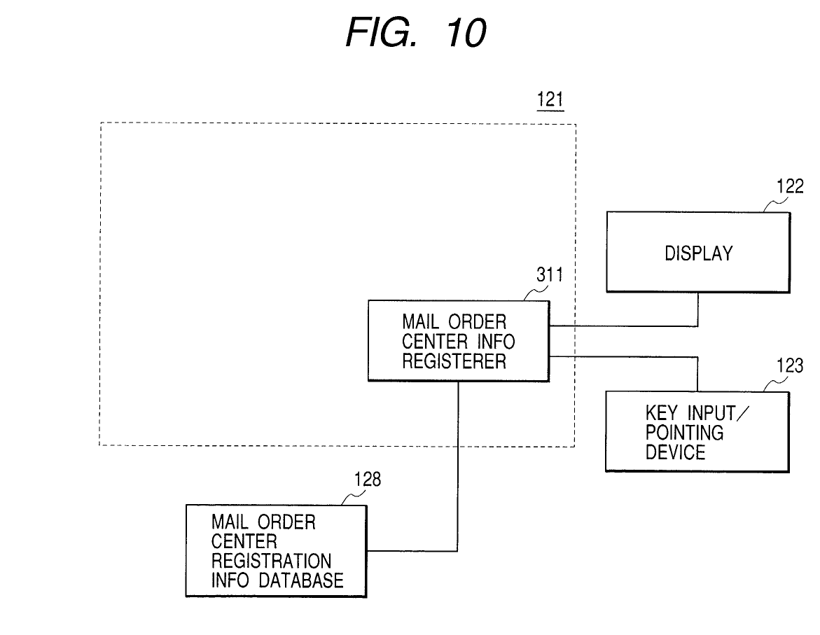

Further, as shown in FIG. 10 to FIG. 12, the second information processing means 121 of the portal server comprises mail order center information registering means 311 that registers the information about an order table order issue destination mail order center by the input of the portal server administrator using the second key input/pointing means 123. The fourth information processing means 141 of the consumable goods mail order center server comprises merchandise data registering means 321 that stores the merchandise data necessary for receiving the mail order including the price and the stock quantity input from the server administrator and merchandise data sending means 322 that sends the merchandise data of the fourth merchandise data base 146 to the portal server of the equipment manufacturer according to the instruction of the server administrator. The second information processing means 121 of the portal server comprises consumable goods price data registering means 331 that receives the price information and inventory information of the consumable goods that are periodically sent from the consumable goods mail order center server 140 registered in the second mail address database 126 and updates the second consumable goods price database 129 and price information sorting means 332 that sorts the price information in the order of the price for each area classified into a genre by consumable goods and stores it associating the price information and the mail order center name when the second consumable goods price database 129 is updated.

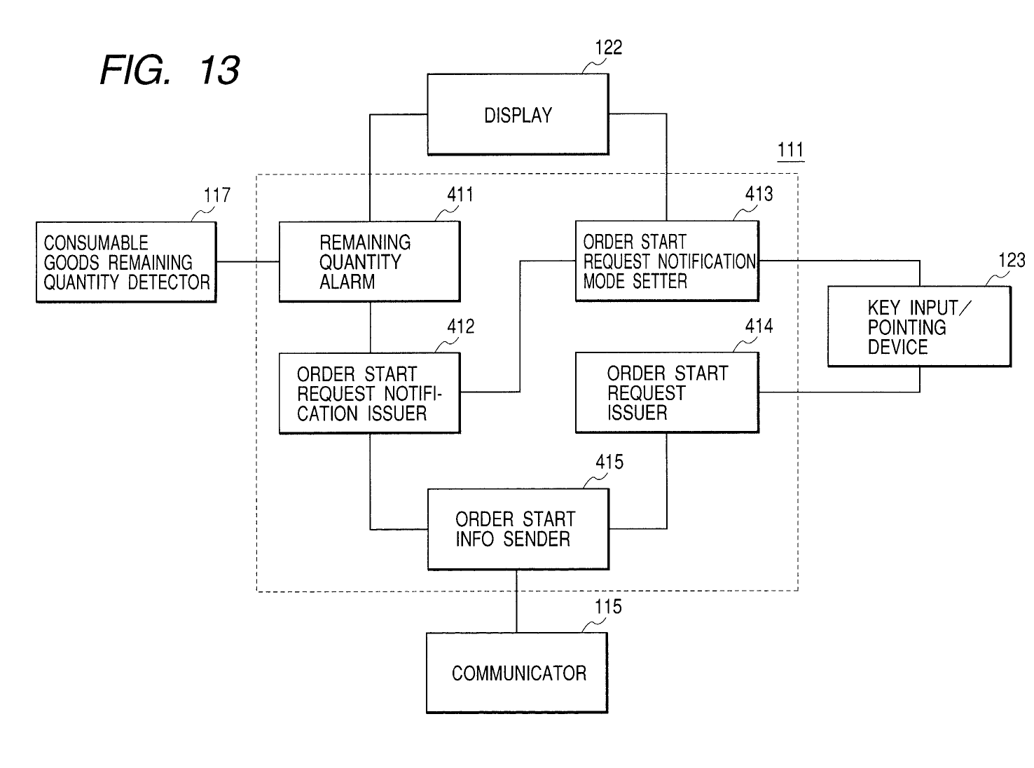

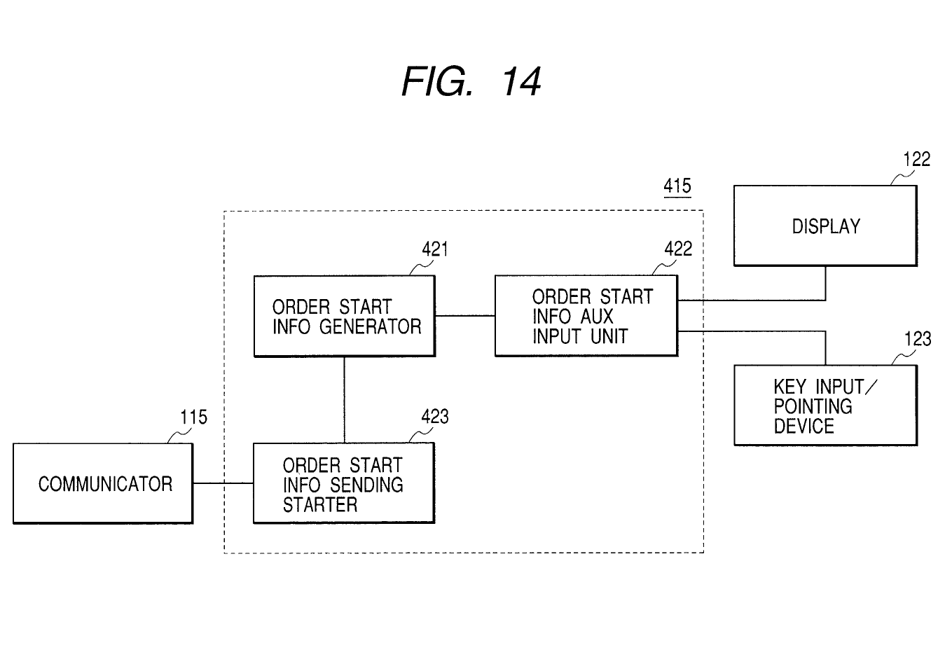

Further, as shown in FIG. 13 and FIG. 14, the first information processing means 111 of the communication information equipment comprises remaining quantity alarming means 411 that detects the remaining quantity of the consumable goods by the first consumable goods remaining quantity detecting means 117 and displays a remaining quantity alarm when a value that goes below a fixed amount is detected, order start request notification automatic issuing means 412 that automatically issues an order start request notification of the consumable goods to the portal server 120 when the order start request notification automatic issue mode is ON after the remaining quantity alarm is displayed, order start request notification automatic issue mode setting means 413 that sets the order start request notification automatic issue mode to ON/OFF, order start request issuing means 414 that issues the order start request notification to the portal server according to the user instruction. The order start information sending means 415 comprises order start information generation means 421 that generates order start information which contains at lease any one of machine type information of the equipment that enables the consumption amount of the consumable goods accumulated in the storage area and the discrimination of the consumable goods, the owner information stored in the storage area of the equipment, and connection information into the mail order center to which priority is given in the storage area in the equipment, order start information auxiliary input means 422 that urges the input of missing information and performs the auxiliary input processing of necessary information if the necessary information is missing when the order start information is generated, and order start information sending start means 423 that starts the sending processing of the generated order start information.

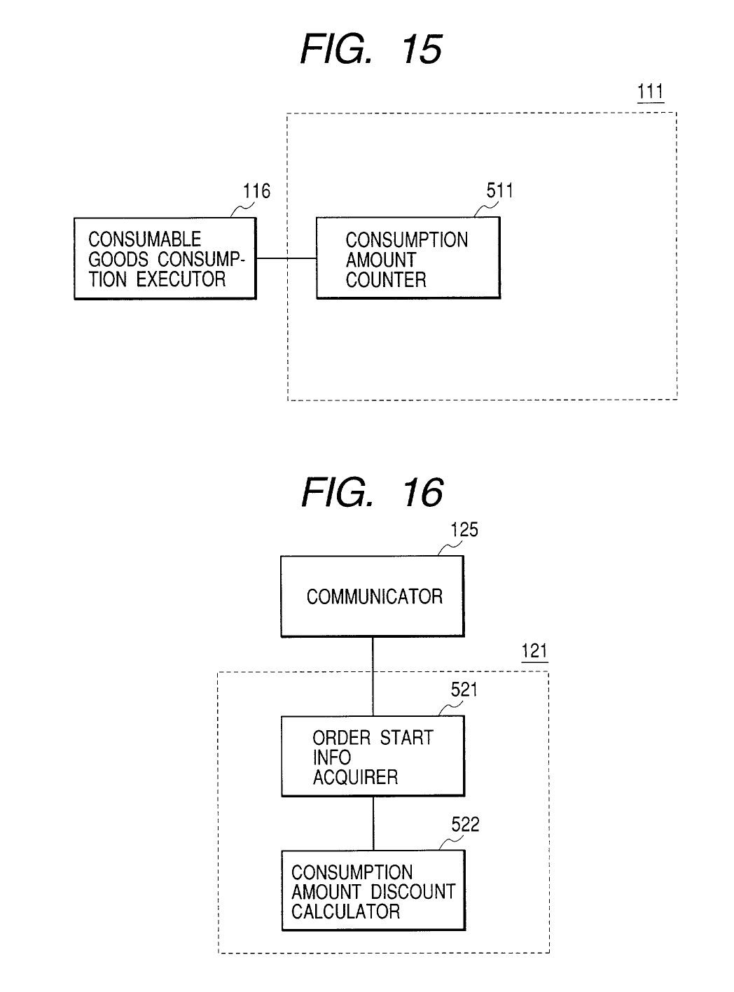

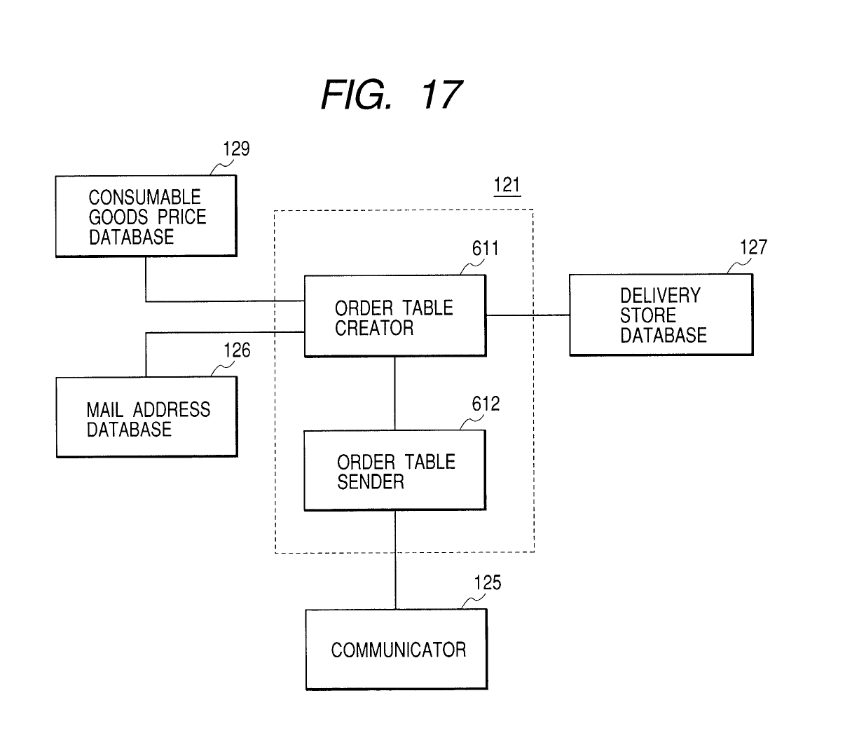

Further, as shown in FIG. 15 and FIG. 16, the first information processing means 111 of the communication information equipment comprises consumption amount counting means 511 that increments (counts up) the consumption amount of the consumable goods and accumulates it in the storage area after the first consumable goods consumption executing means 116 operates. The order start information sending means 415 comprises the order start information generation means 421 that refers to the consumption amount of the consumable goods counted by the consumption amount counting means 511 and generates it as the order start information. The second information processing means 121 of the portal server comprises order start information acquiring means 521 that receives the order start information sent from the side of the communication information equipment and acquires the order start information and consumption amount discount calculating means 522 that calculates the discount that corresponds to the consumption amount of the consumable goods in the acquired order start information.

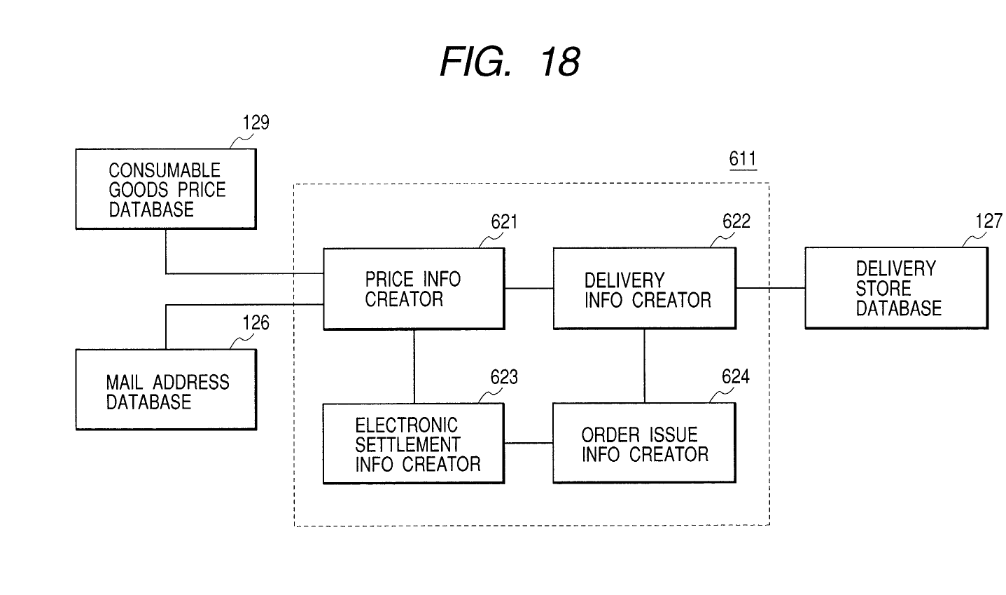

Further, as shown in FIG. 17 to FIG. 23, the second information processing means 121 of the portal server comprises order table creating means 611 that creates the order table based on the order start information acquired from the order start information acquiring means 521 and order table sending means 612 that sends the created order table to the communication information equipment. The order table creating means 611 comprises price information creating means 621 that creates an order table price information portion, delivery information portion creating means 622 that creates an order table delivery information portion, electronic settlement information portion creating means 623 that creates an order table electronic settlement information portion, and order issue portion creating means 624 that creates an order table order issue portion. The price information creation portion creating means 621 comprises price information acquiring means 631 that retrieves the second consumable goods price database 129 based on the machine type information in the order start information and acquires the price information and inventory information of the consumable goods that correspond to the machine type information, the consumption amount discount calculating means 522 that calculates the discount that corresponds to the consumption amount of the consumable goods, recycling discount calculating means 632 that acquires the number of recovery cartridges stored in the second mail address database 126 and calculates the discount information that corresponds to the number of recovery cartridges based on the mail address written to the owner information in the order start information. The second information processing means 121 creates the price information portion for each mail order center according to the price information, inventory information, consumption amount discount information, recycling discount information, and number of orders setting area obtained by each of the means, obtains the price information acquired from the price information acquiring means 631 in the sequence sorted in the price order on the consumable price database, creates the price information portion in the state sorted according to the price, and creates the price information portion of the order table in which priority is given to the specified mail order center when the connection information to the mail order center server in the order start information is specified. The delivery information portion creating means 622 comprises delivery method specification creating means 641 that creates a specification area which can specify the delivery method including at least any one of mailing, conveyance, and store-based delivery as the delivery method, destination information specification area creating means 642 that creates a destination information specification area necessary for mailing and conveyance, and a delivery store specification area creating means 643 that creates a delivery store specification area required for the store-based delivery, and creates the specification area obtained from each of the means as the delivery information portion. At the creation of the destination information specification area, destination information default setting means 644 sets at least one of the postal number, address, name, and telephone number described in the owner information in the order start information. At the creation of the delivery store specification regional store information default setting means 645 specifies a delivery area from the postal number, address, and telephone number, retrieves the second delivery store database 127 from the specified area information, sets the store that is doing business in the delivery area so that it can preferentially be specified as a default, and always updates and registers the latest data according to the management of the portal server administrator regarding the second delivery store database 127. The electronic settlement information portion creating means 623 comprises authentication data input area creating means 651 that creates the area in which authentication data required when the electronic settlement is performed in the electronic settlement server and creates the authentication data input area created by the authentication data input area creating means 651 as the electronic settlement information portion. The order issue portion creating means 624 comprises order issue specification area creating means 661 that creates the area in which the activation of the order issue instruction of a mail order can be specified and coupon ticket issuing specification area creating means 662 that creates the area in which the activation of the coupon ticket issuing instruction can be specified, and creates the specification area created by the coupon ticket issuing specification area creating means 662 as the order issue portion. The first information processing means 111 of the communication information equipment comprises order table receiving means 671 that receives the order table sent from the order table sending means 612, order table display means 672 that displays the received order table on the screen, order table input means 673 that inputs the data necessary for the order table on the displayed screen, order issue notification means 674 that sends the order issue notification and the order table to which the necessary data is input to the portal server of the equipment manufacturer when the order issue instruction is given, coupon ticket issuing notification means 675 that sends the coupon ticket issuing notification and the order table to the portal server of the equipment manufacturer, and order canceling means 676 that cancels an order.

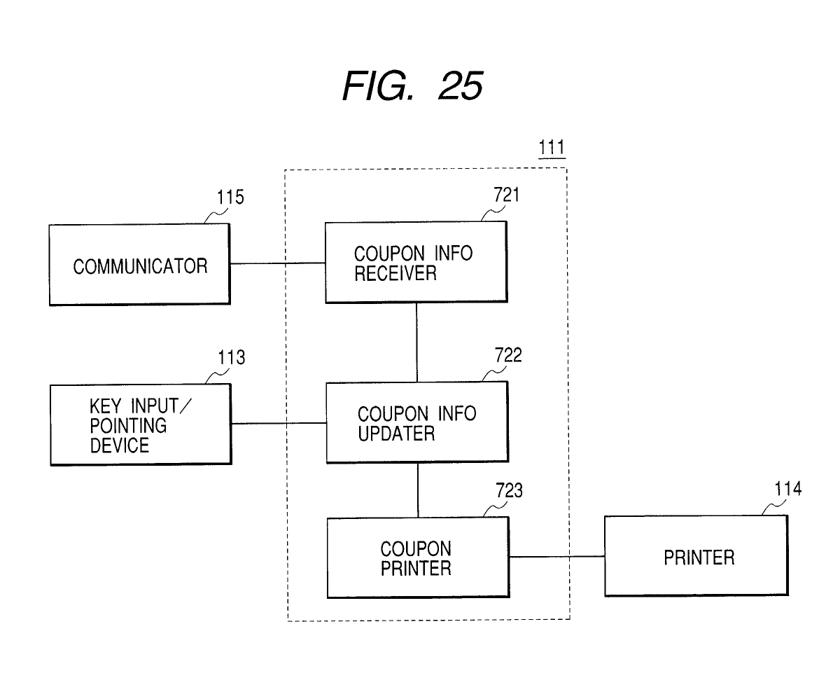

Further, as shown in FIG. 24 and FIG. 25, the second information processing means 121 of the portal server comprises coupon ticket issuing notification reception means 711 that receives the coupon ticket notification and the order table sent from the coupon ticket issuing notification means 675, coupon issue processing means 712 that receives the coupon ticket issuing notification and the order table and issues the coupon information based on the consumption amount discount information and the recycling discount information provided in the order table price information portion, and coupon information sending means 713 that sends the issued coupon information to the communication information equipment 110. The first information processing means 111 of the communication information equipment comprises coupon information receiving means 721 that receives the coupon information sent by the coupon information sending means 713 and stores it in the storage area of the equipment, coupon information updating means 722 that calculates a consumption amount discount by the print instruction of an operator based on a discount rate that matches the consumption amount previously stored in the equipment, compares the coupon information generated from the consumption amount discount and the coupon information stored in the storage area, and online coupon ticket printing means 723 that prints the coupon information stored in the storage area as the coupon ticket by the printing means.

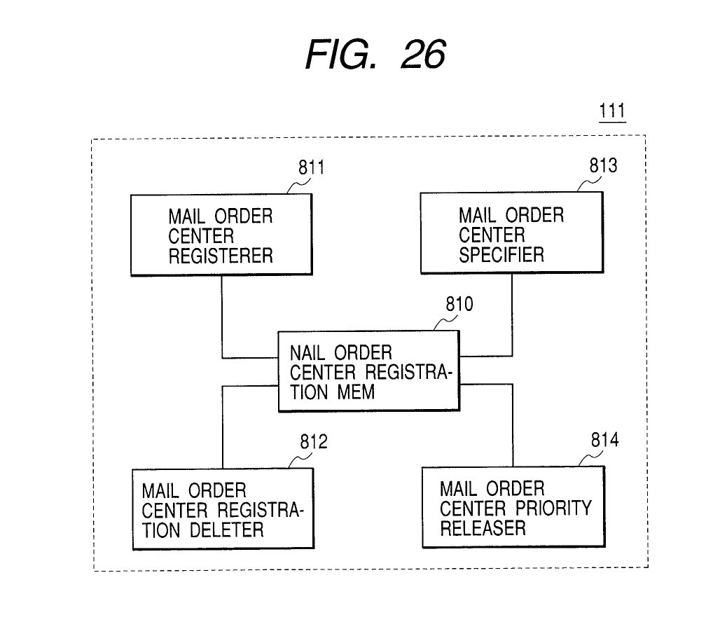

Further, as shown in FIG. 26, the first information processing means 111 of the communication information equipment comprises mail order center registering means 811 that specifies a specific mail order center from a plurality of mail order centers provided in the price information portion of the order table displayed by the order table display means 672 and can register the plurality of mail order centers specified in the storage area of the equipment, a mail order center registration memory 810 that is the storage area of the equipment in which the mail order centers are registered, mail order center registration deletion means 812 that registers and then deletes the specific mail order center from the mail order centers registered in the mail order center registration memory 810, mail order center specification means 813 that can preferentially specify the specific mail order center from the plurality of mail order centers registered in the mail order center registration memory 810, and mail order center priority releasing means 814 that can release priority specification.

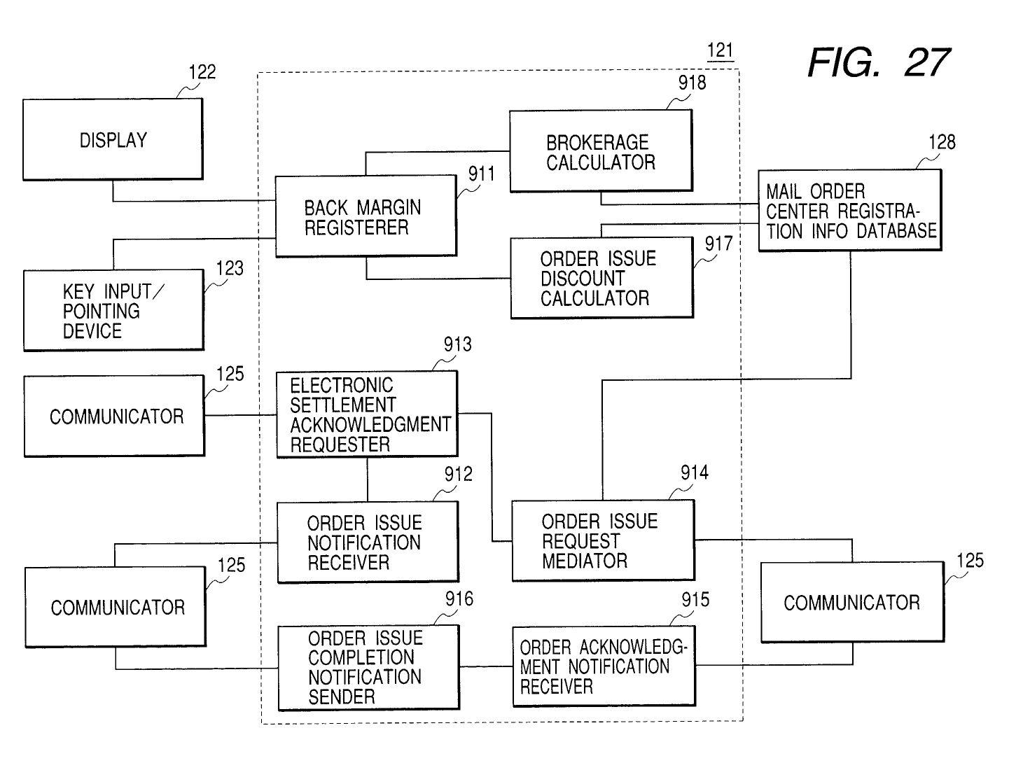

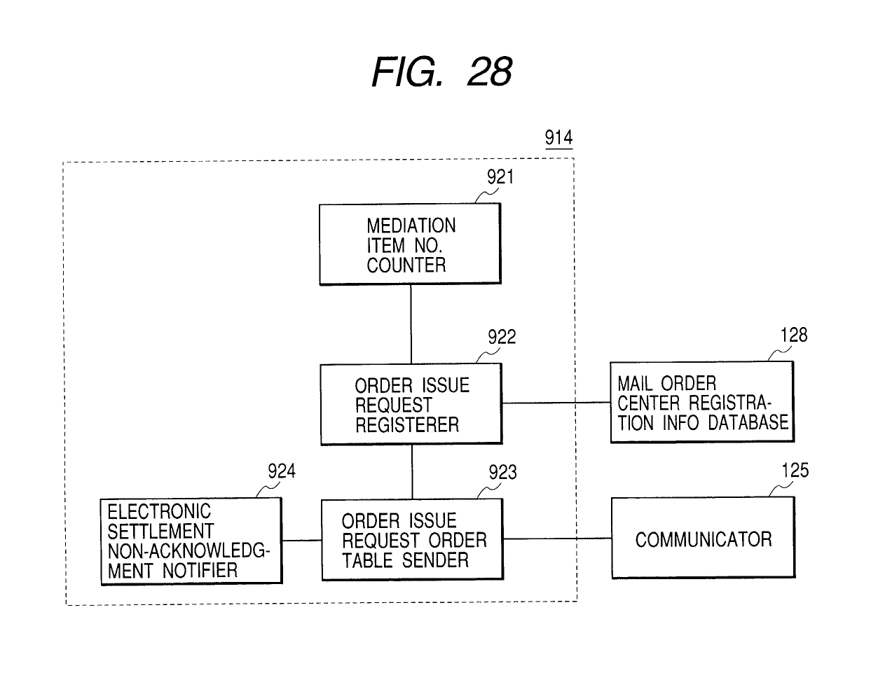

Further, as shown in FIG. 27 to FIG. 32, the second information processing means 121 of the portal server comprises back margin registering means 911 at the side of the manufacturer that registers the information about brokerage and discount fee that match the handling amount determined according to the arrangement with each mail order center by the data input of the portal server administrator, order issue notification receiving means 912 that receives the order issue notification from the communication information equipment 110, electronic settlement acknowledgement requesting means 913 that receives the order issue notification, creates acknowledgement information based on authentication data input to the order table and sends it to the electronic settlement server 130, and performs the electronic settlement acknowledgment request for order issue merchandise to the specified mail order center, order issue request mediating means 914 that receives the acknowledgment result notification information from the electronic settlement server 130 and performs the mediation to the mail order center server 140, received order acknowledged notification receiving means 915 that receives the received order acknowledged notification from the mail order center server 140, and order issue completion notification sending means 916 that receives the received order acknowledged notification and issues an order issue completion notification to the communication information equipment 110. The order issue request mediating means 914 comprises number of mediation items counting means 921 that counts the number of mediation items for each mail order center when the electronic settlement is acknowledged according to the acknowledgment result notification information from the electronic settlement server 130, order issue request registering means 922 that registers the number of orders counted by the number of mediation items counting means 921 in the second mail order center registration information database 128 for each mail order center together with the order table of the order of which the order issue request is received, order issue request order table sending means 923 that sends the order table of which the order issue is received to the mail order center server 140, and electronic settlement not-acknowledged notification means 924 that sends an electronic settlement not-acknowledged notification to the first communication information equipment 110 when the electronic settlement is not acknowledged. The second information processing means 121 of the portal server comprises brokerage calculating means 918 at the side of the manufacturer that calculates the brokerage paid from the side of the mail order center according to the number of orders that is counted by the number of mediation items counting means 922 and registered in the mail order center registration information database 128 by the order issue request registering means 923 and order issue discount calculating means 917 at the side of the manufacturer that calculates the discount fee paid to the mail order center in accordance with the number of mediation items. The third information processing means 131 of the electronic settlement server comprises electronic settlement acknowledgment request receiving means 951 that receives an electronic settlement acknowledgment request from the portal server 120, electronic settlement means 952 that performs the electronic settlement based on the acknowledgment information and the electronic settlement database and electronic settlement acknowledgment result information notification means 953 that sends a result of the electronic settlement to the portal server as the acknowledgment result information notification. The first information processing means 111 of the communication information equipment comprises order issue completion notification receiving means 961 that receives the order issue completion notification from the portal server, electronic settlement not-acknowledged notification receiving means 962 that receives the electronic settlement not-acknowledged notification, and order issue response notification means 963 that displays separately received notification contents. The fourth information processing means 141 of the mail order center server comprises back margin registering means 931 at the side of the mail order center that registers the information about brokerage and discount fee that match the handling amount determined according to the arrangement with each mail order center by the data input of the portal server administrator, order issue request order table receiving means 932 that receives the order issue request from the portal server 120, and received order acknowledged notification sending means 934 that sends the received order acknowledged notification to the portal server 120 when the order is given. The received order means 933 comprises number of received orders counting means 941 that counts the number of order issue requests from the portal server 120 and received order request registering means 942 that registers the number of received orders counted by the number of received orders in the fourth order table database 148 together with the order table of the order of which the order issue request is given. The fourth information processing means 141 of the mail order center server comprises brokerage calculating means 935 at the side of the mail order center that calculates brokerage paid to the equipment manufacturer in accordance with the number of received orders that is counted by the number of orders counting means 941 and registered in the order table database 148 by the received order request registering means 942 and order issue discount calculating means 936 at the side of the mail order center that calculates the discount fee paid from the side of the equipment manufacturer according to the number of received orders.

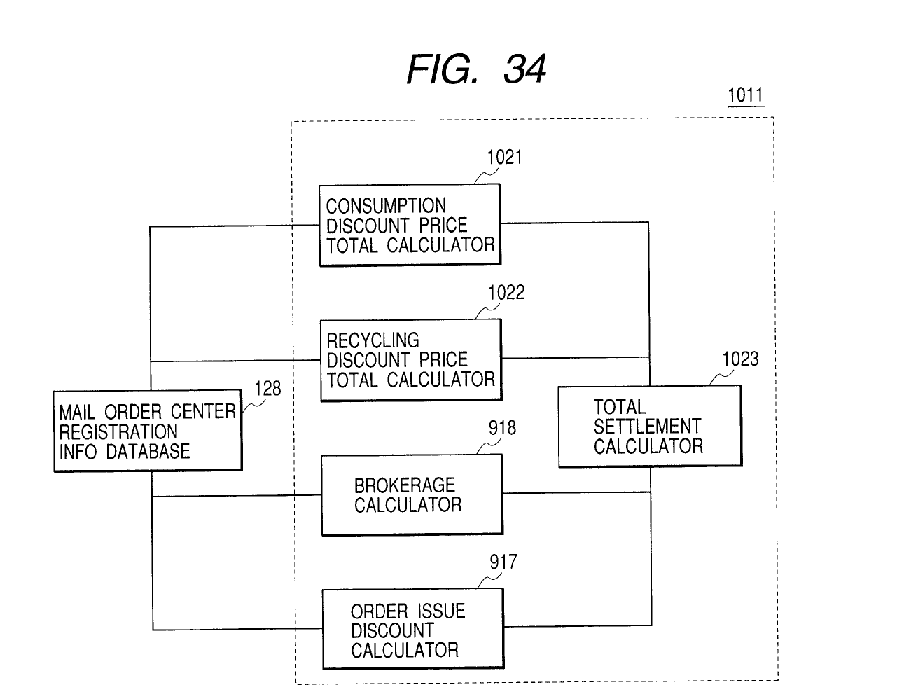

Further, as shown in FIG. 33 and FIG. 34, the second information processing means 121 of the portal server comprises settlement information comprises settlement information calculating means 1011 at the side of the manufacturer that calculates monthly settlement information for each mail order center on a monthly settling day or according to the instruction of the server administrator, settlement information sending means 1012 at the side of the manufacturer that sends the calculated settlement information to each mail order center, settlement information backup means 1013 at the side of the manufacturer that backs up all of the settlement information total, settlement information, and the handling order table within a settling month into the backup area of the second mail order center registration information database 128 for each mail order center, settlement information clearing means 1014 at the side of the manufacturer 1014 that clears the number of orders and an issued order table within the predetermined period when the settlement information is backed up according to the settlement information by the settlement information backup means at the side of the manufacturer, and settlement information utility means 1015 at the side of the manufacturer that prints and deletes the information backed up in the backup area according to the instruction of the portal server administrator. The settlement information calculating means 1011 at the side of the manufacturer comprises consumption discount price total calculating means 1021 at the side of the manufacturer that calculates the consumption discount price total recorded in the order table as the settlement information against all the order tables of the mail order center specified in the second mail order center registration database 128, recycling discount price total calculating means 1022 that calculates the recycling discount price total recorded in the order table as the settlement information, the brokerage calculating means 916 at the side of the manufacturer that calculates the discount fee paid to the mail order center in accordance with the number of mediation items as the settlement information, the settlement information totaling means 1023 at the side of the manufacturer that calculates the value in which the order issue discount price is subtracted from the consumption discount price total, recycling discount price, and order issue brokerage as the settlement information total.

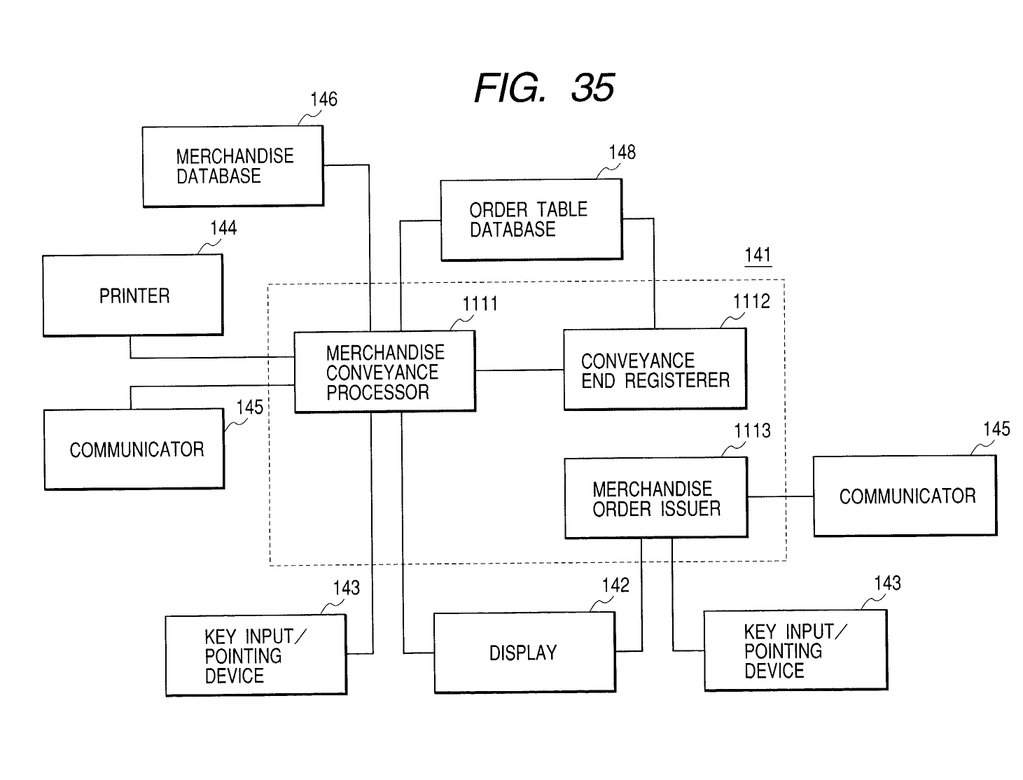

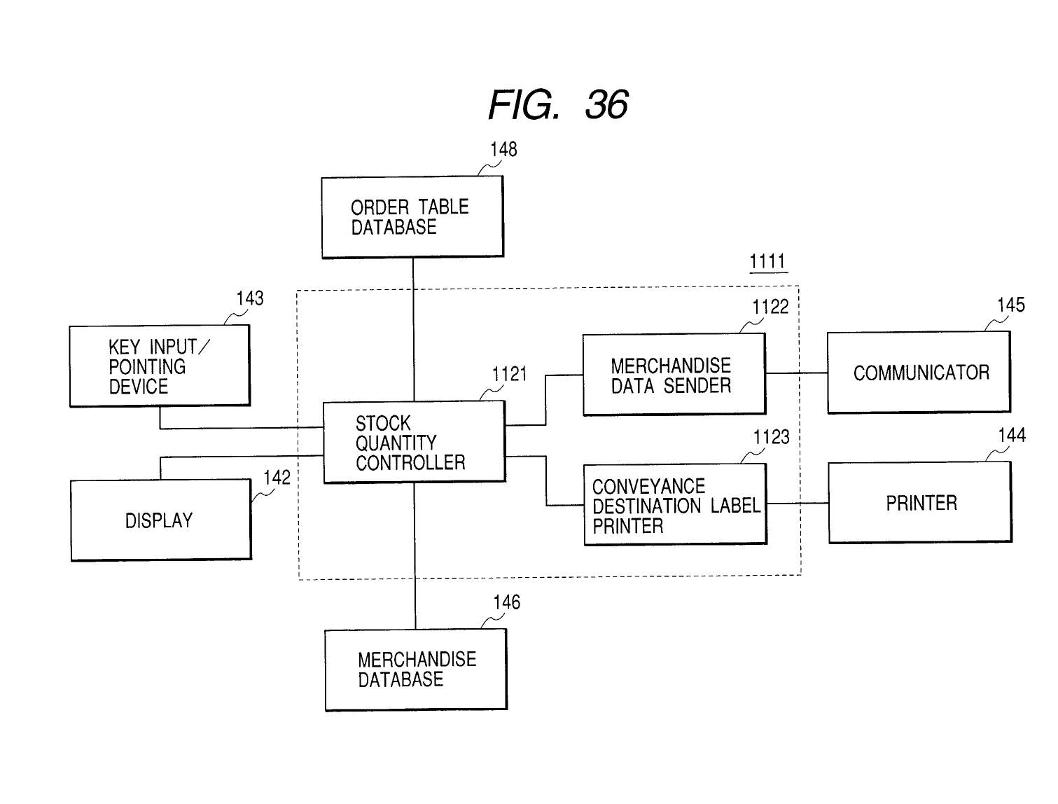

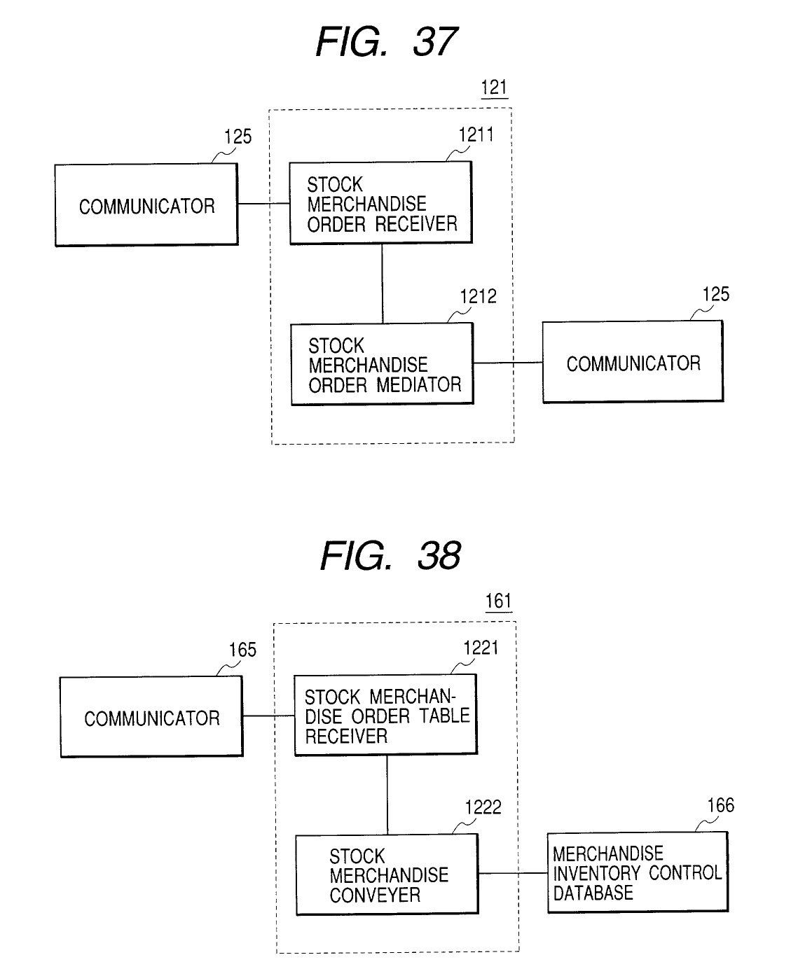

Further, as shown in FIG. 35 and FIG. 36, the fourth information processing means 141 of the mail order center server comprises merchandise conveyance procedure means 1111 that performs a merchandise conveyance procedure based on the delivery method specified in the order table against the order table of which the conveyance procedure registered in the fourth order table database 148 according to the instruction of the sever administrator is not terminated, conveyance procedure end registering means 1112 that registers the conveyance procedure end in the order table database against the order table of which the merchandise procedure is terminated, and stored merchandise order issuing means 1113 that performs the order issue of stored merchandise to the portal server 120 according to the instruction of the server administrator when no remaining stock quantity is reported by the merchandise conveyance procedure means 1111. The merchandise conveyance procedure means 1111 comprises stock quantity control means 1121 that updates the stock quantity in the fourth merchandise database 146 in accordance with the number of received orders and reports the information about no remaining stock quantity to the server administrator of the mail order center when the stock quantity is exhausted, merchandise data sending means 1122 that receives the update of the stock quantity and sends the updated merchandise data in the fourth merchandise database 146 to the portal server 120 of the equipment manufacturer, and conveyance destination label printing means 1123 that prints the postal number, address, and name of the conveyance destination on a label paper based on the owner information of the order table.

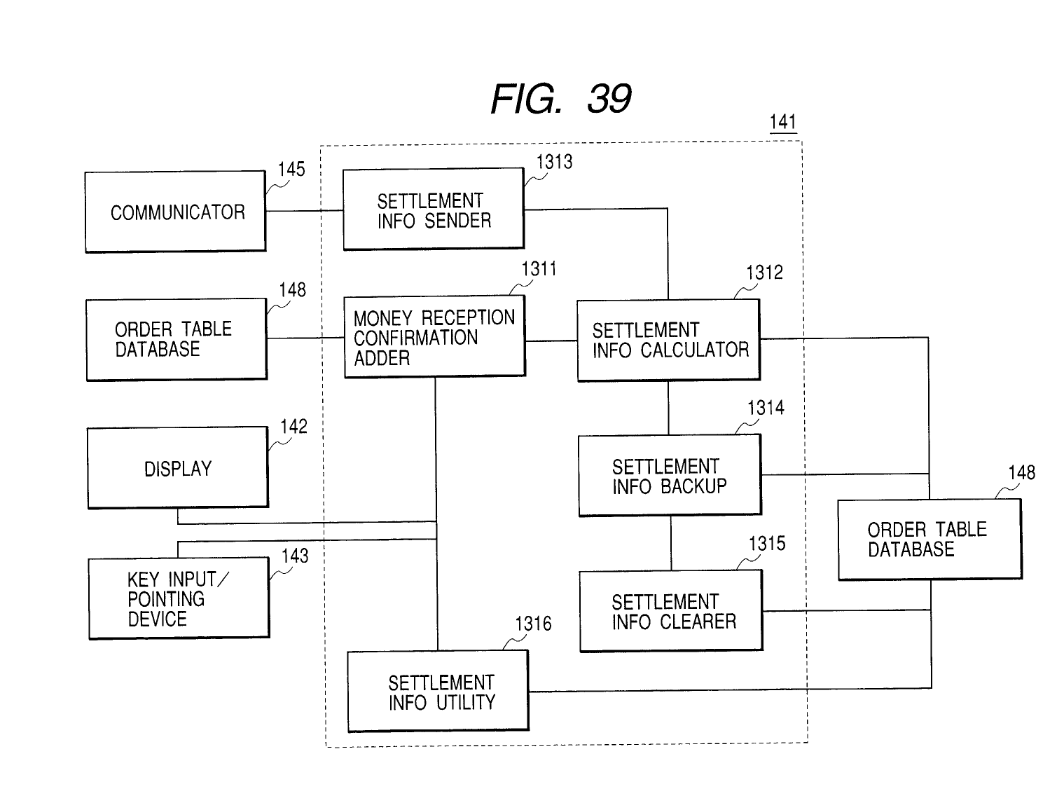

Further, as shown in FIG. 37 and FIG. 38, the second information processing means 121 of the portal server comprises stored merchandise order issue receiving means 1211 that receives the order issue of stored merchandise ordered from the stored merchandise order issuing means 1113 and stored merchandise order issue mediating means 1212 that mediates the received order of the stored merchandise of which the received order is given and sends the order table to the merchandise control center server 160 of the consumable goods. The sixth information processing means 161 of the merchandise control center server of the consumable goods comprises stored merchandise order table received order means 1221 that receives the order table of the stored merchandise by the stored merchandise order issue mediating means 1212 and stored merchandise conveyance means 1222 that updates the sixth merchandise inventory control database 166 in which the merchandise inventory control information of the consumable goods is stored and conveys the received order stored merchandise to the mail order center of which the order issue request is given.

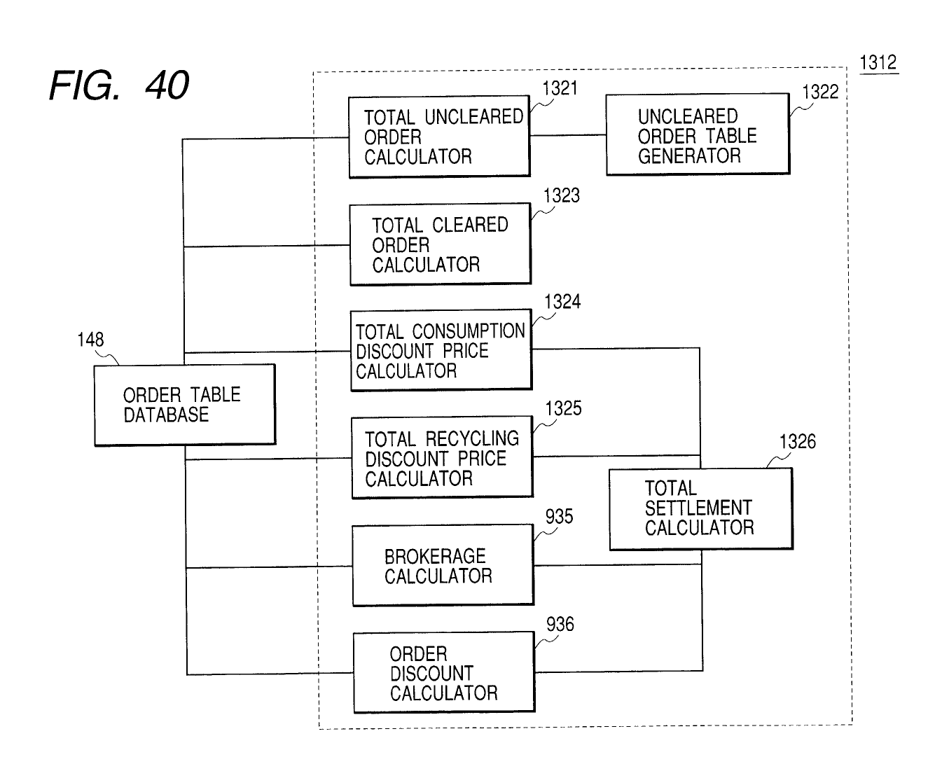

Further, as shown in FIG. 39 and FIG. 40, the fourth information processing means 141 of the mail order center server comprises money-received confirmation information adding means 1311 that adds money-received confirmation information to the order table of which the money-received to an order is checked, on a monthly settling day or according to the instruction of the server administrator, settlement information calculating means 1312 at the side of the mail order center that calculates monthly settlement information, settlement information sending means 1313 at the side of the mail order center that sends the calculated settlement information to the equipment manufacturer portal server 120, settlement information backup means 1314 at the side of the mail order center that backs up all of the settlement information total, settlement information, and received order table handled within a settling month in the backup area of the fourth order table database 148, settlement information clearing means 1315 at the side of the mail order center that clears the number of monthly received orders issued and received order table when the settlement information is backed up by the backup means 1314, and settlement information utility means 1316 at the side of the mail order center that prints and deletes the information backed up in the backup area according to the instruction of the portal server administrator. The settlement information calculating means 1312 at the side of the mail order center comprises money-not-received calculating means 1321 that calculates the total of the money-not-received order table to which the money-received confirmation information is not added against all the monthly received order tables registered in the fourth order table database 148, money-not-received order table creating means 1322 that creates a list of money-not-received order tables, money-received total calculating means 1323 that calculates the total of the merchandise price of the money order table to which the money-received confirmation information is added, consumption discount price total calculating means 1324 at the side of the mail order center that calculates the total of the consumption discount price recorded in the order table as the settlement information, recycling discount price total calculating means 1325 at the side of the mail order center that calculates the total of the consumption discount price recorded in the order table as the settlement information, the brokerage calculating means 935 at the side of the mail order center that calculates the brokerage paid to the equipment manufacturer in accordance with the number of orders, the order issue discount calculating means 936 at the side of the mail order center that calculates the discount price paid to the side of the mail order center in accordance with the number of mediation items, and settlement information total calculating means 1326 at the side of the mail order center that calculates the value in which an order issue discount price is subtracted from the total of a consumption discount price, a recycling discount price, and order issue brokerage as the settlement information total.

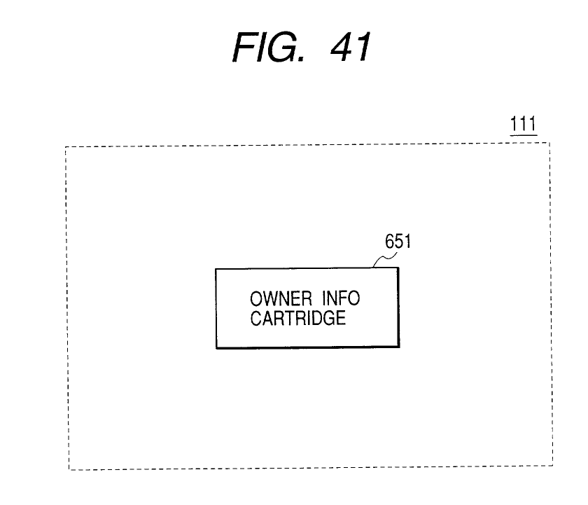

Further, as shown in FIG. 41 to FIG. 44, the first information processing means 11 of the communication information equipment comprises owner cartridge storage means 1411 that stores the owner information in the storage area at the side of the cartridge when consumable goods are of a cartridge type and there is the area in which the owner information is recorded at the side of the cartridge. The fifth information processing means 151 of the recycling plant server of the consumable goods comprises cartridge owner information reading means 1421 that reads the owner information stored in the storage area of the recovered cartridge, by the fifth cartridge information reader 156, owner information management database registering means 1422 that obtains the mail address information from the read owner information and registers it in the fifth owner information management database 157, recycling discount information sending means 1423 that periodically sends the mail address information and the recovery cartridge information registered in the fifth owner information management database 157 to the portal server 120 of the equipment manufacturer, owner information management database clearing means 1424 that clears the mail address information and the recovery cartridge information already sent in the fifth owner information management database 157 after sending processing is performed by the recycling discount information sending means 157 from the owner information management database, and owner information management database utility means 1425 that displays and deletes the contents of the owner information management database according to the instruction of the server administrator. The owner information management database registering means 1422 comprises cartridge information initializing means 1431 that sets the recovery cartridge information to 1 and registers it the fifth owner information management database 157 together with the mail address database 157 when the mail address information in the owner information read by the cartridge owner reading means 1421 is not registered in the fifth owner information management database 157, and recovery cartridge information updating means 1432 that increments (counts up) and updates the recovery cartridge information in the database when the mail address information is registered in the fifth owner information management database 157. The second information processing means of the portal server comprises recycling discount information receiving means 1441 that receives the mail address information and the recovery cartridge information sent by the recycling discount information sending means 1423 and mail address database updating means 1442 that adds the received recovery cartridge information to the recovery cartridge information which corresponds to the mail address information in the second mail address database 126 that matches the received mail address information and updates it.

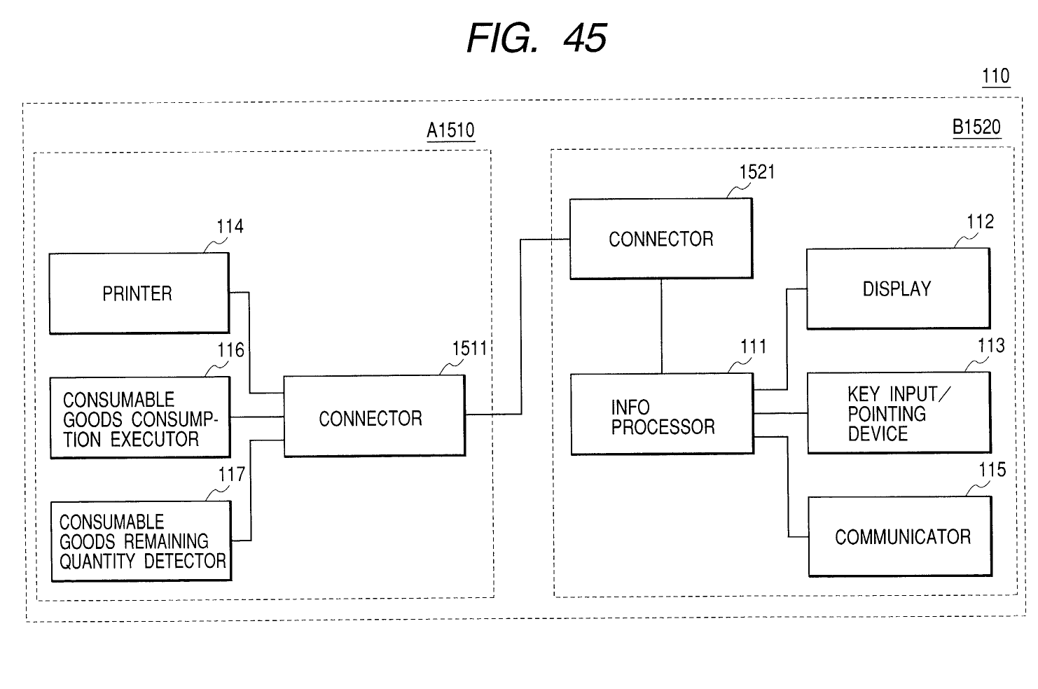

Further, as shown in FIG. 45, the communication information equipment 110 comprises first electronic equipment A1510 having the function that performs the consumption execution of the consumable goods and remaining quantity detection and second electronic equipment B1520 having the function that performs the processing necessary for performing the online shopping. The first electronic equipment comprises the first printing means 114, the first consumable goods consumption executing means 116, the first consumable goods remaining quantity detecting means 117, and first electronic equipment connecting means 1511 that performs the connection of the equipment in order to transfer necessary information between the first electronic equipment A and the second electronic equipment B. The second electronic equipment B comprises the first information processing means 111, the first screen display means 112, the first key input/pointing means 113, the first communicating means 115, and second electronic equipment connecting means 1521 that performs the connection of the equipment in order to transfer necessary information between the first electronic equipment and the second electronic equipment A.

Besides, FIG. 1 and FIG. 2 to FIG. 45 are a block diagram of a consumable goods online shopping system according to one embodiment of the present invention.

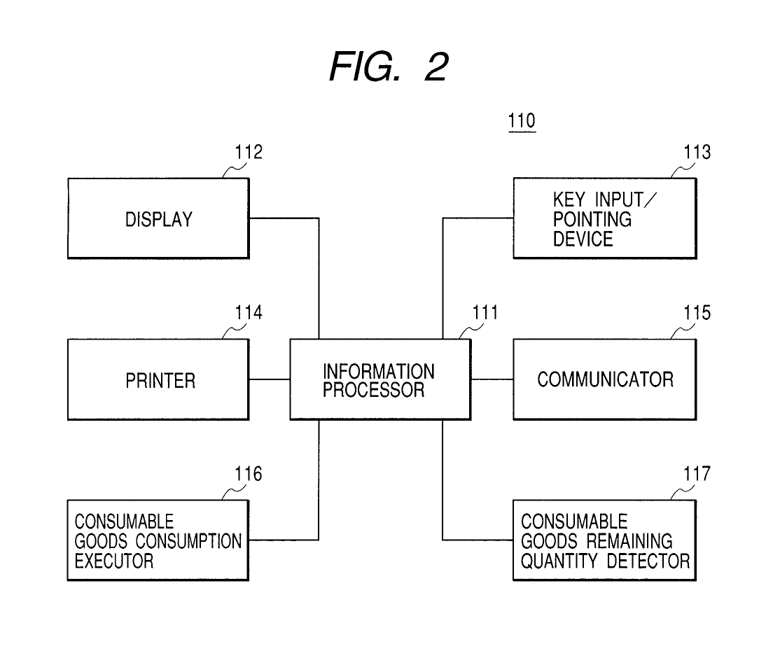

Further, as shown in FIG. 1 the communication information equipment 110 according to the present embodiment is communication information equipment that is connected to a portal server 120 to which data is sent, the electronic settlement server 130 that performs the settlement of the transaction performed, the recycling plant server 150 installed in the recycling plant of the consumable goods, and the merchandise control center server 160 installed in the merchandise control center of the consumable goods, where as shown in FIG. 2, it comprises information processing means 111 that performs the processing of various information in the communication information equipment, screen display means 112 that displays the information-processed information on the screen, key input/pointing means 113 that inputs the information necessary for the information processing with the key or by the pointing device on the screen, printing means 114 that prints the information-processed contents, communicating means 115 that communicates the information-processed contents via the network, consumable goods consumption executing means 116 that executes the processing that consumes the consumable goods, and consumable goods remaining quantity detecting means 117 that detects the remaining quantity of the consumable goods.

Further, as shown in FIG. 8, the information processing means 111 comprises owner information registering means 211 that stores the information for identifying an owner including at least any one of a mail address, a postal number, an address, a name, and a telephone number in the storage area of the equipment as the owner information and mail address automatic registering means 213 that performs automatic connection to the portal server, issues a mail address acquisition request to the portal server, and automatically registers the mail address allocated and sent by the portal server in the mail address of the owner information.

Further, as shown in FIG. 13, the information processing means 111 comprises remaining quantity alarming means 411 that detects the remaining quantity of the consumable goods by the consumable goods remaining quantity detecting means 117 and displays a remaining quantity alarm when the value that goes below a fixed amount is detected, an order start request notification automatic issuing means that automatically issues a consumable goods order start request notification to the portal server when the order start request notification automatic issue mode is ON after the remaining quantity amount alarm is displayed, order start request notification automatic issue mode setting means 413 that sets the order start request notification automatic issue mode to ON/OFF, order start request notification means 414 that issues the order start request notification to the portal server according to the user instruction, and order start information sending means 415 that sends necessary information to the portal server as order start information according to the issue of the order start request notification. As shown in FIG. 14, the order start information sending means 415 comprises order start information generating means 421 that generates the order start information including at least any one of the machine type information of the equipment that enables the discrimination of the consumption amount of the consumable goods accumulated in the storage area and the discrimination of the consumable goods, the owner information stored in the storage of the equipment, and the connection information to the mail order center that is preferentially specified in the storage area of the equipment, order start information auxiliary input means 422 that urges the input of missing information and performs the auxiliary input processing of necessary information when the necessary information is missing at the generation of the order start information, and order start information sending start means 423 that starts the sending processing of the generated order start information.

Further, as shown in FIG. 15, the information processing means 111 comprises consumption amount counting means 511 that increments (counts up) the consumption amount of the consumable goods after the consumable goods consumption executing means 116 operates, and as shown in FIG. 14, the order start information sending means 415 comprises order start information generating means 421 that refers to the consumption amount of the consumable goods counted by the consumption amount counting means 511 and generates it as the order start information.

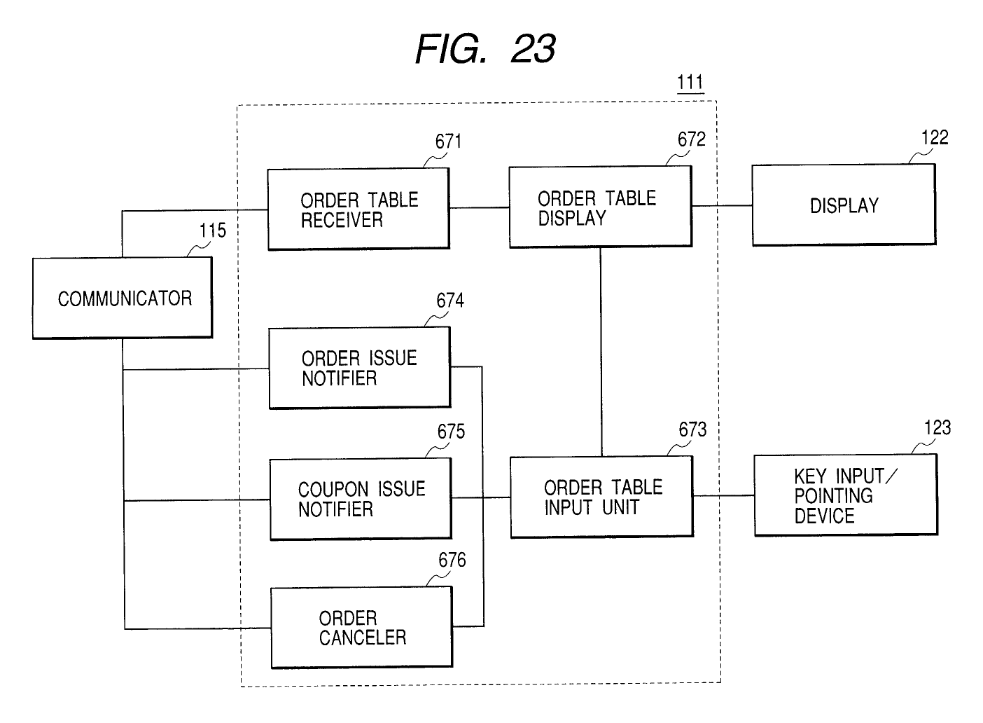

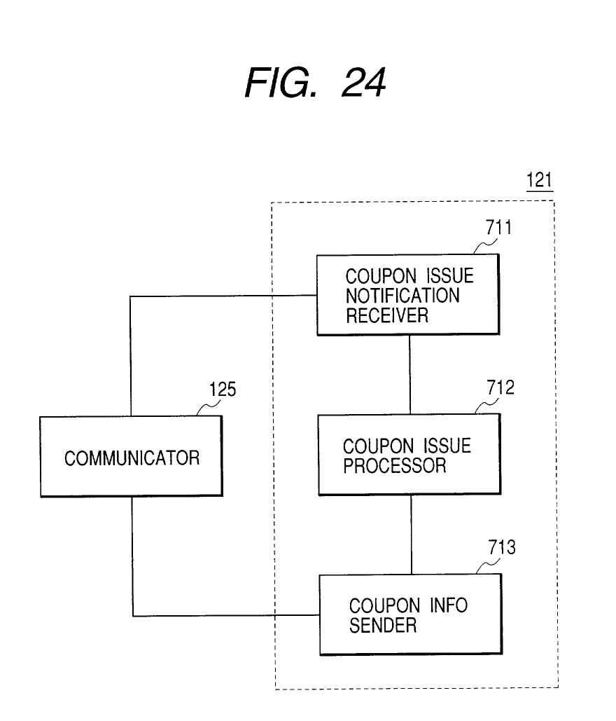

Further, as shown in FIG. 23, the information processing means 111 comprises order table receiving means 671 that receives the sent order table, order table display means 672 that displays the displayed order table on the screen, order table input means 673 that inputs the data necessary for the order table on the displayed screen and performs an order issue and a coupon ticket issuing instruction, order issue notification means 674 that sends an order issue notification and the order table to which necessary data is input to the portal server of the equipment when an order issue instruction is given, coupon ticket notification means 675 that sends a coupon ticket issuing notification and the order table to the portal server when a coupon ticket issuing instruction is given, and order canceling means 676 that cancels the order.

Further, as shown in FIG. 26, the information processing means 111 comprises mail order center registering means 811 that specifies a specific mail order center from a plurality of mail order centers provided in the price information portion of the order table displayed by the order table display means 672 and can register the plurality of mail order centers specified in the storage area of the equipment, mail order center registration deletion means 812 that registers and deletes the specific mail order center from a mail order center registration memory 810 that is the storage area of the equipment in which the mail order center is registered and the mail order center registered in the mail order center registration memory, mail order center specification means 813 that can preferentially specify the specific mail order center from the plurality of mail order centers registered in the mail order center registration memory, and mail order center priority release means 814 that can release preferential specification.

Further, as shown in FIG. 25, the information processing means 111 of the communication information equipment 110 comprises coupon information receiving means 721 that receives the sent coupon information and stores it in the storage area of the equipment, coupon information updating means 722 that calculates a consumption amount discount based on the discount rate that matches the consumption amount stored previously in the storage area of the equipment, compares the coupon information generated from the consumption amount discount and the coupon information stored in the storage area and changes the coupon information stored in the storage area to the coupon information that is advantageous for the discount, and online coupon ticket printing means 723 that prints the coupon information stored in the storage area as the coupon ticket by the printing means.

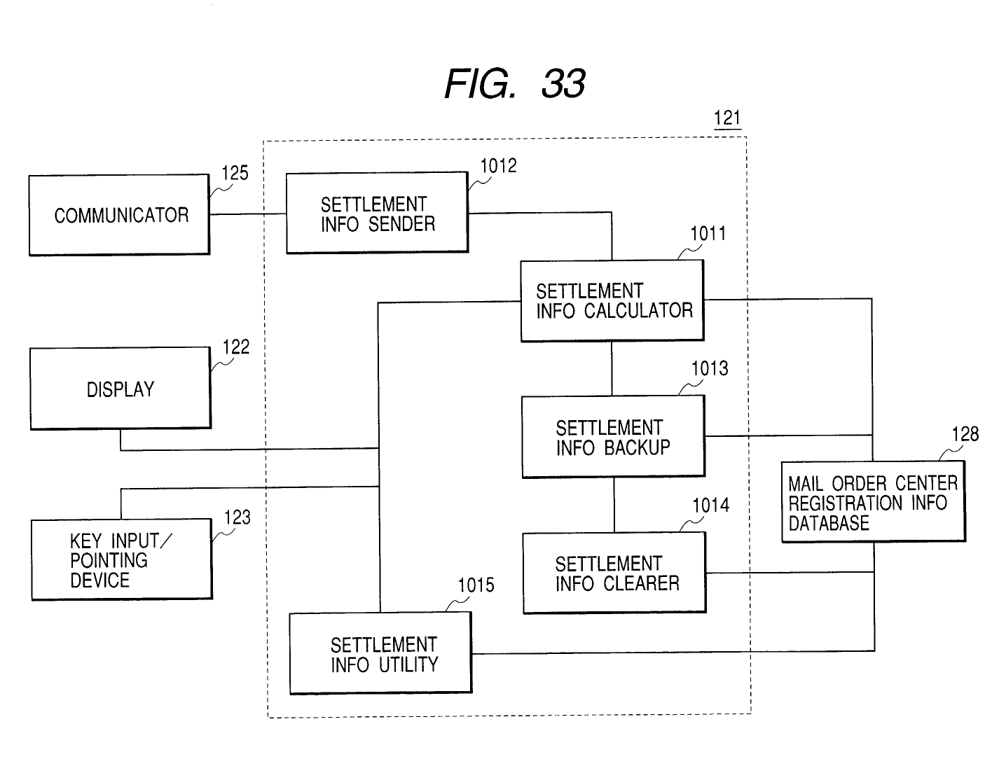

Further, as shown in FIG. 32, the information processing means 111 comprises order reception acknowledgment notification receiving means 961 that receives an order issue completion notification from the portal server 120, electronic settlement not-acknowledged notification receiving means 962 that receives an electronic settlement not-acknowledged notification, and an order issue response notification display means 963 that displays separately received notification contents.

Further, as shown in FIG. 41, the information processing means 111 comprises owner information cartridge storage means 1411 that also stores owner information in the storage area at the side of the cartridge when the consumable goods are of a cartridge type and there is an area in which the owner information is recorded at the side of the cartridge.

Further, as shown in FIG. 45, provided are electronic equipment A1510 having the function that performs the consumption execution and remaining quantity detection of the consumable goods and electronic equipment A1520 having the function that performs the processing necessary for performing the online shopping. The electronic equipment A1510 comprises the printing means 114 , the consumable goods consumption executing means 116, the consumable goods remaining quantity detecting means 117, and electronic equipment connecting means 1511 that performs the connection of the equipment in order to transfer the necessary information between the electronic equipment A1510 and the electronic equipment B1520. The electronic equipment B1520 comprises the information processing means 111, the screen display means 112, the key input/pointing means 113, the communicating means 115, and electronic equipment connecting means 1521 that performs the connection of the equipment in order to transfer the information necessary for the electronic equipment B1520 and the electronic equipment A1510.

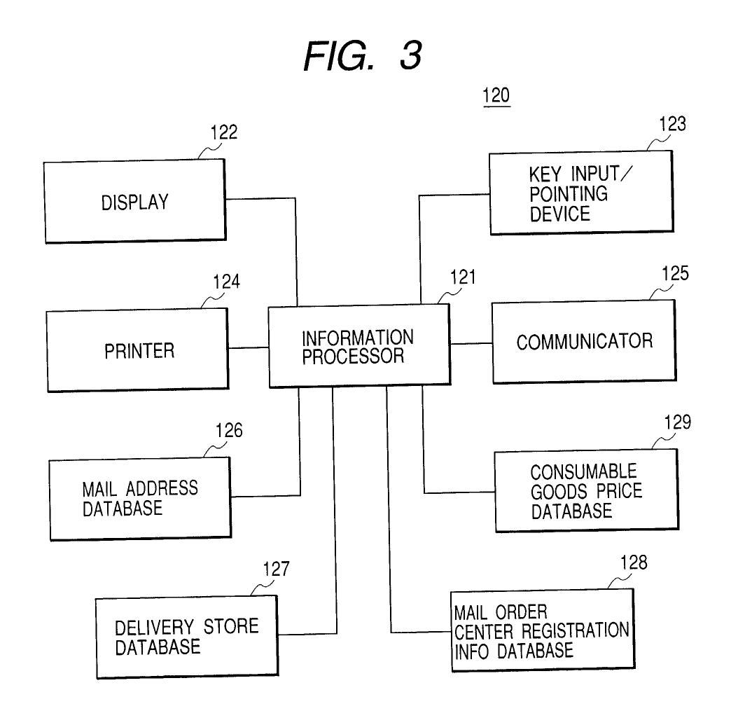

Further, as shown in FIG. 1, the portal server 120 according to the present embodiment is a portal server to which data is sent from the communication information equipment 110 connected to communication information equipment that consumes consumable goods, an electronic settlement server 130 that performs the settlement of the transaction performed in the communication information equipment, a mail order center server 140 for mail-ordering the consumable goods, a recycling plant server 150 installed in a recycling plant of the consumable goods, and a merchandise control center server 150 installed in a merchandise control center of the consumable goods via a network 100, wherein as shown in FIG. 3, it comprises information processing means 121 that performs processing of various information in the portal server 120, screen display means 122 that displays information-processed information, key input/pointing means 123 that inputs information necessary for information processing with a key or by a pointing device on the screen, communicating means 125 that communicates information-processed contents via the network, a mail address database 126 in which the mail address and recovery cartridge information of the communication information equipment 110 connected to the portal server are stored, a delivery store database 127 in which delivery stores of the consumable goods are stored for each area, a mail order center registration information database 128 in which the information of the mail order center that is connected to the portal server and from which the consumable goods are ordered, and a consumable goods price database 129 in which individual merchandise price information is stored for each mail order center.

Further, as shown in FIG. 9, the information processing means 121 comprises mail address notification means 221 that receives a mail address acquisition request issued by the mail address automatic registering means of the communication information equipment 110, retrieves a mail address database 126, and allocates and reports an unregistered empty mail address as the mail address of the communication information equipment, automatic mail address allocation means 222 that automatically allocates the empty mail address for the allocation of the mail address, and empty mail address retrieval means 223 for supporting allocation by the portal administrator.

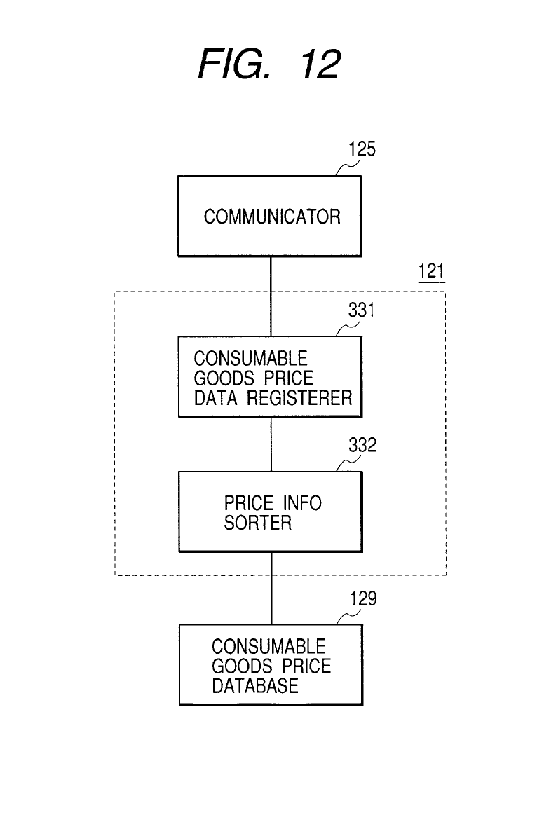

Further, as shown in FIG. 10, the information processing means 121 comprises mail order center information registering means 311 that registers the information about the order issue destination mail order center of an order table in a mail order center database 128 according to the input of the portal server administrator using the key input/pointing means 123, consumable goods price data registering means 331 that receives the price information and inventory information of the consumable goods which are periodically sent from the consumable goods mail order center server registered in the second mail order center registration database and updates a consumable goods price database 129 and price information sorting means 332 that sorts them for each area categorized by consumable goods in the order of the price and storing them by associating the price information and the mail order center name (FIG. 12).

Further, as shown in FIG. 16, the information processing means 121 comprises order start information acquiring means 521 that receives order start information sent from the side of the communication information equipment and acquires the order start information and consumption amount discount calculating means 522 that calculates the discount that matches the consumption amount of the consumable goods in the acquired order start information.

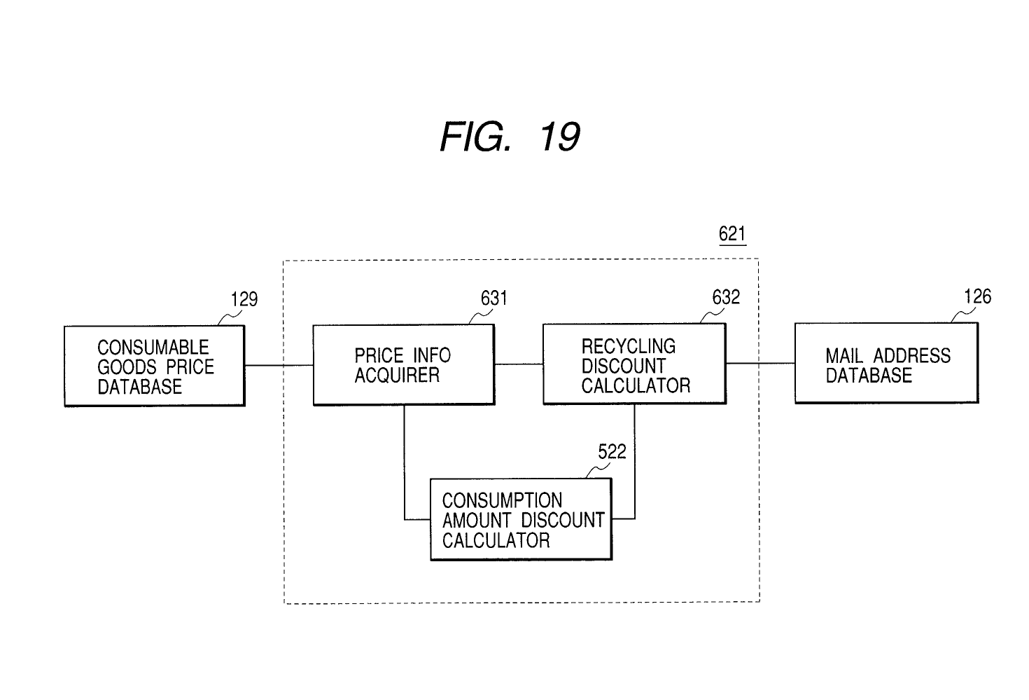

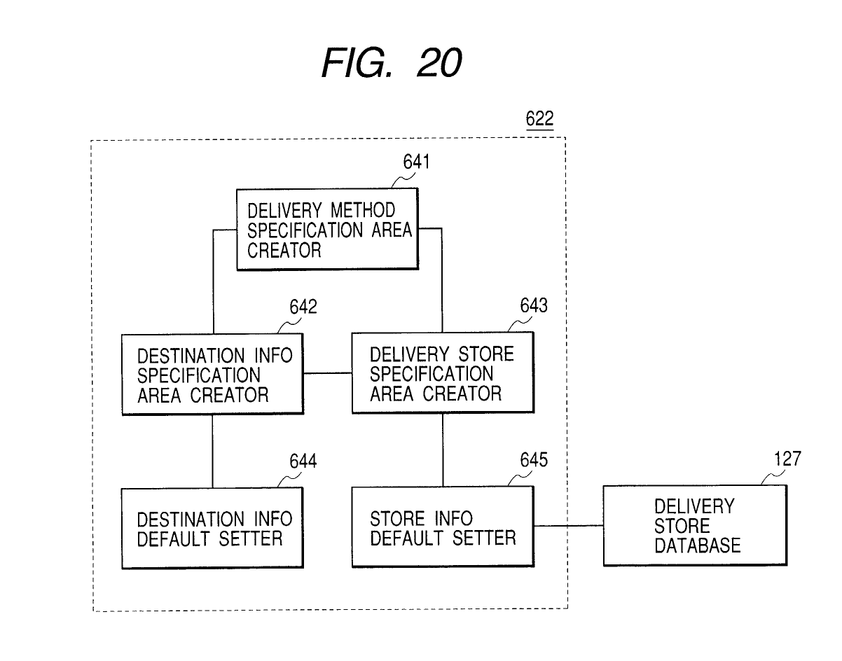

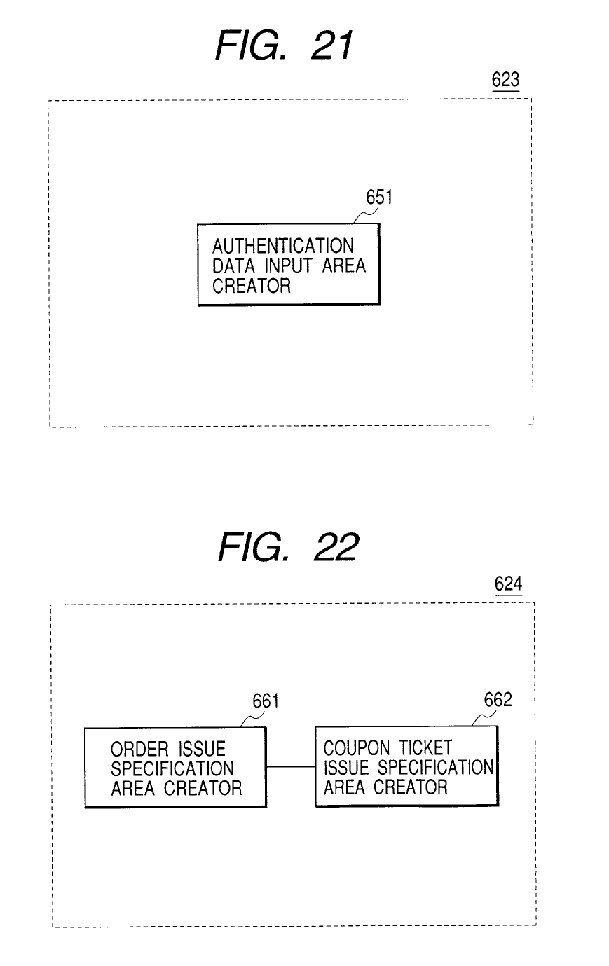

Further, as shown in FIG. 17, the information processing means 121 comprises order table creating means 611 that creates an order table based on the order start information acquired by the order start information acquiring means and order table sending means 612 that sends the created order table to the communication information equipment. As shown in FIG. 18, the order table creating means 611 comprises price information portion creating means 621 that creates the price information portion of the order table, delivery information portion creating means 622 that creates the delivery information portion of the order table, electronic settlement information portion creating means 623 that creates the electronic settlement information of the order table, and order issue portion creating means 624 that creates the order issue portion of the order table. As shown in FIG. 19, the price information portion creating means 621 comprises price information acquiring means 631 that retrieves the consumable goods price database 129 based on the machine type information in the order start information and acquires the price information and inventory information of the consumable goods that match the machine type information, the consumption amount discount calculating means 522 that calculates the discount information that matches the consumption amount of the consumable goods, and recycling discount calculating means 632 that acquires the number of recovery cartridges stored in the mail address database 120 and calculates the discount that matches the number of recovery cartridges. The information processing means 121 creates the price information portion for each mail order center according to the price information, inventory information, consumption amount discount information, recycling discount information, and number of orders setting area obtained by each of the means, acquires the price information acquired by the price information acquiring means in the order sorted in the price order on the consumable goods price database, creates the price information portion in the state sorted according to the price and creates the price information portion of the order table of which priority is given to the specified mail order center when there is a specification in the connection information to the mail order center server in the start information. As shown in FIG. 20, the delivery information portion creating means 622 comprises delivery method specification area means 641 that creates the specification area in which the delivery method including at least any one of mailing, conveyance, and store-based delivery as the specification of the delivery method, destination information specification area creating means 642 that creates the destination information specification area required for the mailing and conveyance, and delivery store specification area creating means 643 that creates the delivery store specification area required for the store-based delivery, and creates the specification area obtained by each of the means as the delivery information portion. At the creation of the destination information specification area, destination information default setting means 644 sets at least one of the postal number, address, name, and telephone number written to the owner information in the order start information as a default value. At the creation of the delivery store specification regional store information default setting means 645 specifies a delivery area from the postal number, address, and telephone number, retrieves a delivery store database 127 from the specified area information, sets the store that is doing business at the delivery area so that it can preferentially be specified as a default, and always updates and registers the latest data according to the management of the portal server administrator concerning the delivery store database 127. As shown in FIG. 21, the electronic settlement information portion creating means 623 comprises authentication data input area creating means 651 that creates the area in which the authentication data required for performing an electronic settlement in the electronic settlement server and creates the authentication data input area created by the authentication data area input area creating means as the electronic settlement information portion. As shown in FIG. 22, the order issue portion creating means 624 comprises order issue specification area creating means 661 that creates the area in which the activation of a mail order issue instruction can be specified and coupon ticket issuing specification area creating means 662 that creates the area in which the activation of a coupon ticket issuing instruction can be specified, and creates the specification area created by the coupon ticket issuing specification area creating means as the order issue portion.

As shown in FIG. 24, the information processing means 121 comprises a coupon issuing notification reception means 711 that receives a coupon issuing notification and an order table, a coupon issuing means 712 that receives the coupon issuing notification and the order table and issues coupon information based on consumption discount information and recycling discount information included in the order table, and a coupon information sending means 713 that sends the issued coupon information to the communication information equipment.

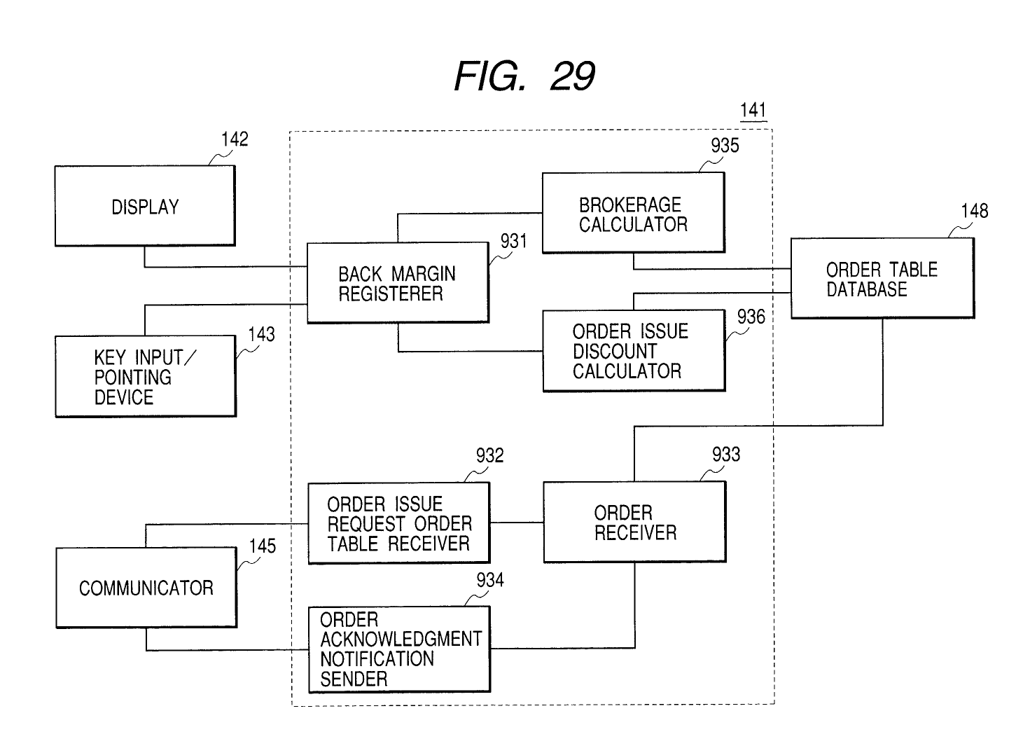

Further, as shown in FIG. 27, the information processing means 121 comprises back margin registering means 911 at the side of the manufacturer that registers the information about brokerage and discount fee that match the handling amount determined according to the arrangement with each mail order center by the data input of the portal server administrator, order issue notification receiving means 912 that receives an order issue notification from the communication information equipment, electronic settlement acknowledgement requesting means 913 that receives the order issue notification, creates acknowledgement information based on authentication data input to the order table, sends it to the electronic settlement server, and performs an electronic settlement acknowledgment request for order issue merchandise to the specified mail order center, order issue request mediating means 914 that receives acknowledgment result notification information from the electronic settlement server and performs mediation to the mail order center server, received order acknowledged notification receiving means 915 that receives a received order acknowledgment notification from the mail order center server, and order issue completion notification sending means 916 that receives the received order acknowledgment notification and an order issue completion notification to the communication information equipment. As shown in FIG. 28, the order issue request mediating means comprises number of mediation items counting means 921 that counts the number of mediation items for each mail order center when an electronic settlement is acknowledged according to the acknowledgment result notification information from the electronic settlement server, order issue request registering means 922 that registers the number of orders counted by the number of mediation items counting means in the mail order center registration information database 128 for each mail order center together with the order table of the order of which the order issue request is received, order issue request order table sending means 923 that sends the order table of which the order issue is received to the mail order center server, and electronic settlement not-acknowledged notification means that sends an electronic settlement not-acknowledged notification to the communication information equipment when no electronic settlement is acknowledged. As shown in FIG. 27, the information processing means of the portal server comprises brokerage calculating means 918 at the side of the manufacturer that calculates the brokerage paid from the side of the mail order center according to the number of orders that is counted by the number of mediation items counting means and registered in the mail order center registration information database by the order issue request registering means and order issue discount calculating means 917 at the side of the manufacturer that calculates the discount paid to the mail order center in accordance with the number of mediation items.

Further, as shown in FIG. 32, the information processing means 121 of the portal server comprises settlement information calculating means 1012 at the side of the manufacturer that calculates monthly settlement information for each mail order center on a monthly settling day or according to the instruction of the server administrator, settlement information sending means 1011 at the side of the manufacturer that sends the calculated settlement information to each mail order center, settlement information backup means 1013 at the side of the manufacturer that backs up all of the settlement information total, settlement information, and order table handled within a settling month to the backup area of the second mail order center registration information database for each mail order center, settlement information clearing means 1014 at the side of the manufacturer that clears the number of orders and an issued order table within the predetermined period when the settlement information is backed up by the settlement information backup means 1015 at the side of the manufacturer, and settlement information utility means at the side of the manufacturer that prints and deletes the information backed up in the backup area according to the instruction of the portal server administrator. As shown in FIG. 34, the settlement information calculating means 1011 at the side of the manufacturer comprises consumption discount price total calculating means 1021 at the side of the manufacturer that calculates the total of consumption discount price recorded in the order table as the settlement information against all the order tables of the mail order center specified in the mail order center registration database, recycling discount price total calculating means 1022 that calculates the total of the recycling discount price recorded in the order table as the settlement information, the brokerage calculating means 916 at the side of the manufacturer that calculates the brokerage paid from the side of the mail order center as the settlement information in accordance with the number of orders, the order issue discount calculating means 917 at the side of the manufacturer that calculates the discount paid to the mail order center as the settlement information in accordance with the number of mediation items, and settlement information total calculating means 1023 at the side of the manufacturer that calculates the value in which the order issue discount price is subtracted from the total of a consumption discount price, a recycling discount price, and order issue brokerage as the settlement information total.

Further, as shown in FIG. 37, the information processing means 121 comprises stored merchandise order issue receiving means 1211 that receives an order issue of stored merchandise of which order issue is given by the stored merchandise order issuing means and stored merchandise order issue mediating means 1212 that mediates a received order of stored merchandise and sends an order table to the merchandise control center server of the consumable goods.

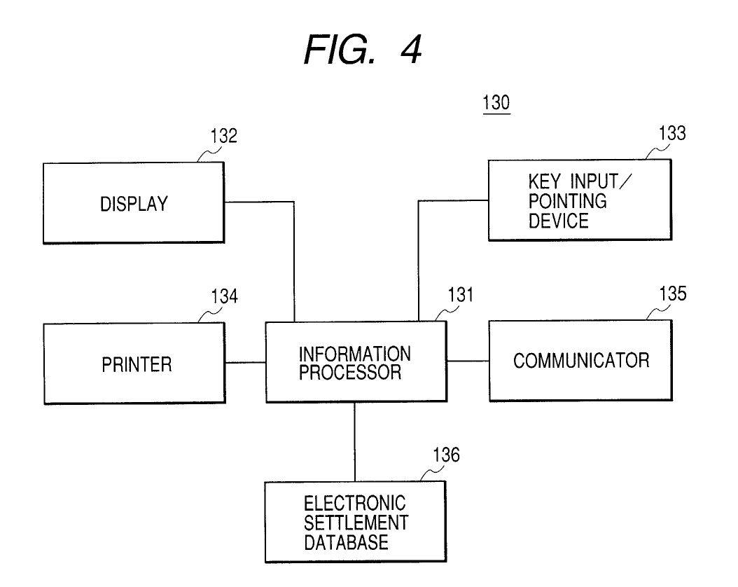

Further, the electronic settlement server 130 according to this embodiment is an electronic settlement server that performs the settlement of the transaction performed in the communication information equipment 110 connected to communication information equipment 110 that consumes the consumable goods, a portal server 120 to which data is sent from the communication information equipment, a mail order center server 140 for mail-ordering the consumable goods, a recycling plant server 150 installed in a recycling plant of the consumable goods, and a merchandise control center server 150 installed in a merchandise control center of the consumable goods via a network. As shown in FIG. 4, the server 130 comprises third information processing means 131 that performs an electronic settlement based on the authentication information input by the input means on the communication information equipment, third screen display means 132 that displays information-processed information, key input/pointing means 133 that inputs information necessary for information processing with a key or by a pointing device on the screen, printing means 134 that prints information-processed contents, communicating means 135 that communicates the information necessary for performing the electronic settlement, and electronic settlement database 136 in which the data required for performing the electronic settlement is stored.

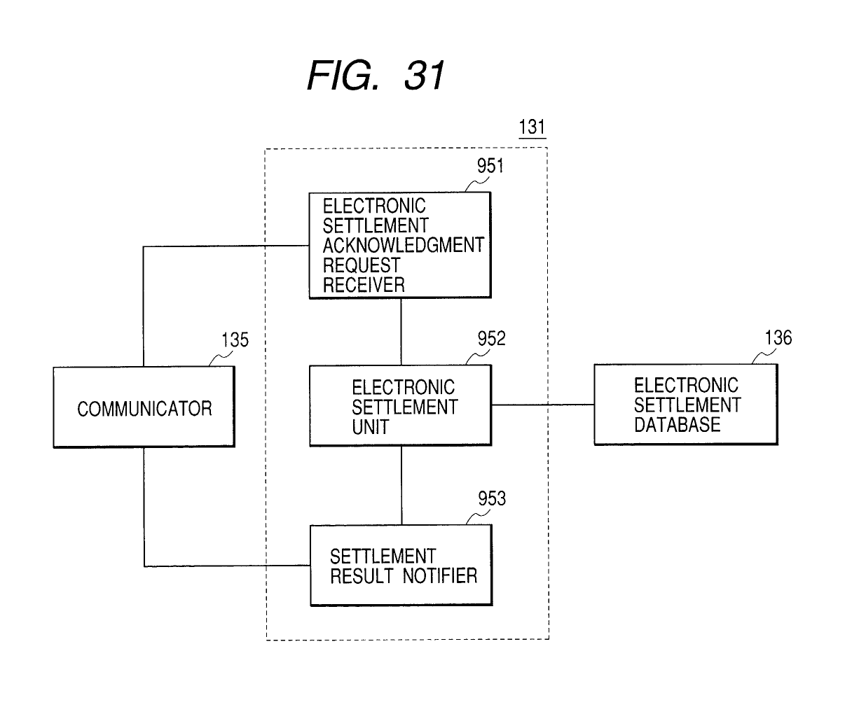

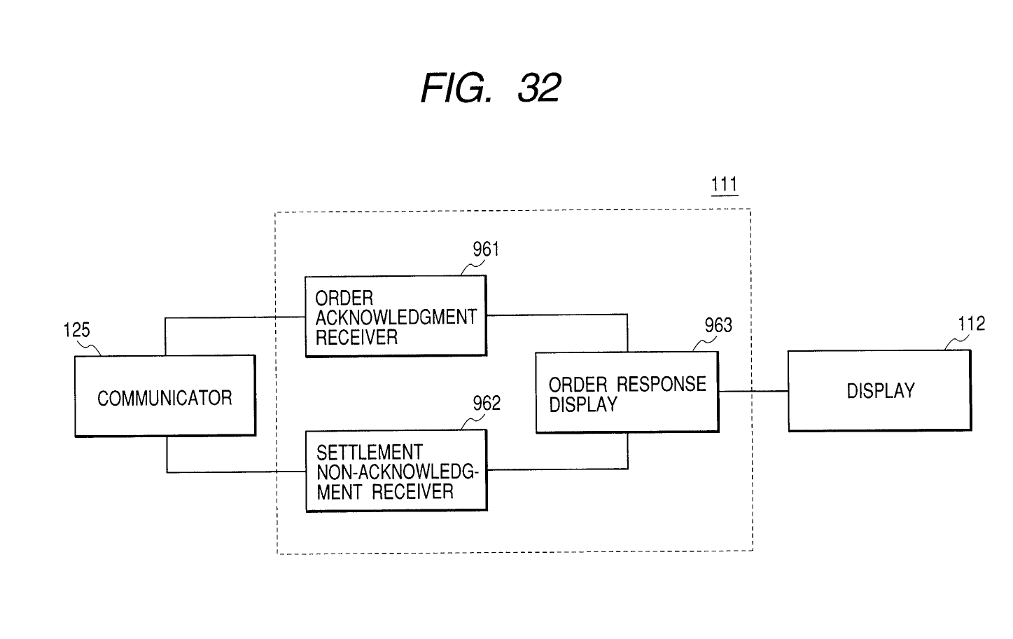

Further, as shown in FIG. 31, the information processing means comprise electronic settlement acknowledgment request receiving means 951 that accepts an electronic settlement acknowledgment request from the portal server and receives acknowledgment information, electronic settlement means 952 that performs the electronic settlement based on the acknowledgment and electronic settlement database, and electronic settlement acknowledgment result information notification means 953 that sends the result of the electronic settlement to the portal server as acknowledgment result notification information.

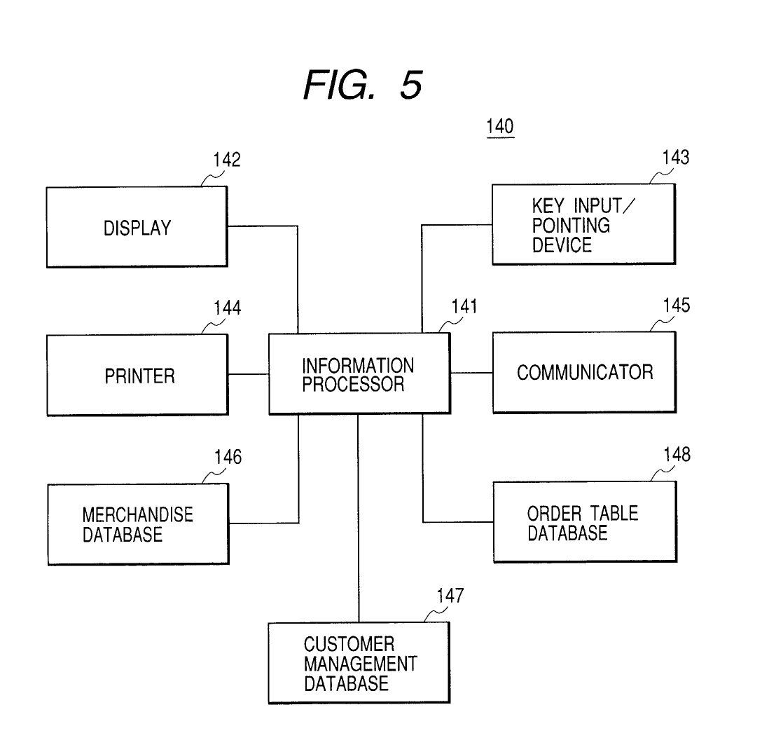

Further, as shown in FIG. 1, the mail order center server 140 according to the present embodiment is a mail order center server 140 for mail-ordering consumable goods connected to communication information equipment 110 that consumes the consumable goods, a portal server 120 to which data is sent from the communication information equipment, an electronic settlement server 130 that performs the settlement of the transaction performed in the communication information equipment, a recycling plant server 150 installed in the recycling plant of the consumable goods, and a merchandise control center server 160 installed in the consumable goods via a network. As shown in FIG. 5, the server 140 comprises information processing means 141 that performs processing of each information in the mail order center server, screen display means 142 that displays information-processed information on the screen, key input/pointing means 143 that inputs information necessary for information processing with a key/by a pointing device on the screen, printing means 144 that prints information-processed contents, communicating means 145 that communicates the information-processed contents via the network 100, merchandise database 146 in which the merchandise data required for receiving the mail order including the price and the stock quantity of the consumable goods controlled in the mail order center, a customer management database 147 in which the customer information of the customer whose order request is given, and a order table database 148 for storing the order table for which an order is given.

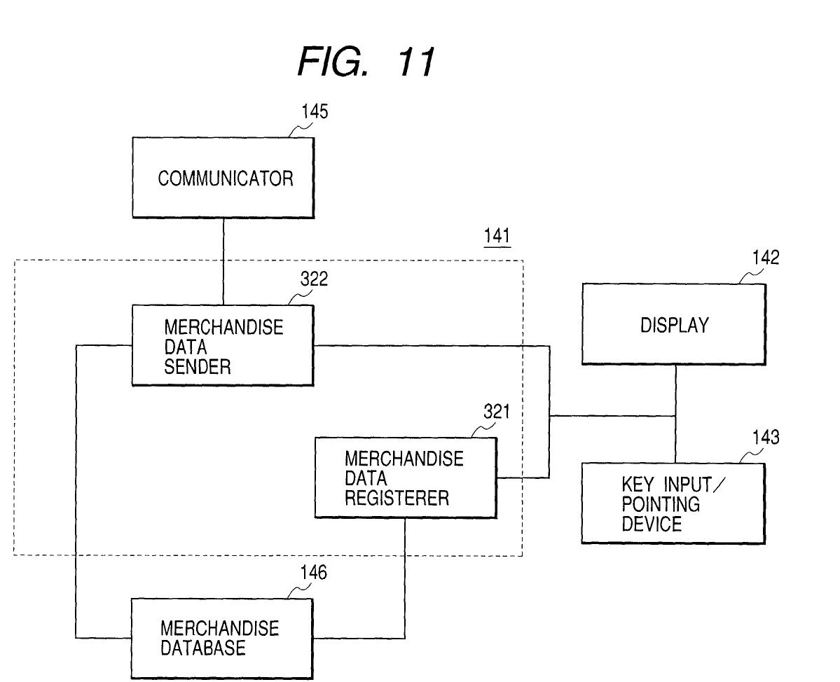

Further, as shown in FIG. 11, the information processing means 141 comprises merchandise data registering means 221 that the merchandise data required for receiving a mail order in the merchandise database 146 including the price and the stock quantity input from the server administrator and merchandise data sending means 322 that sends the merchandise data of the merchandise database 146 to the portal server of the equipment manufacturer according to the instruction of the server administrator.

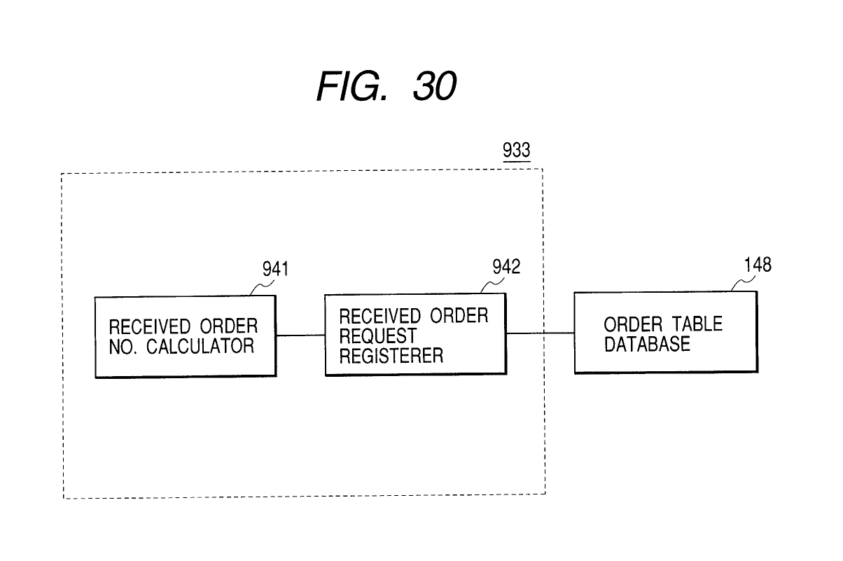

Further, as shown in FIG. 29, the information processing means 141 comprises back margin registering means 931 at the side of the manufacturer that registers the information about brokerage and discount fee that match the handling amount determined according to the arrangement with each mail order center by the data input of the server administrator of each mail order center, order issue request order table receiving means that receives an order issue notification from the portal server, order issue receiving means 933 that receives an order issue request, and order received acknowledgement notification sending means that sends an received order acknowledgment notification to the portal server when it is received. As shown in FIG. 30, the received order means 933 comprises number of received orders counting means 941 that counts the number of order issue request items from the portal server as the number of received orders and received order request registering means 942 that registers the number of received orders counted by the number of received orders counting means in the order table database 148 together with the order table of the order of which the order issue request is received. As shown in FIG. 29, the information processing of the mail order center server comprises brokerage calculating means 935 at the side of the mail order center that calculates the brokerage paid to the equipment manufacturer in accordance with the number of received orders counted by the number of orders counting means registered in the order table database by the received order request registering means and order issue discount calculating means 936 at the side of the mail order center that calculates the discount paid from the side of the equipment manufacturer in accordance with the number of received orders.

Further, as shown in FIG. 35, the information processing means 141 comprises merchandise conveyance procedure means 111 that performs the conveyance procedure of merchandise based on the delivery method specified in the order table against the order table for which the conveyance procedure registered in the order table database 148 is not terminated according to the instruction of the server administrator, conveyance procedure termination registering means 1112 that registers the termination of the conveyance procedure in the order table database against the order table for which the merchandise conveyance procedure is terminated, and stored merchandise order issuing means 1113 that performs an order issue of stored merchandise against the portal server according to the instruction of the server administrator when no stock remaining quantity is reported by the merchandise conveyance procedure means 1111. As shown in FIG. 36, the merchandise conveyance procedure means 1111 comprises stock quantity control means 1121 that updates a stock quantity in the merchandise database 148 in accordance with the number of received orders and reports the information about no stock remaining quantity to the server administrator of the mail order center when the stock quantity is exhausted, merchandise data sending means 1122 that receives the update of the stock quantity and sends the updated merchandise data of the merchandise database 146 to the portal server of the equipment manufacturer, and conveyance destination label printing means 1123 that prints the postal number, address, and name of a conveyance destination on a label paper based on the owner information of the order table.

Further, as shown in FIG. 39, the information processing means 141 of the mail order center server comprises money-received confirmation information adding means 1311 that adds money-received confirmation information to the order table of which the money received for an order is checked at a monthly settling day or according to the instruction of the server administrator, settlement information calculating means 1312 at the side of the mail order center that calculates monthly settlement information, settlement information sending means 1313 at the side of the mail order center that sends the calculated settlement information to the equipment manufacturer portal server, settlement information backup means 1314 at the side of the mail order center that backs up all of the settlement information total, settlement information, and received order table handled within a settling month in the backup area of the order table database 148, settlement information clearing means 1315 at the side of the mail order center that clears the number of monthly received orders issued and received order table when the settlement information is backed up by the backup means, and settlement information utility means 1316 at the side of the mail order center that prints and deletes the information backed up in the backup area according to the instruction of the portal server administrator. As shown in FIG. 40, the settlement information calculating means 1312 at the side of the mail order center comprises money-not-received calculating means 1312 that calculates the total of the money-not-received order table to which the money-received confirmation information is not added against all the monthly received order tables registered in the fourth order table database, money-not-received order table creating means 1322 that creates a list of money-not-received order tables, money-received total calculating means 1323 that calculates the total of the merchandise price of the money order table to which the money-received confirmation information is added, consumption discount price total calculating means 1324 at the side of the mail order center that calculates the total of the consumption discount price recorded in the order table as the settlement information, recycling discount price total calculating means 1325 at the side of the mail order center that calculates the total of the consumption discharge recorded in the order table as the settlement list, the brokerage calculating means 935 at the side of the mail order center that calculates the brokerage paid to the equipment manufacturer in accordance with the number of orders, order issue discount calculating means 936 at the side of the mail order center that calculates the discount paid to the side of the mail order center in accordance with the number of mediation items, and settlement information total calculating means 1326 at the side of the mail order center that calculates the value in which the order issue discount price is subtracted from the total of a consumption discount price, a recycling discount price, and order issue brokerage as the settlement information total.

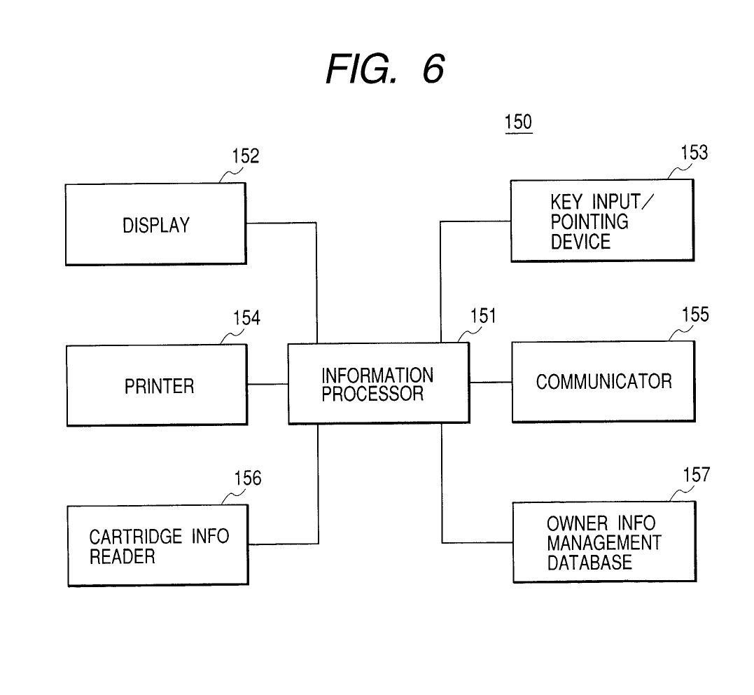

Further, as shown in FIG. 1, the recycling plant server 150 according to the present embodiment is a recycling plant server installed in the recycling plant of the consumable goods connected to communication information equipment 110, a portal server 120 to which data is sent from the communication information equipment, an electronic settlement server 130 that performs the settlement of the transaction performed in the communication information equipment, a mail order center server 140 for mail-ordering the consumable goods, and a merchandise control center server 160 installed in the recycling plant of the consumable goods via a network 100. As shown in FIG. 6, the server 150 comprises information processing means 151 that performs processing of various information in the recycling plant server, screen display means 152 that displays information-processed information on the screen, fifth key input/pointing means 153 that inputs the information necessary for information processing with a key/by pointing device on the screen, printing means 154 that prints information-processed contents, communicating means 155 that communicates the information-processed contents via the network, fifth cartridge information reader 156 that reads the owner information stored in the storage area of the cartridge recovered in the recycling plant, and an owner information management database 157 in which the number of recovery cartridges and the owner information are linked and stored.

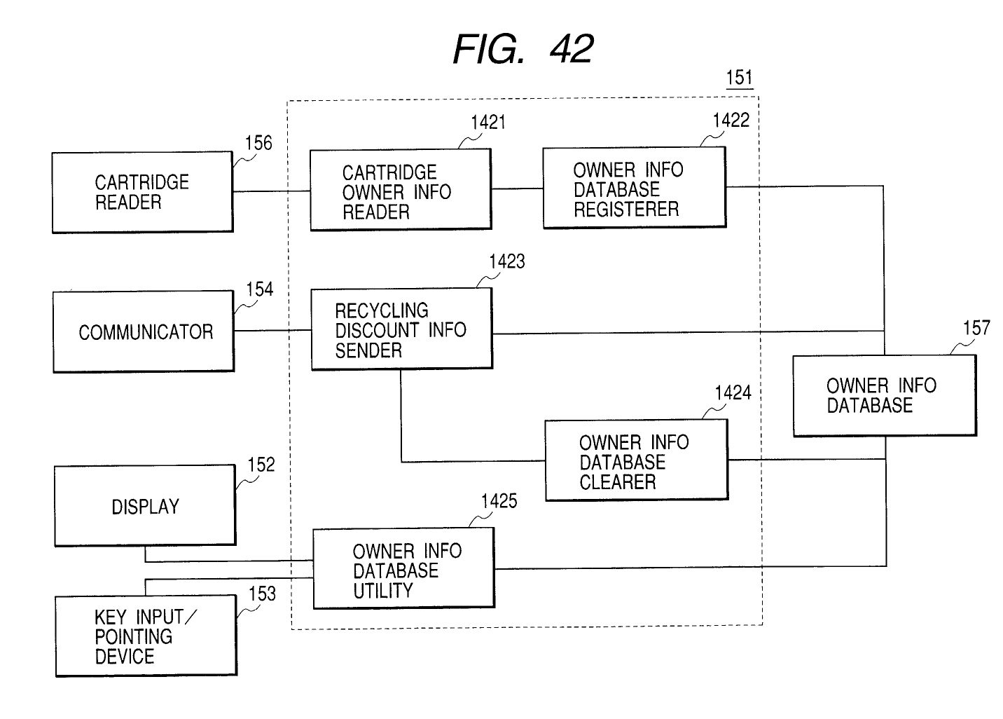

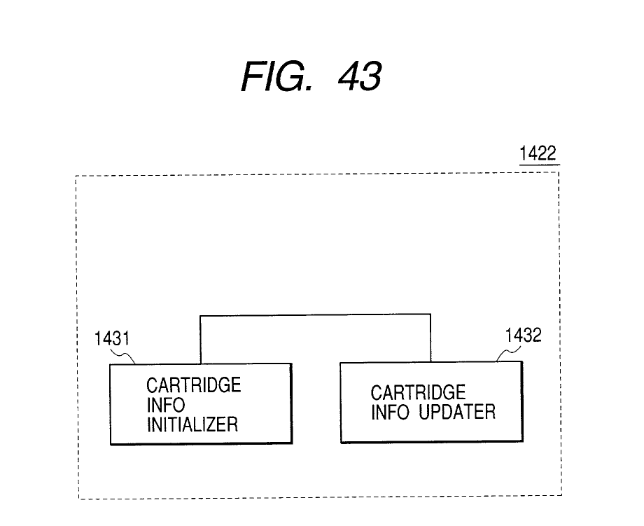

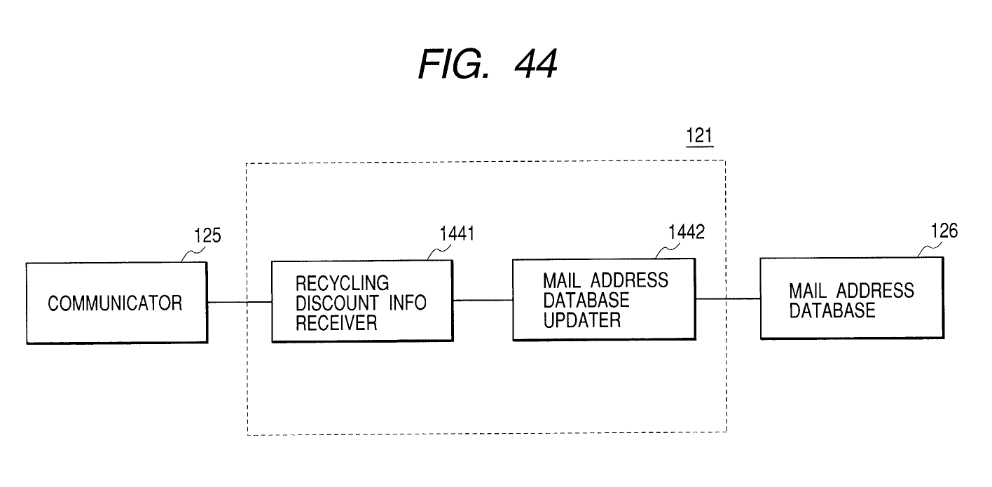

Further, as shown in FIG. 42, the information processing means 151 comprises cartridge owner information reading means 1421 that reads the owner information stored in the storage area of the recovered cartridge by the cartridge information reader 156, owner information management database registering means 1422 that acquires mail address information from the read owner information and registers it in the owner information management database 157, recycling discount information sending means 1423 that periodically sends the mail address information and recovery cartridge information registered in the owner information management database 157 to the portal server of the equipment manufacturer as recycling discount information, owner information management data clearing means 1424 that clears the sent mail address information and recovery cartridge information of the owner information management database 157 from the owner management database after sending processing is performed by the recycling discount information sending means, and owner information management database utility means 1425 that displays, prints, and deletes the contents of the owner information management database according to the instruction of the server administrator. As shown in FIG. 43, the owner information management database registering means 1422 comprises recovery cartridge information initializing means 1431 that sets the recovery cartridge information to 1 and registers it in the owner information management database 157 together with mail address information when the mail address information of the read owner information by the cartridge owner information reading means is not registered in the owner information management database and recovery cartridge information updating means 1432 that increments (counts up) and updates the recovery cartridge information in the database.

Further, as shown in FIG. 1, the merchandise control center server 150 according to the present embodiment is a merchandise control center server installed in the merchandise management center of consumable goods connected to communication information equipment 110 that consumes the consumable goods, a portal server 120 to which data is sent from the communication information equipment, an electronic settlement server 130 that performs the settlement of the transaction performed in the communication information equipment, a mail order center server 140 for mail-ordering the consumable goods, and a recycling plant server 150 installed in a recycling plant via a network. As shon in FIG. 1, the server 150 comprises sixth information processing means 161 that performs the processing of various information in the merchandise control center server, screen display means 162 that displays information-processed information on the screen, key input/pointing means 163 that inputs the information necessary for information processing with a key or by a pointing device on the screen, printing means 164 that prints the information-processed contents, communicating means 165 that communicates the information-processed contents via the network, and merchandise inventory control database 166 in which the merchandise inventory control information of the consumable goods is recorded.

Further, as shown in FIG. 38, the information processing means 161 comprises stored merchandise order table receiving means 1221 that receives an order table of stored merchandise by the stored merchandise order issue mediating means and stored merchandise conveyance means 1222 that updates the merchandise inventory control in which the merchandise inventory control information of consumable goods and delivers the stored merchandise of which the order issue is given to the mail order center of which the order request is given.

Further, the consumable goods online shopping method according to the present invention applies to a consumable goods online shopping system that comprises communication information equipment that consumes consumable goods, a portal server to which data is sent from the communication information equipment, an electronic settlement server that performs the settlement of the transaction performed in the communication information equipment, a mail order center server for mail-ordering the consumable goods, a recycling plant server installed in the recycling plant of the consumable goods, and a merchandise control center server installed in the merchandise control center of the consumable goods that interconnect via a network, wherein it comprises the first information processing step that performs the processing of various information in the communication information equipment, the first screen display step that displays information-processed information on the screen, the first key input/pointing step that inputs the information necessary for information processing with a key/by a pointing device on the screen, the first printing step that prints information-processed information, the first communication step that communicates the information-processed contents via the network, the first consumable goods consumption execution step that executes the processing which consumes the consumable goods, the first consumable goods remaining quantity detection step that detects the remaining quantity of the consumable goods, the second information processing step that performs the processing of various information in the portal server, the second screen display step that displays information-processed information on the screen, the second key input/pointing process that inputs the information necessary for information processing with the key or by the pointing device on the screen, the second printing step that prints information-processed contents, the second communication step that communicates information-processed contents via the network, the twenty-first storage step that stores the mail address and recovery cartridge information of the communication information equipment connected to the portal server in the second mail address database, the twenty-second storage step that stores the delivery store of the consumable goods in the second delivery store database for each area, the twenty-third storage step that stores the information of the mail order center that is connected to the portal server and from which the order issue of the consumable goods is given in the second mail order center registration information database, the twenty-fourth storage step that stores individual merchandise price information in the second consumable goods price database for each mail order center, the third information processing step that performs the electronic settlement based on the authentication information input according to the first processing input on the communication information equipment, the third screen display step that displays information-processed information on the screen, the third key input/pointing step that inputs the information necessary for information processing with the key or by the pointing device on the screen, the third printing step that prints information-processed contents, the third communication step for communicating the information necessary for performing the electronic settlement, the third storage step that stores the data necessary for performing the electronic settlement, the fourth information processing step that performs the processing of various information in the nail order center server, the fourth screen display step that displays information-processed on the screen, the fourth key input/pointing step that inputs the information necessary for information processing with the key or by the pointing device, the fourth printing step that prints information-processed contents, the fourth communication step that communicates the information-processed contents via the network, the forty-first storage step that stores the merchandise data necessary for the mail order including the price and the stock quantity controlled in the mail order center in the fourth merchandise database, the forty-second storage step that stores the customer information of the customer of which order is requested in the fourth customer management database, the forty-third storage step the order table of which the order is given in the fourth order table database, the fifth information processing step that performs the processing of various information in the recycling plant server, the fifth screen display step that displays information-processed information on the screen, the fifth key input/pointing step that inputs the information necessary for information processing with the key or by the point device on the screen, the fifth printing step that prints information-processed contents, the fifth communication step that communicates the information-processed information contents via the network, the fifth cartridge owner reading step that reads the owner information stored in the storage area of the cartridge recovered in a recycling plant, the fifth cartridge information reading step that links and stores the number of recovery cartridges and the owner information, the sixth information processing step that performs the processing of various information in the merchandise control center server, the sixth screen display step that displays information-processed information on the screen, the sixth key input/pointing step that inputs the information necessary for information processing, the sixth printing step that prints information-processed contents, the sixth communication step that communicates the information-processed contents via the network, and the sixth merchandise inventory step that records the merchandise inventory control information of the consumable goods.

Further, the first information processing step in the communication information equipment comprises an owner information registration step that stores the information for identifying an owner including at least any one of a mail address, a postal number, an address, and a telephone number in the storage area of the equipment as the owner information and a mail address automatic registration step that performs automatic connection to the portal server, issues a mail address acquisition request to the portal server, and automatically registers the allocated and sent mail address by the portal server in the owner information mail address when the mail address is not registered regarding the mail address. The second information processing step in the portal server comprises a mail address notification step that receives the mail address acquisition request issued according to the mail address automatic registration step of the communication information equipment, retrieves the second mail address database and allocates and reports an unregistered empty mail address as the mail address of the requested communication information equipment, an automatic allocation step that automatically allocates the empty mail address for the mail address allocation, and an empty mail address retrieval step that supports the allocation by the portal server administrator.

Further, the second information processing step in the portal server comprises a mail order center information registration step that registers the information about the order issue destination mail order center of an order table in the second mail order center server by the input of the portal server administrator using the second key input/pointing step. The fourth information processing step in the mail order center server comprises a merchandise data registration step that stores the merchandise data necessary for receiving the mail order including the price and the stock quantity input by the server administrator in the fourth merchandise database and a merchandise data sending step that sends the merchandise data in the fourth merchandise database to the portal server of the equipment manufacturer according to the instruction of the server administrator. The second information processing step in the portal server comprises a consumable goods price data registration step that receives the price information and the stock information of the consumable goods that are registered in the second mail order center registration database and periodically sent from the mail order center server and a price information sorting step that sorts the price information and the mail order center name for each area jenre-classified by consumable goods in the order of the price and associates and stores them.

Further, the first information processing step in the communication information equipment comprises a remaining quantity alarming step that detects the remaining quantity of the consumable goods in the first consumable goods remaining quantity detecting step and displays a remaining quantity alarm when the value that goes below a fixed amount is detected, an order start request notification automatic issue mode setting step that automatically issues an order start request automatic request notification of the consumable goods to the portal server when the order start request notification automatic issue mode is ON after the remaining quantity alarm is displayed, an order start request notification automatic issuing step that sets the order start request notification automatic issuing mode is ON, an order start request issuing step that issues an order start request notification to the portal server according to the user instruction, an order start information sending step that sends necessary information to the portal server as the order start information by the issue of the order start request notification. The order start information sending step comprises an order information generation step that generates the order start information including at least any one of the machine type information of the equipment that enables the discrimination of the consumable goods consumption amount and the discrimination of the consumable goods accumulated in the storage area, the owner information stored in the storage area of the equipment, and the connection information to the mail order center that is preferentially specified in the storage area of the equipment, an order start information auxiliary input step that urges the input of missing information and performs the auxiliary input processing of necessary information when the necessary information is missing at the generation of the order start information, and a order start information sending start step that starts the sending processing of the generated order start information.

Further, the first information processing step in the communication information equipment comprises a consumption amount counting step that increments (counts up) a consumption amount of the consumable goods and accumulates it in the storage area after the first consumable goods consumption execution step operates. The order start information sending step comprises an order start information generation step that refers to a consumption amount of the consumable goods counted by the consumption amount counting step and generates it as the order start information. The second information processing step of the portal server comprises an order start information acquisition step that receives order start information sent from the side of the communication information equipment and acquires the order start information and a consumption amount discount calculation step that calculates the discount that matches the consumption amount of the consumable goods in the acquired order start information.

Further, the second information processing step in the portal server comprises an order table creation step that creates an order table based on the order start information acquired in the order table start information acquisition step and an order table sending step that sends the created order table to the communication information equipment. The order table creation step comprises a price information portion creation step that creates the price information portion of the order table, a delivery information portion creation step that the delivery information portion of the order table, an electronic settlement information portion creation step that creates the electronic settlement information portion of the order table, and an order issue creation step that creates the order issue portion of the order table. The price information portion creation step comprises a price information acquisition step that retrieves the second consumable goods price data based on the machine type information in the order start information and acquires the price information and the inventory information of the consumable goods that match the machine type information, the consumption amount discount calculation step that calculates the discount information that matches the consumption amount of the consumable goods, and a recycling discount calculation step that acquires the number of recovery cartridges stored in the second mail address database and calculates the discount information in accordance with the number of recovery cartridges. The second information processing step creates a price information portion for each mail order center according to the price information, inventory information, consumption amount discount information, recycling discount information, and number of orders setting area obtained in each of the steps, acquires the price information acquired in the order sorted in the price order on the consumable goods price data, creates the price information portion in the state sorted according to the price, and creates the price information portion of the order table in which priority is given to the specified mail order center when there is a specification in the connection information to the mail order center in the order start information. The delivery information portion creation step comprises a delivery method specification area creation step that creates the specification area in which the delivery method including at least any one of mailing, conveyance, and store delivery as the specification of the delivery method, a destination information specification area creation step that creates the destination information specification area necessary for the mailing and conveyance, and a delivery store specification area creation step that creates the delivery store specification area necessary for the store-based delivery, and creates the delivery specification area obtained in each of the steps as the delivery information portion. At the creation of the destination information specification area, a destination information default setting step sets at least one of the postal number, address, name, and telephone number described in the owner information in the order start information as a fault value. At the creation of the delivery store specification area, a store information default setting step specifies a delivery area from the postal number, address, name, and telephone number, retrieves a second delivery store database from the specified area information, sets the store that is doing business in the delivery area so that it can preferentially be specified, and always updates and registers the latest data by the control of the portal administrator concerning the second delivery store database. The electronic settlement information portion step comprises an authentication data input area creation step that creates the area to which the authentication data necessary for performing the electronic settlement in the electronic settlement server and creates the authentication data input area created in the authentication data input area creation step as the electronic settlement information portion. The order issue portion creation step comprises an order issue specification area creation step that creates the area in which the activation of the order issue instruction of the mail order can be specified and a coupon ticket issuing specification area that creates the area in which the activation of the coupon ticket issuing instruction can be specified, and creates the specification area created in the coupon ticket issuing specification area creation step as the order issue portion. The first information processing step of the communication information equipment comprises an order table receiving step that receives an order table sent in the order table sending step, an order table display step that displays the received order table on the screen, an order table input step that inputs the data necessary for the order table on the displayed screen and performs the order issue and the coupon ticket issuing instruction, an order issue notification step that sends the order issue notification and the order table to which necessary data are input to the portal server of the equipment manufacturer when the order issue instruction is given, a coupon ticket issuing notification step that sends a coupon ticket issuing notification and the order table to the portal server of the equipment manufacturer, and an order cancellation step that cancels an order.

Further, the second information processing step in the portal server comprises a coupon ticket issuing notification receiving step that receives the coupon ticket issuing notification and the order table sent in the coupon ticket issuing step and a coupon ticket issuing processing step that receives the coupon ticket issuing notification and the order table and performs the ticket issuing of the coupon information based on the consumption amount discount information and recycling discount information provided in the price information portion of the order table. The first information processing step of the communication information equipment comprises a coupon information receiving step that receives coupon information sent from the coupon information sending step and stores it in the storage area of the equipment and a coupon information updating step that calculates a consumption amount discount based on the discount rate that matches the consumption amount previously stored in the equipment, compares the coupon information generated from the consumption amount discount and the coupon information stored in the storage area, and changes the coupon information in the storage area to the coupon information that is advantageous for the discount, and an online coupon ticket printing step that prints the coupon information stored in the storage area through the printing step as a coupon ticket.

Further, the first information processing step in the communication information equipment comprises a mail order center registration step that specifies a specific mail order center from a plurality of mail order centers provided in the price information portion of the order table displayed in the order table display step and can register a plurality of mail order centers specified in the storage area of the equipment, a mail order center registration deletion step that registers and deletes a specific mail order center from the mail order center registration memory that is the storage area of the equipment in which the mail order center is registered and the memory order center registered in the mail order center registration memory, a mail order center specification step that can preferentially specify a specific mail order center from the plurality of mail order centers registered in the mail order center registration memory, and a mail order center priority release step that can release preferential specification.

Further, the second information processing step of the portal server comprises a back margin registration step at the side of the manufacturer that registers the information about brokerage and discount that match the handling amount determined according to the arrangement with each mail order center by the data input of the portal server administrator, an order issue notification receiving step that receives an order issue notification from the communication information equipment, an electronic settlement acknowledgment request step that receives the order issue notification, creates acknowledgment information based on the authentication data input to the order table, sends it to the electronic settlement server, and performs an electronic settlement acknowledgment request against the merchandise ordered to the specified mail order center, an order issue request mediation step that receives acknowledgment result information from the electronic settlement server and performs mediation to the mail order center, received order completion notification sending step that receives the received order acknowledgment notification and issues an order issue completion notification to the communication information equipment. The order issue request mediation step comprises a number of mediation items counting step that counts the number of mediation items for each mail order center based on the acknowledgment result notification information from the electronic settlement server when an electronic settlement is acknowledged, an order issue request registration step that registers the number of orders counted through the number of mediation items counting step in the second mail order registration information database together with the order table of the order of which the order issue request is received, an order issue request order table sending step that sends the order table of which the order issue request is received to the mail order center, and an electronic settlement not-acknowledged notification step that sends an electronic settlement not-acknowledged notification to the first communication information equipment. The second information processing step of the portal server comprises a brokerage calculation step at the side of the manufacturer that calculates the brokerage paid from the side of the mail order center in accordance with the number of orders that is counted through the number of mediation items counting step and registered in the mail order registration information database through the order issue request registration step and a brokerage calculation step at the side of the manufacturer that calculates the brokerage paid to the mail order center in accordance with the number of mediation items. The third information processing step in the electronic settlement server comprises an electronic settlement acknowledgment request receiving step that receives an electronic settlement acknowledgment request from the portal server and receives acknowledgment information, an electronic settlement step that performs an electronic settlement based on the acknowledgment information and electronic settlement database, and an electronic settlement acknowledgment result information notification step that sends the result of the electronic settlement to the portal server as the acknowledgment result notification information. The first information processing step in the communication information equipment comprises an order issue completion notification receiving step that receives an order issue completion notification from the portal server, an electronic settlement not-acknowledged notification receiving step that receives an electronic settlement not-acknowledged notification, and an order issue response notification display step that displays separately received notification contents. The fourth information processing step in the mail order center server comprises a back margin registration step at the side of the manufacturer that registers the information about brokerage and discount that match the handling amount determined according to the arrangement with each mail order center by the data input of the portal server administrator, an order issue request order table receiving step that receives an order issue request from the order issue request, a received order step that receives an order issue request, and sends a received order acknowledgment notification to the portal server when it is received. The received order step comprises a number of orders counting step that counts the number of order issue requests from the portal server as the number of received orders and a received order request registration step that registers the number of received orders counted through the number of received orders counting step in the fourth order table database together with the order table of an order of which the order issue request is received. The fourth communication information equipment in the mail order center server comprises a brokerage calculation step at the side of the mail order center that calculates the brokerage paid to the manufacturer in accordance with the number of orders registered in the order table database through the received order request registration step and an order issue discount calculation step at the side of the mail order center that calculates the discount fee paid from the equipment manufacturer in accordance with the number of received orders.

Further, the second information processing step of the portal server comprises a settlement information calculation step at the side of the manufacturer that calculates monthly settlement information for each mail order center on a monthly settling day or according to the instruction of the server administrator, a settlement information sending step at the side of the manufacturer that sends the calculated settlement information to each mail order center, a settlement information backup step at the side of the manufacturer that backs up all of the settlement information total, settlement information, and the order table handled within a settling month into the backup area of the second mail order center registration information database for each mail order center, a settlement information clearing step at the side of the manufacturer that clears the number of orders and an issued order table within a predetermined period when the settlement information is backed up by the settlement information backup step at the side of the manufacturer, and a settlement information utility step at the side of the manufacturer that prints and deletes the information backed up in the backup area according to the instruction of the portal server administrator. The settlement information calculation step at the side of the manufacturer comprises a consumption discount price total calculation step at the side of the manufacturer that calculates the total of a consumption discount price recorded in the order table as the settlement information against all the order tables of the mail order center specified in the second mail order center registration database, a recycling discount price total calculation step that calculates the total of the recycling discount price recorded in the order table as the settlement information, the brokerage calculation step at the side of the manufacturer that calculates the discount fee paid to the mail order center in accordance with the number of mediation items as the settlement information, the order issue discount calculation step at the side of the manufacturer that calculates the discount price paid to the mail order center in accordance with the number of mediation items, and the settlement information total calculation step at the side of the manufacturer that calculates the value in which the order issue discount is subtracted from the total of a consumption discount price, a recycling discount price, and order issue brokerage as the settlement information total.

Further, the fourth information processing step in the mail order center server comprises a merchandise conveyance procedure step that performs a merchandise conveyance procedure based on the delivery method specified in an order table for the order table of which the conveyance procedure registered in the fourth order table database is not terminated according to the instruction of the server administrator, a conveyance procedure termination registration step that registers conveyance procedure termination in the order table database for the order table of which the merchandise conveyance procedure is terminated, and a stored merchandise order issue step that performs an order issue of stored merchandise to the portal server according to the instruction of the server administrator when no stock remaining quantity is reported. The merchandise conveyance procedure step comprises a stock quantity control step that reports the information of no stock remaining quantity to the server administrator of the mail data center, a merchandise data sending step that receives the update of a stock quantity and sends the merchandise data updated in the fourth merchandise database to the postal server of the equipment manufacturer, and a conveyance destination label printing step that prints the postal number, address, and name of a conveyance destination on a label paper based on the owner information of the order table.

Further, the second information processing step in the portal server comprises a stored merchandise order issue receiving step of which the order issue is given through the stored merchandise order issue step and a stored merchandise order issue mediation step that mediates a received order of which the received order is given and sends an order table to the merchandise control center server. The sixth information processing step in the merchandise control center server of the consumable goods comprises a stored merchandise order table received order step that receives the order table of the stored merchandise through the stored merchandise order issue mediation step and an stored merchandise conveyance step that updates the sixth merchandise inventory control database in which the merchandise inventory control information of the consumable goods is recorded and delivers the stored merchandise of which the received order is given to the mail order center of which the order issue request is given.

Further, the fourth information processing step in the mail order center server comprises a money-received confirmation information addition step that adds money-received confirmation information to the order table of which the money received is confirmed on a monthly settling day or according to the instruction of the server administrator, a settlement information calculation step at the side of the mail order center that calculates monthly settlement information to the equipment manufacturer portal server, a settlement information backup step at the side of the mail order center that backs up all of the settlement information total, settlement information, and received order table handled within a settling month to the backup area of the fourth order table database, a settlement information clearing step at the side of the mail order center that clears the number of monthly received orders issued and a received order table when the settlement information is backed up the backup step and a settlement information utility step at the side of the mail order center that prints and deletes the information backed up in the backup area according to the information of the portal server administrator. The settlement information calculation step at the side of the mail order center comprises a money-not-received total calculation step that calculates the total of the money-not-received order table to which the money-received confirmation information is not added to all monthly order received order tables registered in the fourth order table database, a money-not-received order table listing creation step that creates a list of money-not-received order tables, a money-received total calculation step that calculates the total of the merchandise price of the money-received confirmation information is added, a consumption discount price total calculation step at the side of the mail order center that calculates the total of the consumption discount price recorded in the order table as the settlement information, a recycling discount price total calculation step at the side of the mail order center that calculates the total of the recycling discount price recorded on the order table as the settlement information, a brokerage calculation step at the side of the mail order center that calculates the brokerage paid to the equipment manufacturer as the settlement information in accordance with the number of orders, the order issue discount calculation step that calculates the discount paid to the mail order center as the settlement information in accordance with the number of mediation items, and a settlement information total calculation step at the side of the mail order center that calculates the value in which the order issue discount price is subtracted from the total of a consumption discount price, a recycling discount price, and order issue brokerage at the settlement information total.

Further, the first information processing step in the communication information equipment comprises an owner information cartridge storage step that stores owner information in the storage area at the side of the cartridge when consumable goods are of a cartridge type and there is the area in which the owner information is stored at the side of the cartridge. The fifth information processing step in the recycling plant server of the consumable goods comprises a cartridge owner information reading step that reads the owner information stored in the storage area of the recovered cartridge by the fifth cartridge information reader, an owner information management database registration step that acquires mail address information from the read owner information and resisters it in the fifth owner information management database, a recycling discount information sending step that periodically sends the mail address information and recovery cartridge information stored in the fifth owner information management database as the recycling discount information to the portal server of the equipment manufacturer, an owner information management database clearing step that clears the sent mail address information and the recovery cartridge information of the fifth owner information management database from the owner information management database after sending processing is performed through the recycling discount information sending step, and an owner information management database utility step that displays, prints, and deletes the contents of the owner information management database according to the instruction of the server administrator. The owner information management database registration step comprises a recovery cartridge information initialization step that sets recovery cartridge information to 1 and registers it in the fifth owner information management database together with mail address information when the mail address information of the owner information read through the cartridge owner information reading step is not registered in the fifth owner information management database and a recovery cartridge information updating step that increments (counts up) and updates the recovery cartridge information of the database when the mail address information is registered in the fifth owner information management database. The second information processing step of the portal server comprises a recycling discount information receiving step that receives mail address information and recovery cartridge information sent through the recycling discount information sending step and a mail address database updating step that adds the received recovery cartridge information to the recovery cartridge information that corresponds to the mail information of the second mail address database which matches the received mail address information and updates it.

Therefore, according to the present invention, a setting input item of the user in a consumable goods purchase request can be reduced and an operation advantage can be offered to the user by providing the function of setting owner information in communication information equipment and centralizing all processing flows in online shopping based on the set owner information.

Further, a function that is offered to the user can be provided by accumulating individual prices of the consumable goods at the side of the mail order center that are periodically sent from a plurality of mail order centers connected to the portal server of the equipment manufacturer, rearranging them in the price order and a choice advantage on merchandise selection can be offered to the user so that an economical mail order center can easily be selected.

Further, a remaining quantity detection automatic notification mode setting function and an order start request notification function are provided in communication information equipment. The degree of freedom regarding notification operation that the remaining quantity detection automatic notification mode setting function is used to detect a remaining quantity when the automatic notification mode is ON and to display a remaining quantity alarm and then issue an order start request notification when the remaining quantity is below a fixed amount, and not to issue the order start request notification even if the remaining quantity is below the fixed value when the automatic notification mode is OFF can be offered. The degree of freedom of the notification operation in which the order start request notification function is used to perform the order start request notification issue processing at any time, and an operation advantage can be offered to the user.

Further, the portal server of the equipment manufacturer receives the order start request notification, creates an order table of consumable goods based on the individual prices of the accumulated consumable goods, and it can be offered to communication information equipment.

At this time, an order table for online shopping in which a discount of merchandise is explicitly displayed at the creation of the order table, and the input of authentication information is enabled so that a regional store, such as a convenience store can be specified and an electronic settlement will be enabled for a delivery method of the merchandise can be created.

Further, for the user who does not use online shopping, such specification area that can perform a ticket issuing instruction of only the discount coupon ticket can also be provided. Consequently, in the communication information equipment to which the presentation of an order table is given, an order issue of consumable goods is enabled merely by inputting data only to the necessary item of the presented order table and an operation advantage in the extremely-high-degree-of-freedom, clear, and simplified order issue operation of the consumable goods can be offered to the user.

Further, in the portal server of the equipment manufacturer, for the user who desires the ticket issuing of only a coupon ticket, a system can be constructed so that discount coupon ticket data will be sent to the user's communication information equipment and the coupon ticket issuing processing can be performed by the communication information equipment, and a price advantage can be provided even to the user who does not use a mail order.

Further, an attempt is given to be able to issue a coupon ticket even in the communication information equipment. If the discount according to this attempt is more advantageous than the discount by a mail order, the price advantage can be provided even to the user who does not connect his or her network and the user who seldom requests the issue of the coupon ticket by giving priority to this attempt.

Further, a mail order center registration function and a mail order center specification function are provided in the communication information equipment. A specific mail order center can always preferentially be selected and a choice advantage over the selection of a merchandise purchaser can be offered to the user by enabling storage and registration of a plurality of mail order centers selected using the registration function and enabling specification of the specific mail order center from the plurality of mail order centers stored and registered using the specification function.

Further, the portal server of the equipment manufacturer can construct a system so that the order issued from the side of the communication information equipment will be given to the specified specific mail order center and a profit advantage due to the brokerage for the mail order center can be offered to the equipment manufacturer.

Further such system that enables a discount of the brokerage in accordance with the handling amount for each mail order center can be offered by providing a function that counts and accumulates the order amount for the mail order center at the side of the portal server of the equipment manufacturer, and a profit advantage due to the discount can be offered to the mail order center.

Further, the portal server of the equipment manufacturer can automate part of accounting processing by calculating the settlement information of the transaction generated between it and the mail order center on a monthly settling day and providing a function of reporting it to each mail center, and a profit advantage due to a reduction of personnel expenses can be offered to the equipment manufacturer Further, the mail order center server can automate part of conveyance processing by providing a function that receives an order from the portal server and performs a merchandise conveyance procedure by the conveyance method specified in an order table, a function that creates an address label of a conveyance destination based on the owner information written to the order table, and a function that performs merchandise inventory control at the delivery of the merchandise, and can offer a profit advantage due to a reduction of personnel expenses to the mail order center.

Further, the mail order center server can order stored merchandise from the consumable goods merchandise control center via the porter server of the equipment manufacturer when the stored merchandise is exhausted, and can offer an operation advantage in the stored merchandise order issue operation to the mail order center.

Further, the mail order center server can automate part of accounting processing by providing a function that calculates the settlement information of the transaction and the selling information of merchandise generated between it and the equipment manufacturer on a monthly settling day, and can offer a profit advantage due to a reduction of personnel expenses to the mail order center.

Further, when a system including the efficient recycling of consumable goods is constructed, the recovery path of the consumable goods is established, and the recycling processing of the cartridge recovered in a recycling plant is performed, such system that can purchase the consumable goods due to recycling discount against an order from a specific owner user can be offered by providing a function that records the owner information of the equipment in the cartridge of the consumable goods, in the communication information equipment, acquiring the owner information recorded in the recovered cartridge, in the recycling plant, sending the acquired information and the number of recovery cartridges to the portal server of the equipment manufacturer as recovery cartridge information via the recycling server plant, and specifying the owner user of the recovery cartridge, in the portal server of the equipment. A price advantage can be offered to the owner user of the recovery cartridge and an environmental advantage can be offered to the earth.

Further, the communication information equipment can obtain the quite same effect obtained even if the configuration of the equipment in which the electronic equipment having a communication function via the network and the electronic equipment that consumes the consumable goods are connected is replaced by, for example, the equipment configuration in which the information of a printer, such as the printer connected to a computer including the configuration can be handled via the computer in which consumable goods are consumed in the communication information equipment.

The further desirable embodiment of the embodiment described above using a function block is illustratively described in detail below with reference to the drawings. However, the dimensions, materials, shapes, and their relative arrangements of components written to this embodiment will not limit the scope of this invention to only them, unless otherwise specified. Further, a storage medium, such as a write-enable nonvolatile memory or a hard disk is applied to each storage area described in each embodiment, and necessary information is written or read as occasions demand.

Further, in the following drawing, the same number is assigned to the same member as the member described in the previously-stated drawing. Further, the description of each embodiment of the consumable goods online shopping system according to the present invention described below also serves as the description of each embodiment of a recording medium which records the communication information equipment, portal server, electronic settlement server, mail order center server, recycling plant server, merchandise control center server, consumable goods online shopping method, and consumable online shopping program according to the present invention.

(Embodiment 1) First, the embodiment 1 of the consumable goods online shopping system according to the present invention is described with reference to the drawings. This embodiment 1 is constructed by combining embodiment 2 to embodiment 15 described later.

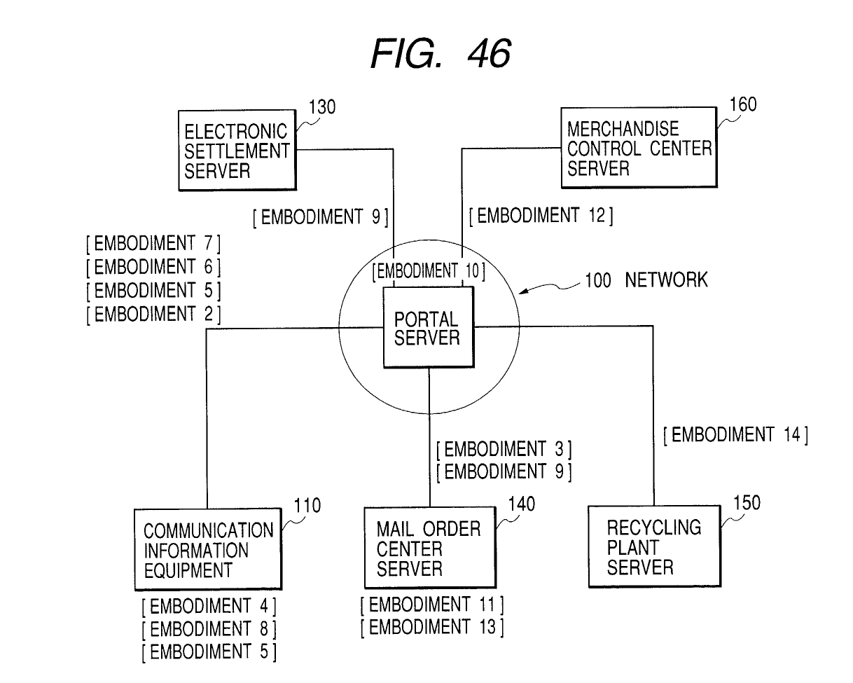

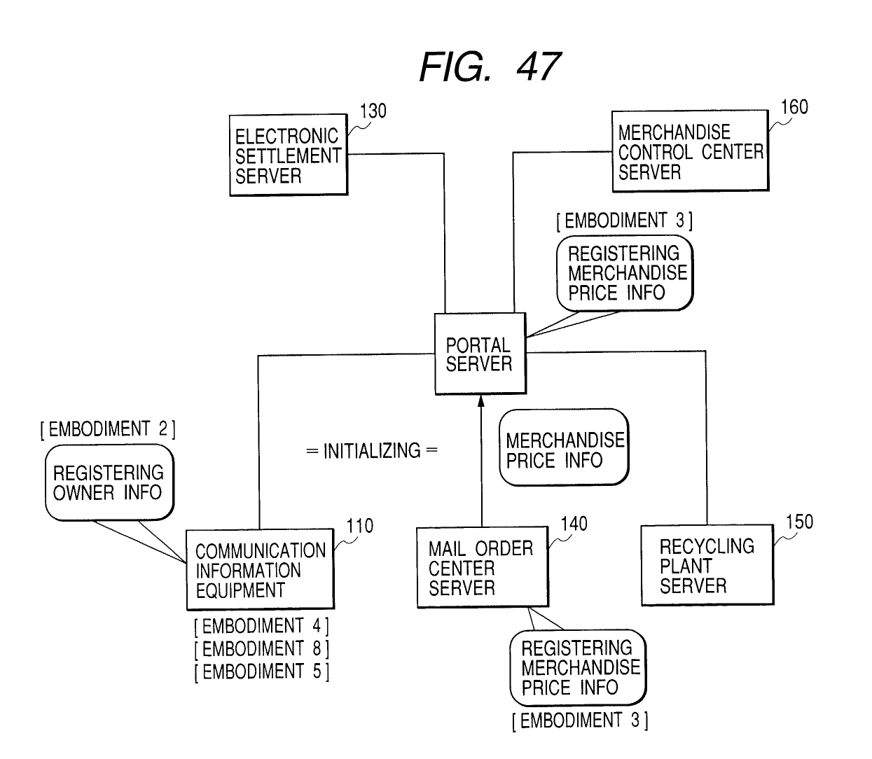

This embodiment 1, as shown in FIG. 46, is executed according to the system configuration in which the communication information equipment 110, the portal server 120 of the equipment manufacturer, the electronic settlement server 130 of a financial company, the server 140 of a mail order center, the server 150 of a recycling plant, and the server 160 of a merchandise control center are connected via the network 100, and realizes a consumable goods online shopping system that produce many advantages by sending and receiving (transferring) information via the network 100. FIG. 46 is a schematic block diagram of embodiment 1 of the consumable goods online shopping system according to the present invention.

At the execution of the system, in the equipment connected via the network, each of the following processing is executed and the online shopping system proposed by the present invention is realized.

Initialization Processing (FIG. 47)

As shown in FIG. 47, as initialization processing, the registration processing of the merchandise price information of the consumable goods which become the object of online shopping is previously executed between the portal server 120 and the mail order center server 140 according to the procedure shown in embodiment 3, and in the communication information equipment 110, processing that registers the owner information of an equipment owner is executed according to the procedure shown in embodiment 2. FIG. 47 is an operation concept diagram of the initialization processing of the system shown in FIG. 46.

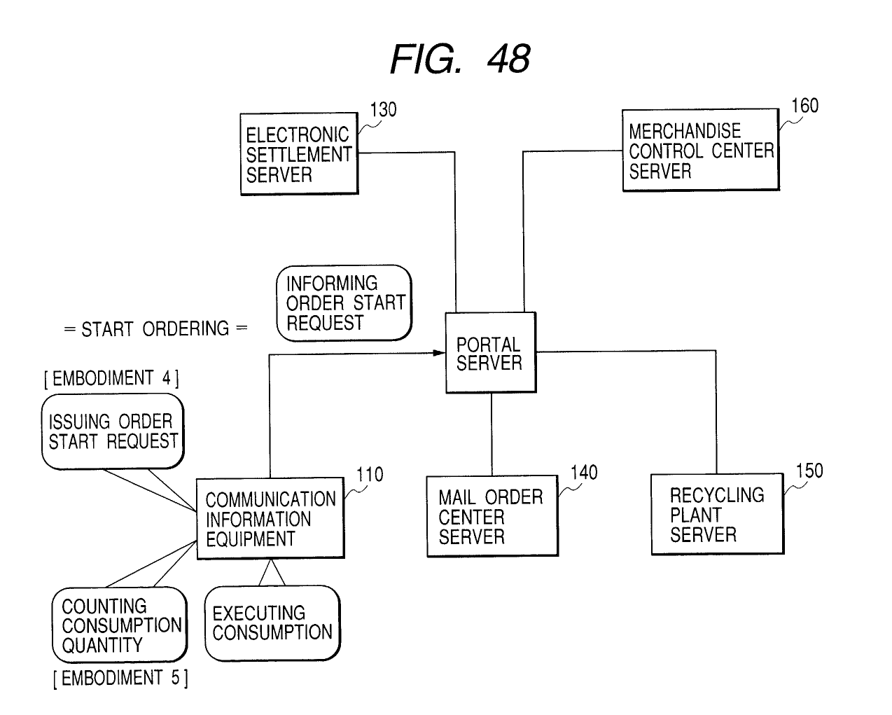

Order Start Processing (FIG. 48)

Further, as shown in FIG. 48, in the communication information equipment 110, processing that consumes consumable goods is executed. With the execution of the consumption execution processing, counting processing regarding the consumption amount of the consumable goods is executed according to the procedure shown in embodiment 5 and issue processing of an order start request notification to the portal server 120 is executed according to the procedure shown in embodiment 4. FIG. 48 is an operation concept diagram of the order start processing of the system shown in FIG. 46.

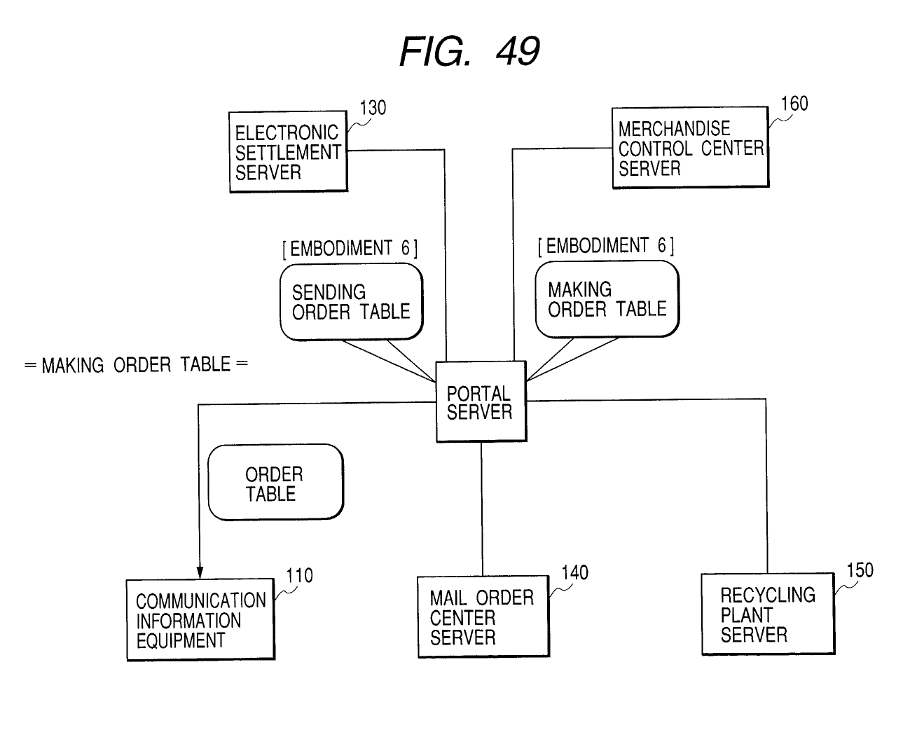

Order table Creation Processing (FIG. 49)

Further, as shown in FIG. 49, in the portal server 120, the issued order start request notification is received, an order table is created according to the procedure shown in embodiment 6, and processing that sends the created order table to the equipment information equipment 110 is executed. FIG. 49 is an operation concept diagram of the order issue processing of the system shown in FIG. 46.

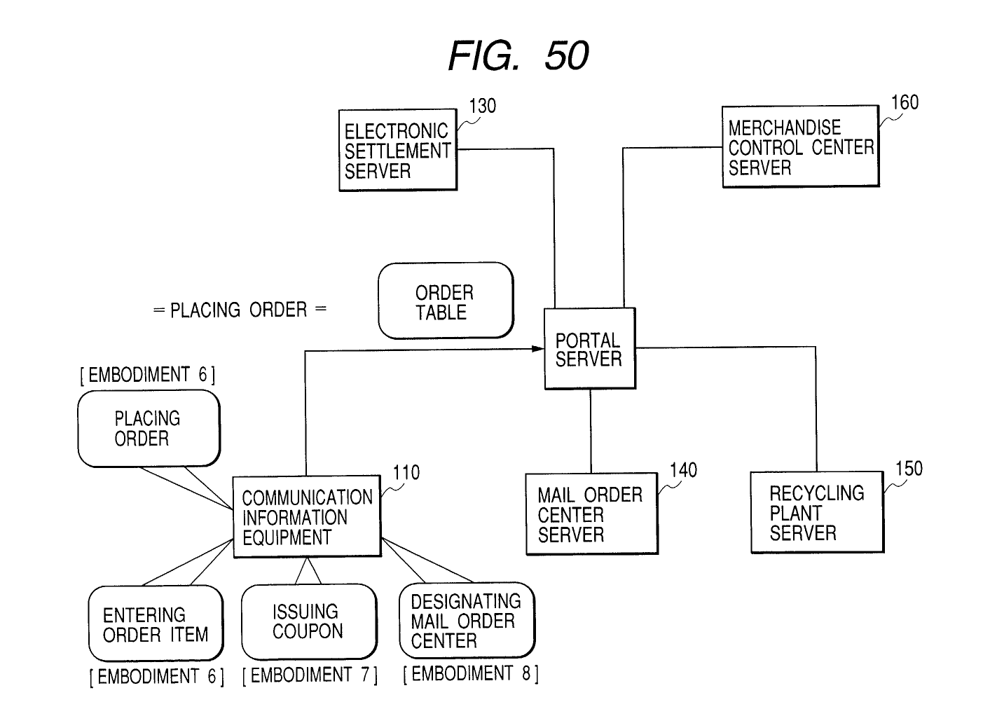

Order Issue Processing (FIG. 50)

Further, as shown in FIG. 50, in the communication information equipment 110, the created order table is received, input processing of an order item is executed according to the procedure shown in embodiment 6, and order issue processing to the portal server 120 is executed. FIG. 50 is an operation concept diagram of the order issue processing of the system shown in FIG. 46.

Further, in the communication information equipment 110, when a coupon ticket issuing instruction is given, coupon ticket issuing processing is executed according to the procedure shown in embodiment 7.

Further, in the communication information equipment 110, when a specific mail order center of a supplier is specified, specification processing that specifies the specific mail order center is executed according to the procedure shown in embodiment 8.

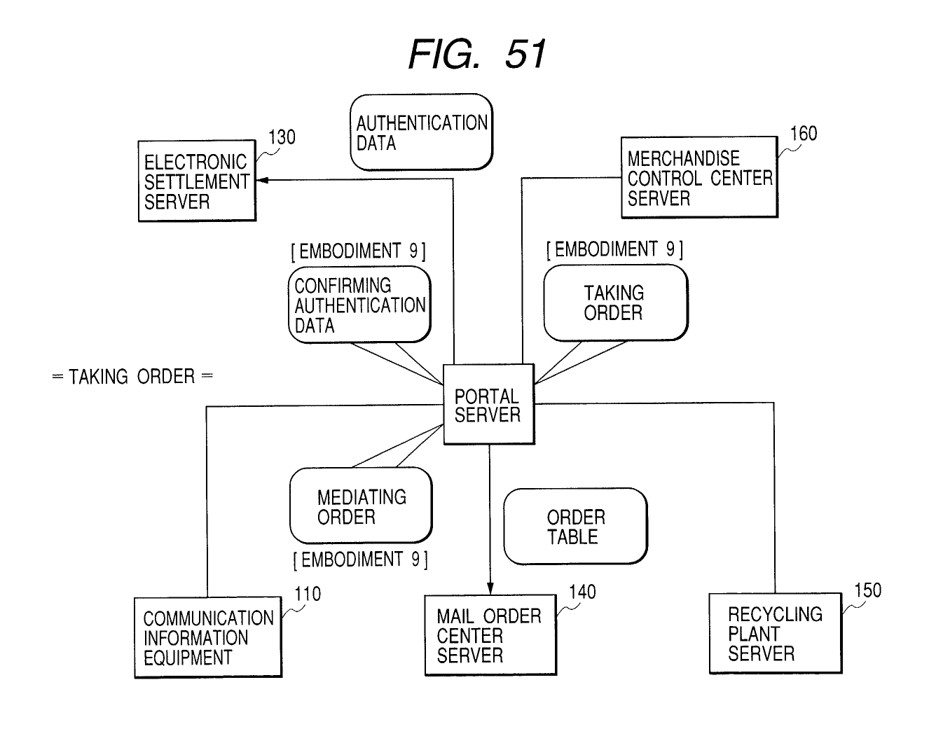

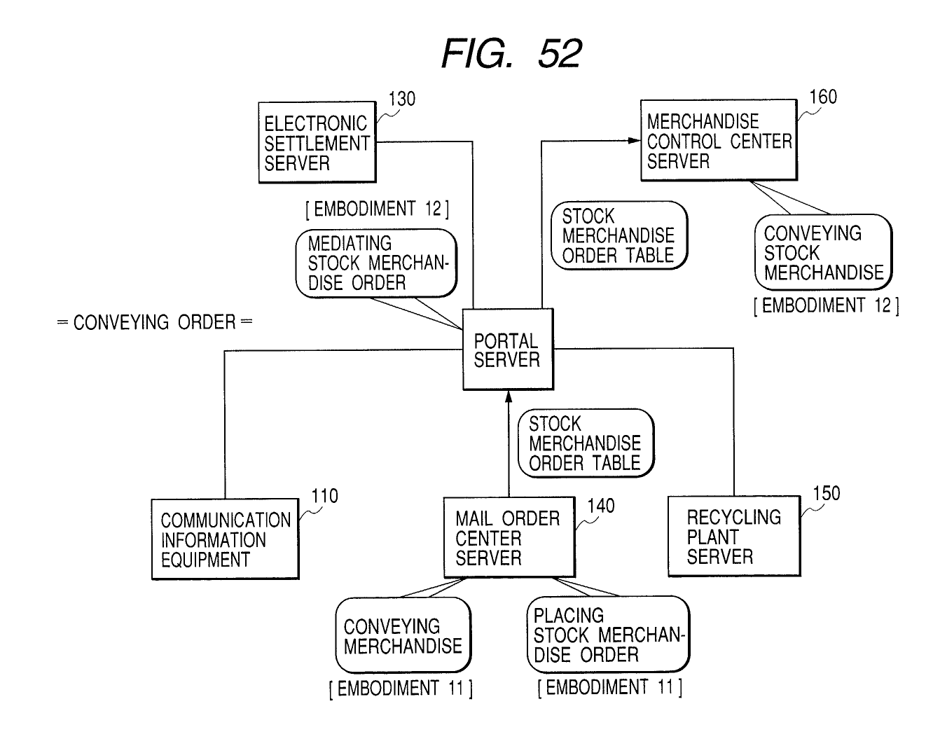

Order Received Processing (FIG. 51)

Further, as shown in FIG. 51, when an order issue of the order of the consumable goods is given through the order issue processing, in the portal server 120, according to embodiment 9, the received order processing of the order of which the order issue is given is executed and check processing of authentication data for the electronic settlement server 130 of a financial company and mediation processing of an order from the specified mail order center server 140 are executed. FIG. 51 is an operation concept diagram of the received order processing of the system shown in FIG. 46.

Order Conveyance Processing (FIG. 52)

Further, as shown in FIG. 52, in the mail order center server 140, an order of which the order issue is given by the mediation of the portal server 120 is received and merchandise conveyance processing is executed according to the procedure shown in embodiment 11. FIG. 52 is an operation concept diagram of the order delivery processing of the system shown in FIG. 46.

Besides, in the conveyance processing, when merchandise stock is exhausted, the mail order center server 140 executes the order issue processing of stored merchandise to the portal server 120. In the portal server 120, an order of the stored merchandise by the received order processing of the stored merchandise is received and mediation processing that places the order of the stored merchandise with the merchandise control center server 160 according to the procedure shown in embodiment 12. In the merchandise center server 160, the order of the stored merchandise is received and processing that delivers the stored merchandise to the mail order center is executed.

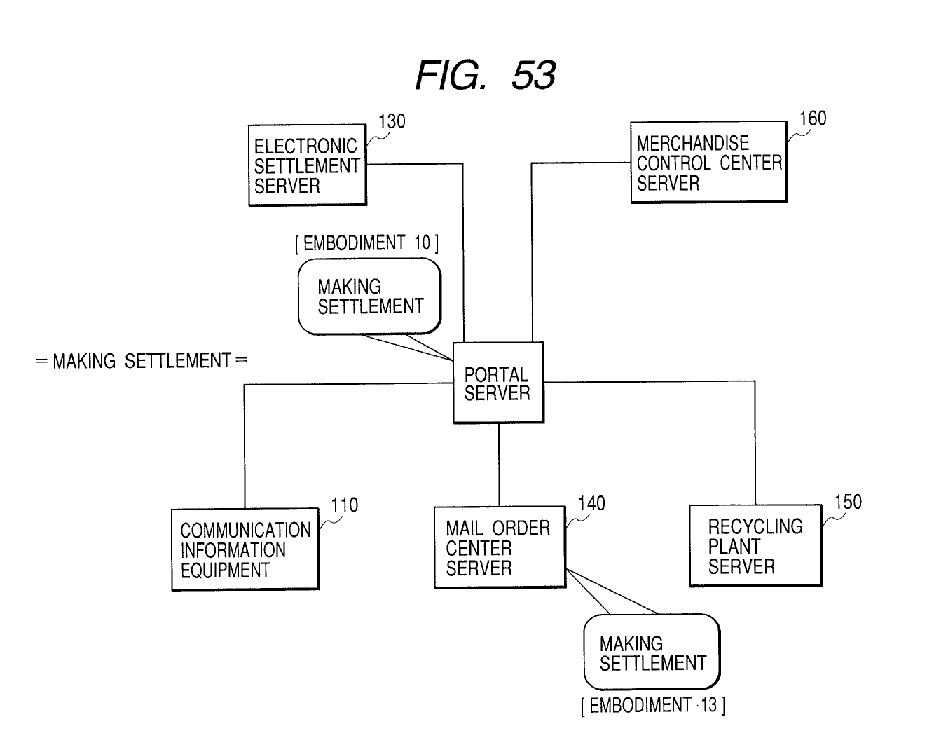

Settlement Processing (FIG. 53)

Further, as shown in FIG. 53, the portal server 120 executes settlement processing for each mail order center to a handled order according to the procedure shown in embodiment 10 and the mail order center server 140 executes the settlement processing to the handled order according to the procedure shown in embodiment 13. FIG. 53 is an operation concept diagram of the settlement processing of the system shown in FIG. 46.

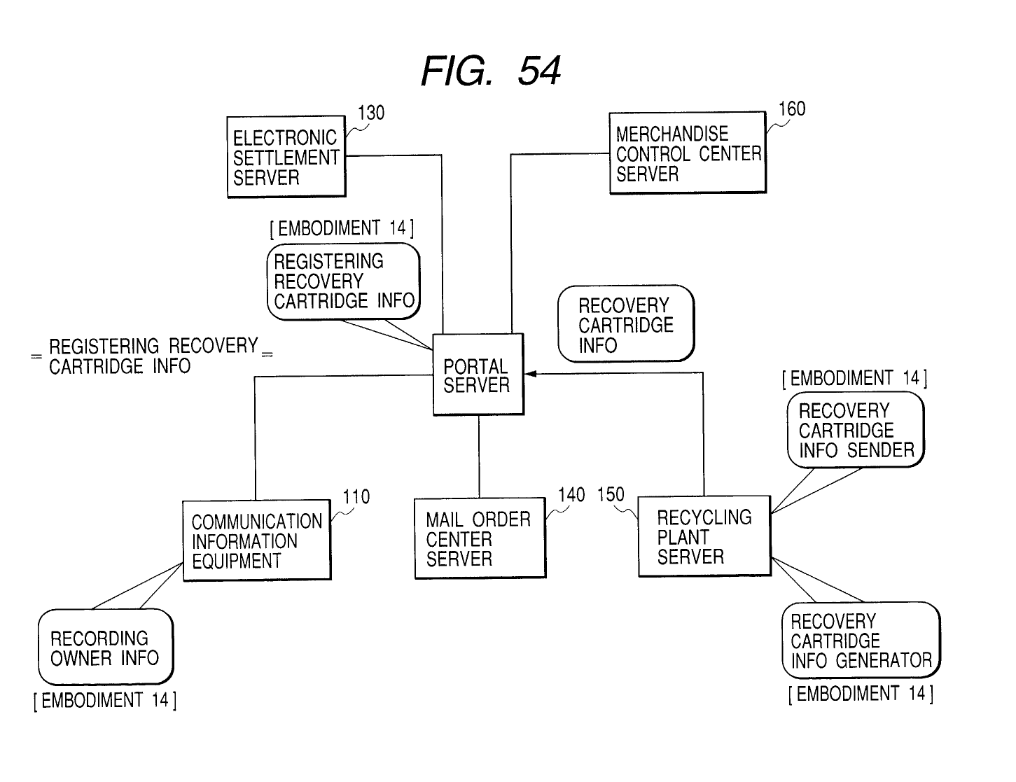

Recovery Cartridge Information Registration Processing (FIG. 54)

Further, as shown in FIG. 54, in the communication information equipment 110, according to the procedure shown in embodiment 14, processing that records owner information in the storage area of a consumable goods cartridge is executed. In the recycling plant server 150, according to the procedure shown in embodiment 14, recovery cartridge information is generated based on the owner information of the recovered cartridge and processing that sends the recovery cartridge information to the portal server is executed. In the portal server 120, the sent recovery cartridge information is received and processing that registers the recovery cartridge information in the database is executed. FIG. 54 is an operation concept diagram of the recovery cartridge information registration processing of the system shown in FIG. 46.

Beside, the registered recovery cartridge information is referred to in the order table creation processing shown in embodiment 6 and processing is executed so that an advantage can be returned to the user as a recycling discount.

According to the processing flow described above, in this embodiment, many advantages described in embodiment 2 and later can be offered to the user.

(Embodiment 2)

The operation of embodiment 2 of the consumable goods online shopping system according to the present invention that is also used in the above embodiment 1 is described here.

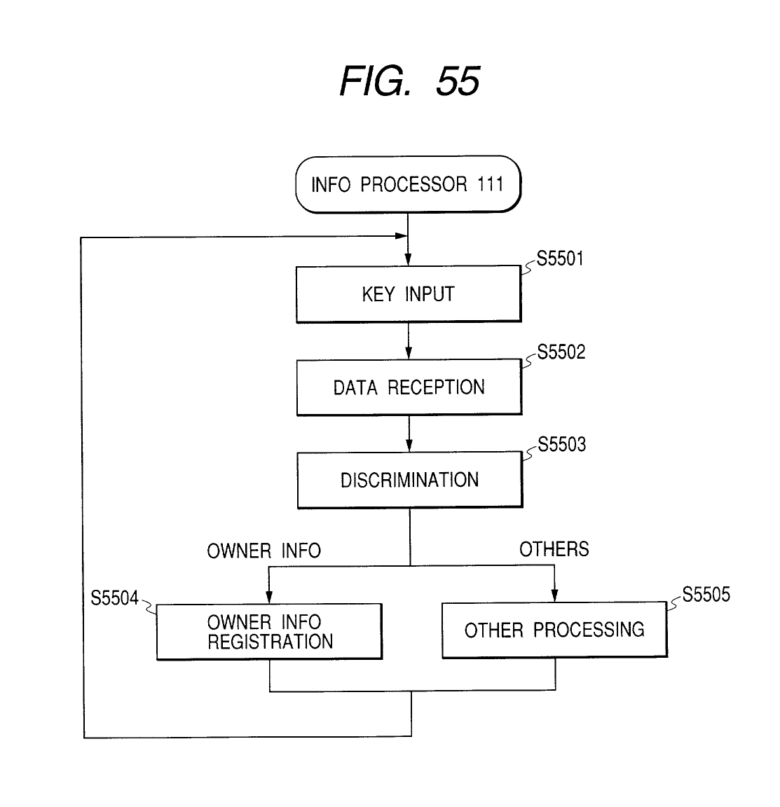

In this embodiment 1, regarding the registration of the owner information in the initialization processing of the above embodiment 1, as shown in FIG. 55, in the information processing means 111 of the communication information equipment 110, when the execution instruction of the owner information registration processing of the communication information equipment is given after key input, data receiving, and discrimination processing instructions (steps S5501, 5502, and 5503) of the user, the registration processing of the owner information is executed (step S5504) and an another necessary processing is performed for another instruction (step S5505). FIG. 55 is an operation flowchart of embodiment 2 of the consumable goods online shopping system according to the present invention.

With the execution of the processing, the information of a mail address, a postal number, an address, a name, and a telephone number is stored in the storage area of the equipment as the owner information.

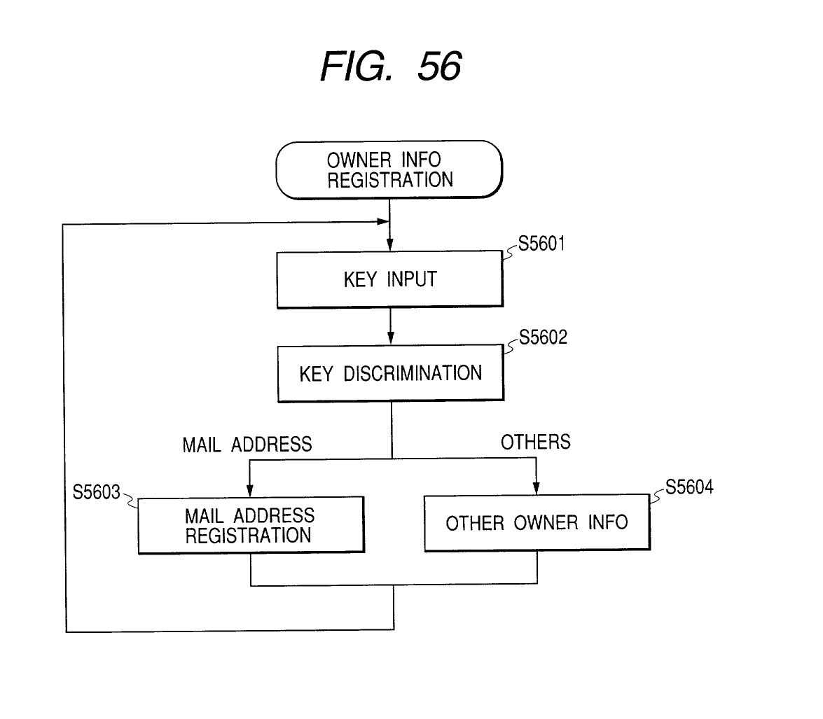

Further, regarding the owner information registration processing, as shown in FIG. 56, after key input and key discrimination processing (steps S5601 and 5602), mail address registration processing and another owner information registration processing are allocated (steps S5603 and 5604). FIG. 56 is an operation flowchart of embodiment 2 of the consumable goods online shopping system according to the present invention.

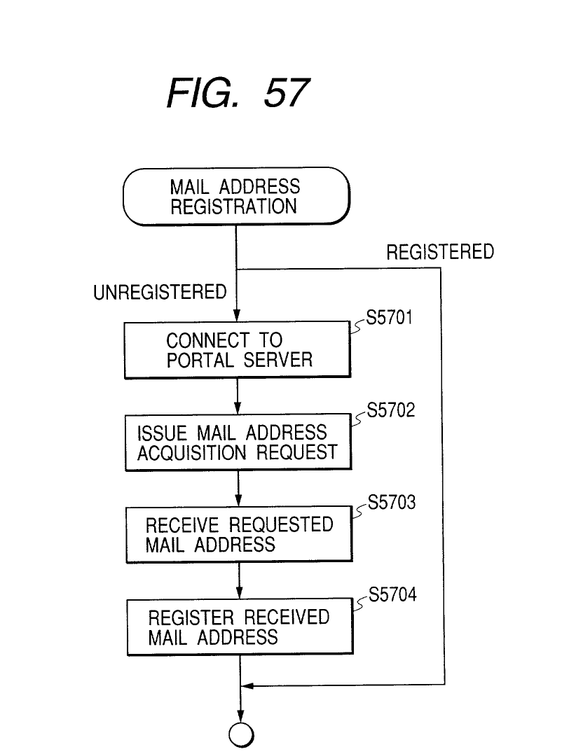

When a mail address input instruction is given according to the user input instruction, the mail address automatic registration processing is executed by the mail address registration processing. In the mail address automatic registration processing, as shown in FIG. 57, when the mail address is not in the unregistered state, automatic connection to the portal server of the equipment manufacturer is performed (step S5701), a mail address acquisition request is issued to the portal server (step S5702), the mail address allocated and sent by the portal server is received (step S5703), and processing that automatically registers it in the mail address of the owner information is executed (step S5704). FIG. 57 is an operation flowchart of embodiment 2 of the consumable goods online shopping system according to the present invention.

When an input instruction is given to another owner information, the information necessary for the specified owner information is input by the key input processing.

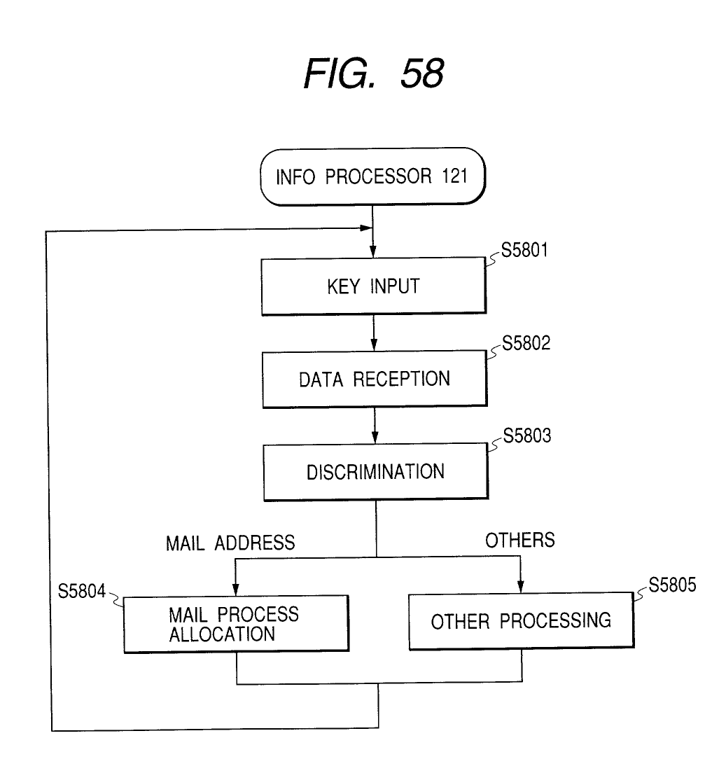

On the other hand, in the information processing means 121 of the portal server 120, as shown in FIG. 58, when the mail address acquisition request issued by the mail address automatic registration processing of the communication information equipment is received after key input, data receiving, and discrimination processing instructions (steps S5801, 5802, and 5803), mail address allocation processing or client and another necessary processing is performed (step S5804 or 5805). FIG. 58 is an operation flowchart of embodiment 2 of the consumable goods online shopping system according to the present invention.

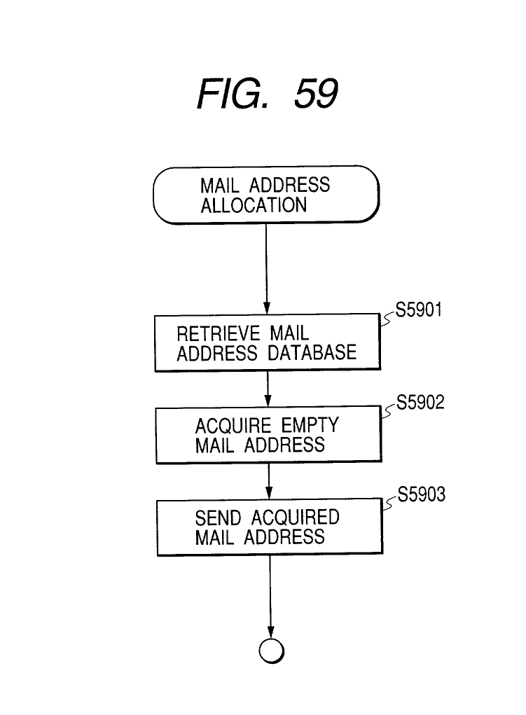

In the mail address allocation processing, as shown in FIG. 59, the mail address database 126 is retrieved (step S5901), an unregistered empty mail address is acquired (step S5902), the acquired mail address is allocated to the mail address of the communication information equipment to which a request is given, and processing that reports it to the communication information equipment is executed (step S5903). FIG. 59 is an operation flowchart of embodiment 2 of the consumable goods online shopping system according to the present invention.

Besides, for the mail address allocation processing, a description of the embodiment is given assuming the portal server 120 performs automatic mail address allocation that automatically allocates the empty mail address by receiving a mail address acquisition request. This can also be executed according to the instruction of the portal server administrator.

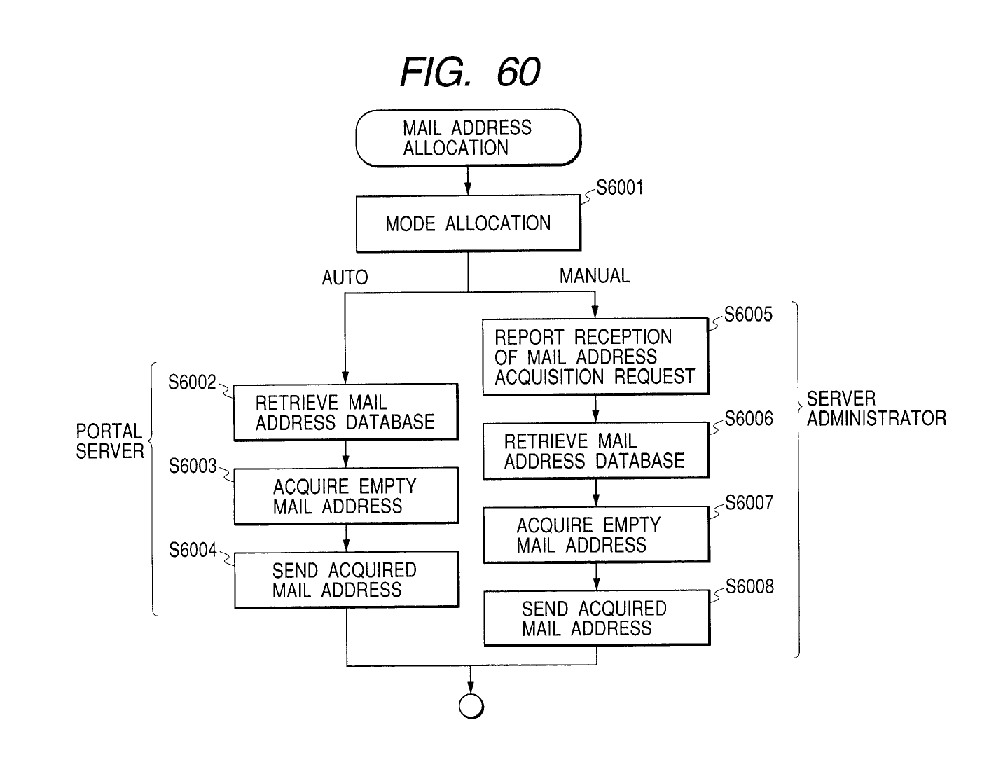

For example, as shown in FIG. 60, if the switching mode of a mode is provided and the manual mode is specified by mode allocation (step S6001), when a mail address acquisition request is received, this is reported to the portal server administrator (step S6005), a database is retrieved according to the instruction of the portal server administrator (step S6006), a mail address is allocated according to the instruction of the portal server administrator (step S6007), and the mail address is reported to the communication information equipment (step S6008) according to the portal server administrator. If a system is constructed in this manner, the mail address allocation processing can be executed. FIG. 60 is an operation flowchart of embodiment 2 of the consumable goods online shopping system according to the present invention.

Besides, the portal server automatic execution (the operation from step S6002 to step S6004) is the same operation shown in FIG. 59 described previously.

According to the processing flow described above, in this embodiment, the communication information equipment can set owner information. If all processing flows in online shopping are unified based on the set owner information, a setting input item of the user in a consumable goods purchase request can be reduced, and an operation advantage can be offered to the user.

(Embodiment 3)

The embodiment 3 of the consumable goods online shopping system according to the present invention is described below with reference to the drawings.

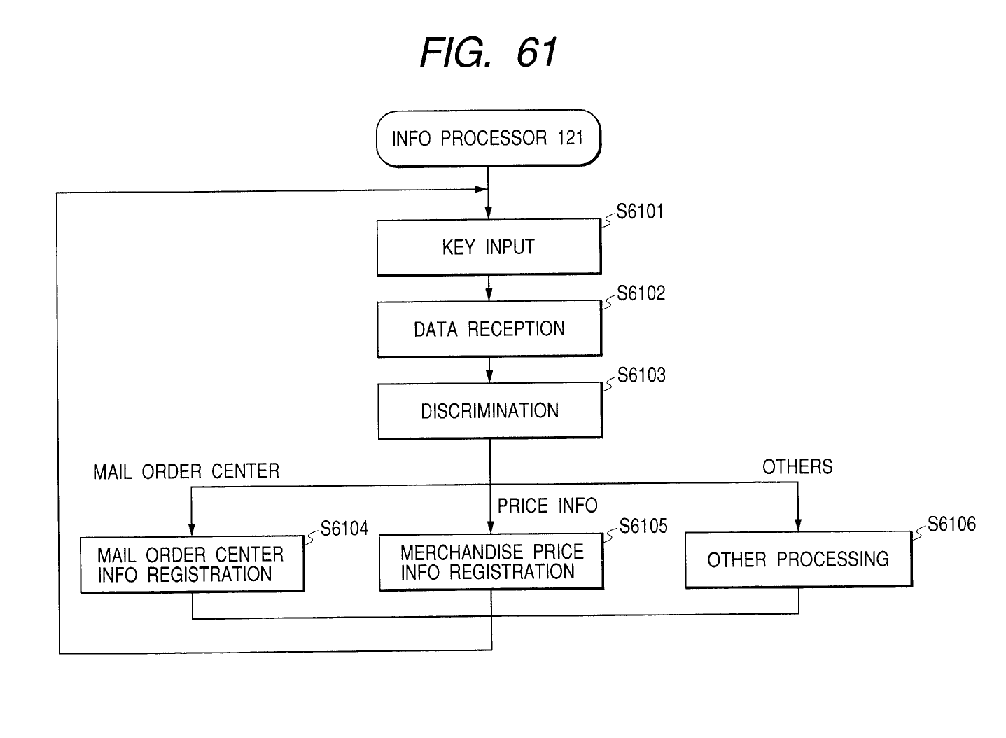

In this embodiment 3, regarding the registration processing of the merchandise price information of the consumable goods in the initialization processing of embodiment 1, in the information processing means 121 of the portal server of the equipment manufacturer, as shown in FIG. 61, when the registration instruction of the mail order center information is given according to the input instruction of the server administrator after key input, data receiving, and discrimination processing instructions (steps S6101, 6102, and 6103) of the user, mail order center information registration processing (step S6104) that registers the information necessary for the processing of the mail order center which handles the online shopping of the consumable goods, merchandise price information processing (step S6105) that stores the received price information in the consumable goods price database when the price information from the mail order center registered by the registration processing is sent, and another necessary processing (step S6106) are performed. FIG. 61 is an operation flowchart of embodiment 3 of the consumable goods online shopping system according to the present invention.

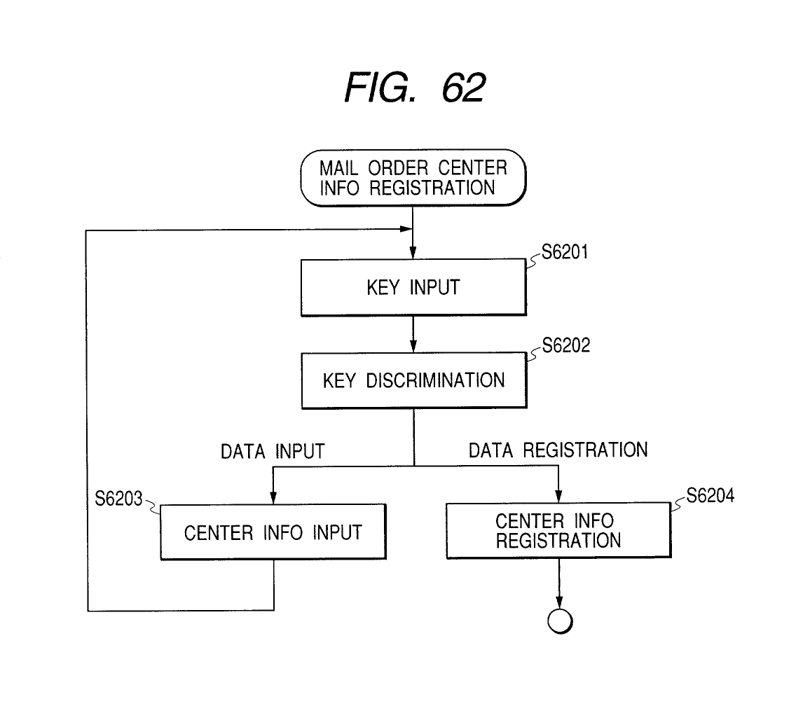

In the mail order center information registration processing, as shown in FIG. 62, when the input of necessary information is performed by the input of the server administrator after key input processing and key discrimination processing (steps S6201 and 6202), data input is performed by the center information input processing (step S6203), and processing that registers the input center information in the mail address database 126 is performed (step S6204) when an information registration instruction is given. FIG. 62 is an operation flowchart of embodiment 3 of the consumable goods online shopping system according to the present invention.

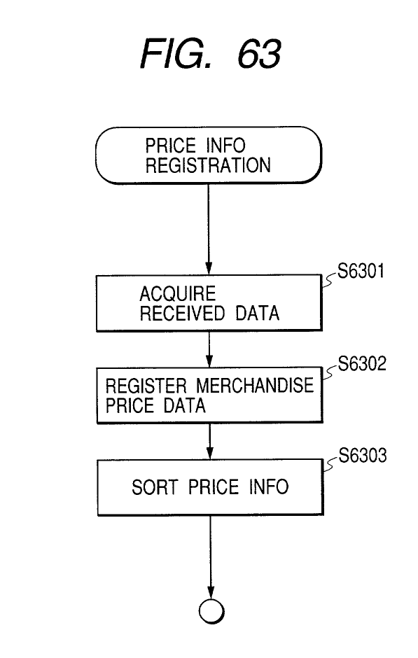

In the merchandise price information registration processing, as shown in FIG. 63, the received price information is acquired by the receiving data acquisition processing (step S6301), processing that registers the price information acquired in the consumable goods database 129 is performed by the merchandise price data registration processing (step S6302), and processing that rearranges the price information on the registered database for each merchandise type in the price order. FIG. 63 is an operation flowchart of embodiment 3 of the consumable goods online shopping system according to the present invention.

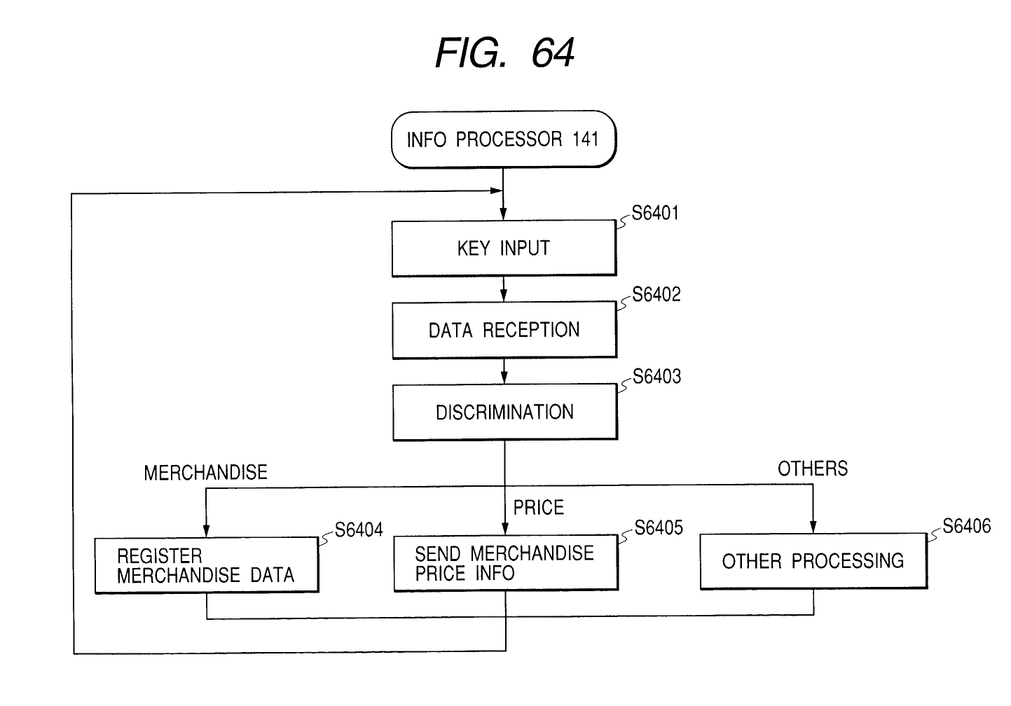

On the other hand, in the information processing means 141 of the consumable goods mail order center server, as shown in FIG. 64, merchandise data registration processing (step S6404) that stores the merchandise data necessary for receiving the mail order including the price and the stock quantity input by the server administrator after key input, data receiving, and discrimination processing instructions (steps S6401, 6402, and 6403) of the user, merchandise price information sending processing (step S6405) that sends the merchandise data in the merchandise database 146 in the portal server of the equipment manufacturer as the price information according to the price information sending instruction of the server administrator, and another necessary processing (step S6406) are performed. FIG. 64 is an operation flowchart of embodiment 3 of the consumable goods online shopping system according to the present invention.

According to processing flow described above, in this embodiment, a function of storing an individual price of the consumable goods at the side of the mail order center that is periodically sent from a plurality of mail order centers connected to the portal server of the equipment manufacturer, rearranging it in the price order, and presenting it to the user can be provided, and a choice advantage over merchandise selection can be offered to the user so that a low-cost mail order center can easily be selected.

(Embodiment 4)

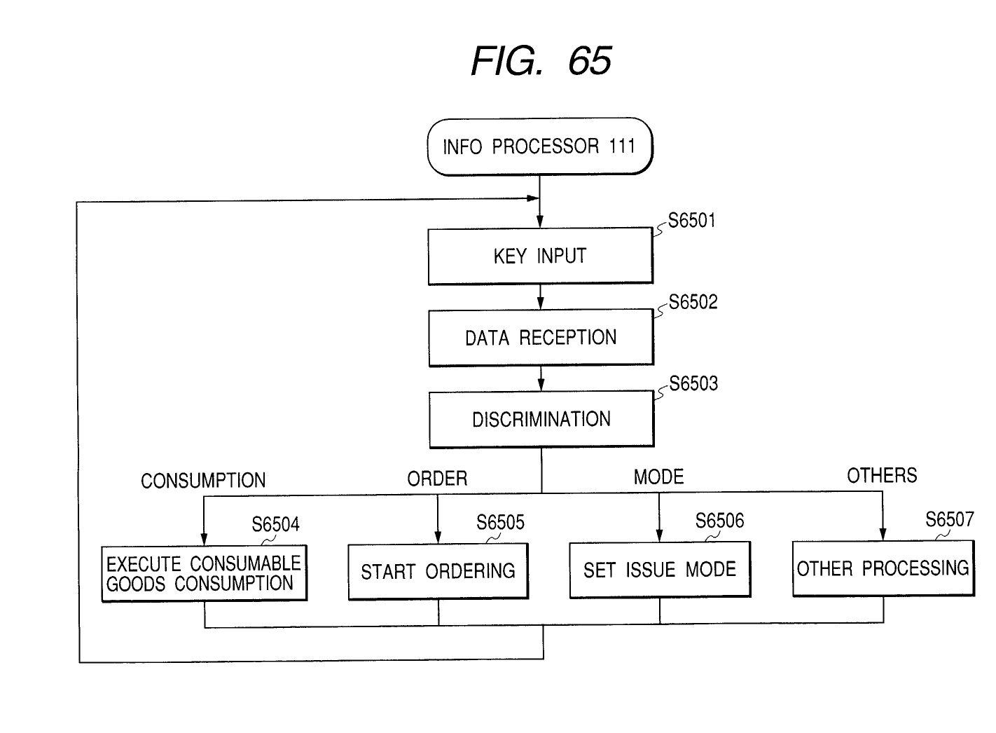

The embodiment 4 of the consumable goods online shopping system according to the present invention is described below with reference to the drawings. In this embodiment 4, regarding the issue processing of the order start request notification in the order start processing of embodiment 1, as shown in FIG. 65, after key input, data receiving, and discrimination processing instructions (steps S6501, 6502, and 6503) of the user, in the information processing means 11 of the communication information equipment, a consumable goods consumption execution instruction is given and consumable goods consumption processing is executed by the consumption goods consumption execution processing (step S6504). There are two cases in which the order start request notification is issued when the remaining quantity of the consumable goods goes below a fixed value and the order start processing is executed by the input of the user order start instruction (step S6505) and the order start request notification is issued according to the issue mode specification (step S6506), and there is another necessary processing (step S6507). FIG. 65 is an operation flowchart of embodiment 4 of the consumable goods online shopping system according to the present invention.

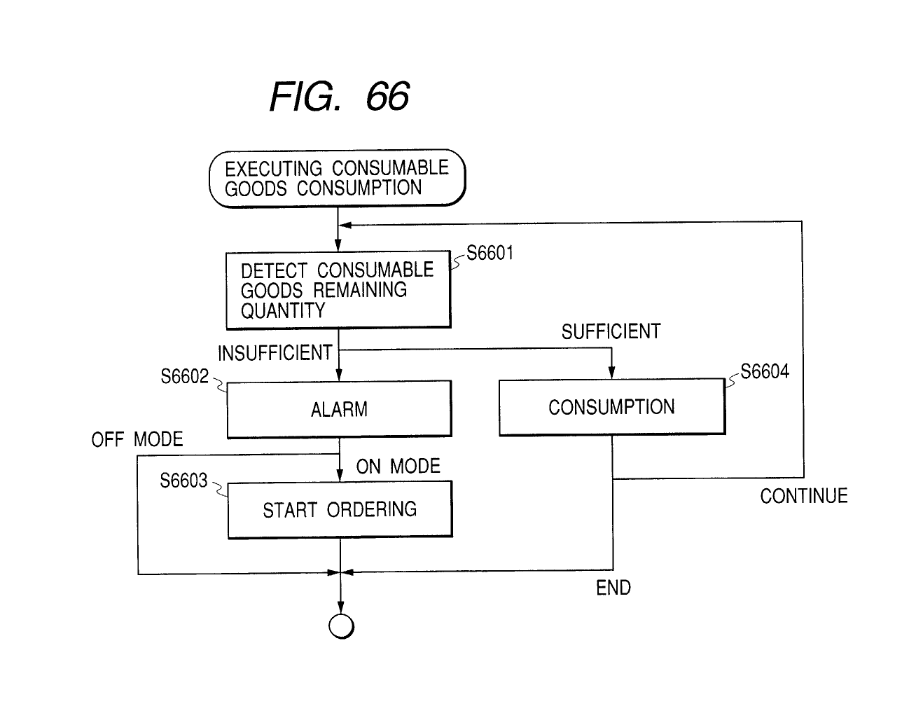

In the consumable goods consumption execution processing, as shown in FIG. 66, remaining quantity of consumable goods is detected by consumable goods remaining quantity detection processing (step S6601), and when the remaining quantity goes below a fixed value, the remaining quantity state is reported to the user by remaining quantity alarm processing (step S6602) and the order start processing (step S6603) is performed. Further, the information about the remaining quantity of the consumable goods obtained through the remaining quantity detection processing of the consumable goods in the consumable goods consumption execution processing is the information based on the consumption amount that is incremented (counted up) by the consumption amount counting means 511 described above and is stored and accumulated in the predetermined storage area of the nonvolatile storage means provided in a device. In this case, as the nonvolatile storage means, for example, the equipment storage area 212 shown in FIG. 8 corresponds to this.

Further, when a printing portion and an information processing portion are separated in the communication information equipment as one form, that is, the printing portion and the information processing portion have such form that they are connected via a predetermined communication table, such form that stores the information (consumable goods remaining quantity information) about the consumption amount of the consumable goods calculated by the consumption amount counting means of the printing portion in the nonvolatile storage portion provided in the information processing portion is also assumed in the present invention. In such case, the sending of each information to the portal server is executed by the sending means provided in the information processing portion.

When the remaining quantity does not go below a fixed value, consumable goods consumption processing is executed through consumption execution processing (step S6604). When the consumption processing is terminated, either successive continuation or execution termination is checked. For the successive continuation, processing is repeated from the consumable goods remaining quantity detection processing, and for the execution end, the consumable goods consumption processing is terminated. On the other hand, when the remaining quantity state is reported to the user by the remaining quantity alarm processing, the automatic issue mode of the order start request notification is subsequently checked. In the ON mode, the order start request notification is issued by the order start processing, and in the OFF mode, the processing is terminated without performing the order start processing. FIG. 66 is an operation flowchart of embodiment 4 of the consumable goods online shopping system according to the present invention.

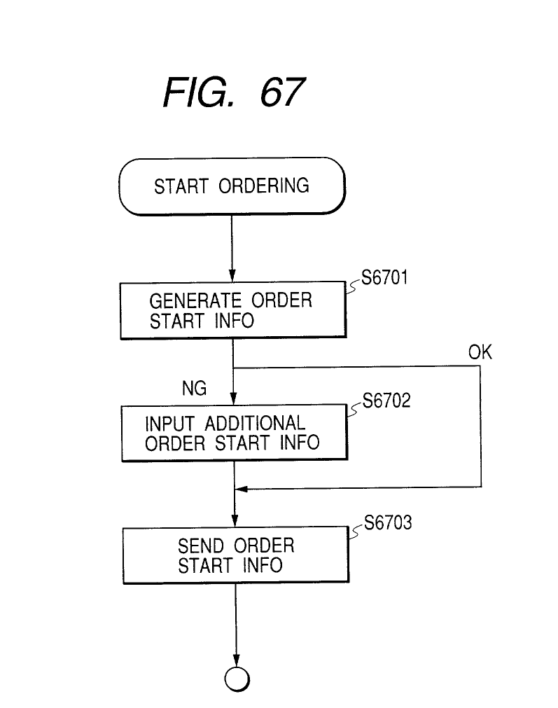

In the order start processing, as shown in FIG. 67, processing (step S6702) that generates the information necessary for creating an order table at the side of the portal server 120, such as the machine type information of the equipment that enables the discrimination of the consumption amount of the consumable goods accumulated in the storage area and the discrimination of the consumable goods, the owner information stored in the storage area of the equipment, the connection information to the mail order center that is preferentially specified in the storage area of the equipment, as the order start information by order start information generation processing (step S6701) and processing (step S6703) that sends the order start request notification and order start information to the portal server 120 is performed. FIG. 67 is an operation flowchart of embodiment 4 of the consumable goods online shopping system according to the present invention.

Besides, when necessary information is missing at the generation of order start information, missing information input processing is performed by order start information auxiliary input processing. Further, the information about the consumption amount of the consumable goods described above corresponds to consumption amount discount information. It is assumed in the present invention that the consumption amount discount information indicates a simple consumption amount. For example, it is also assumed that the information is the information about the consumption amount combined with the consumable goods (or communication information equipment itself) or the information about the consumption amount of the consumable goods at a predetermined period. By making consumption amount discount information correspond to such information, for example, such operation in the portal server that applies a high discount to the consumable goods which use recording agents (toner and ink) of a high unit price even for the same consumption amount is enabled, and such operation in the portal server that applies a higher discount to the consumption at a short period even for the same consumption amount is enabled.

Further, regarding the setting of the order start request automatic issue mode, in the information processing means 111, when an issue mode setting instruction is given, the ON/OFF mode switching can be set by issue mode setting processing.

According to the processing flow described above, in this embodiment, a remaining quantity detection automatic notification mode setting function and an order start request notification function are provided in communication information equipment. The degree of freedom concerning notification operation that the remaining quantity detection automatic notification mode setting function is used to detect remaining quantity when the automatic notification mode is ON and display a remaining quantity alarm and then issue an order start request notification when the remaining quantity is below a fixed amount, and not to issue the order start request notification even if the remaining quantity is below the fixed value when the automatic notification mode is OFF and the degree of freedom of the notification operation in which the order start request notification function is used to perform the order start request notification issue processing at any time can be offered, and an operation advantage can be offered to the user.

Further, in this embodiment, a description is given citing the communication information equipment in which a printing device is incorporated as an example. As described above, the form is also assumed in which the printing device is separated from the communication information equipment (device that separates the printing portion from the communication information equipment in the present invention) and the printing device is connected to the communication information equipment via a predetermined communication cable. This is specifically described below.

First, in the configuration of the communication equipment of this embodiment, generation processing that generates order start information and sending processing that sends the order start information generated by the generation processing to the communication information equipment are provided at the side of the printing device. Receiving processing that receives the order start information sent from the printing device, order start information auxiliary input processing for inputting missing necessary information, sending processing that sends the order start request notification and the order start information to the portal server, and receiving processing that receives the response information that corresponds to the order start information sent from the portal server are provided at the side of the communication information equipment.

Further, order start processing (step S6603) that is based on remaining quantity detection (step S6601) of the consumable goods is started as the processing at the side of the printing device. In the order start processing, processing that acquires necessary information and generates the order start information is performed by order start information generation processing (step S6701) and processing that send the generated order start information to the connected communication information equipment is executed. Further, as the processing at the side of the communication information equipment, the processing that receives the order start information sent from the side of the printing device is performed, the necessary information that is not covered with the received order start information is compensated by the order start information auxiliary input processing, and processing (step S6703) that sends the order start request notification and the order start information to the portal server is performed. Then a response to the sent order start information is received and the transfer for the side of the portal server generated subsequently is executed by sending and receiving necessary information as occasions demand.

By realizing the processing described above, the communication information equipment in which the printing device described in this embodiment is incorporated can execute the transfer in the same manner even in the form in which the communication information equipment is separated and the printing device is connected to the communication information equipment.

(Embodiment 5)

The embodiment 5 of the consumable goods online shopping system according to the present invention is described below with reference to the drawings.

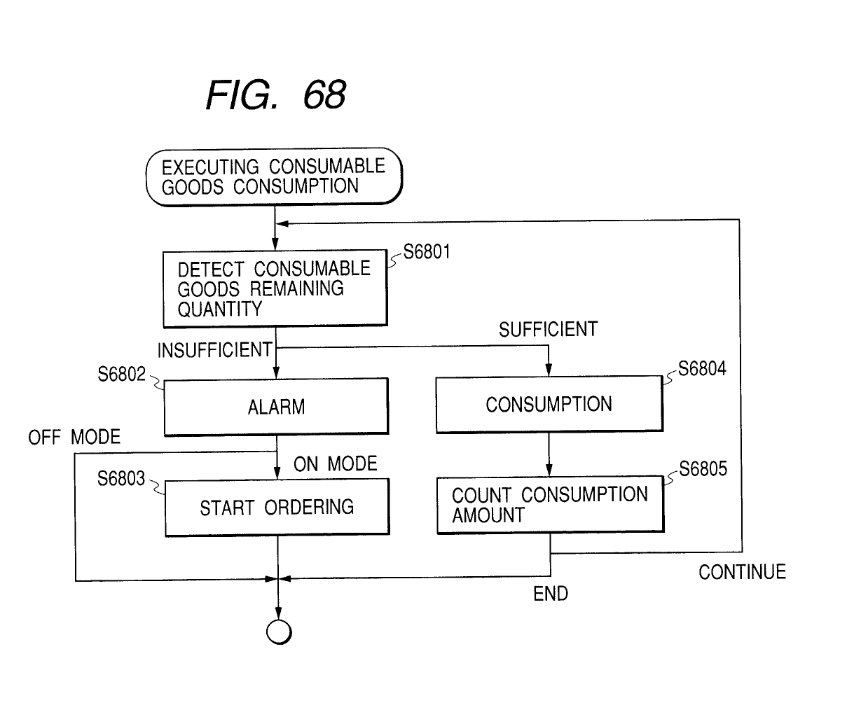

In this embodiment 5, regarding the counting processing on the consumption amount of the consumable goods in the order start processing of embodiment 1, as shown in FIG. 68, after the consumption execution processing in the consumption goods consumption execution processing of embodiment 4, the consumption amount is added and counted by consumption amount counting processing (step S6805) and the counted consumption amount is reflected in the order start information in the order start generation processing of the order start processing. A consumption discount can be calculated by providing the consumption discount calculation processing that calculates the discount amount that matches the consumption amount based on the consumption amount set in this order start information when an order table is created in embodiment 6. Besides, another step of FIG. 68 is the same step shown in FIG. 67 described previously, FIG. 68 is an operation flowchart of embodiment 5 of the consumable goods online shopping system according to the present invention.

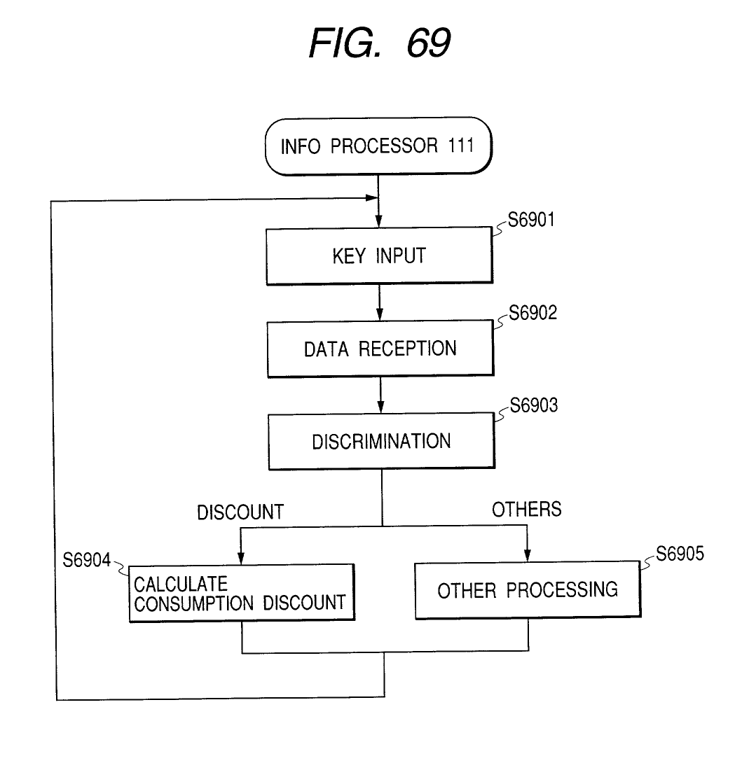

Further, as shown in FIG. 69, after key input, data receiving, discrimination processing instructions (steps S6901, 6902, and 6903), in the information processing means 111 of the communication information equipment, if another necessary processing (step S6905) and consumption discount calculation processing (step S6904) are executed according to the consumption discount calculation instruction, the consumption discount can also be counted in the communication information equipment. FIG. 69 is an operation flowchart of embodiment 5 of the consumable goods online shopping system according to the present invention.

According to the processing flow described above, in this embodiment, a function that allows communication information equipment to count the consumption amount of the consumable goods and accumulate consumption amount in the equipment. At the purchase of the consumable goods, a system that performs control at the side of the portal server can be constructed so that the accumulated consumption amount is sent as the order start request notification information and the consumable goods can be purchased at the discount that matches the consumption amount, and a price advantage can be offered to the user.

Further, the consumption discount can also be calculated according to the user instruction in the equipment and the coupon ticket shown in embodiment 7 can be issued.

(Embodiment 6)

The embodiment 6 of the consumable goods online shopping system according to the present invention is described below with reference to the drawings.

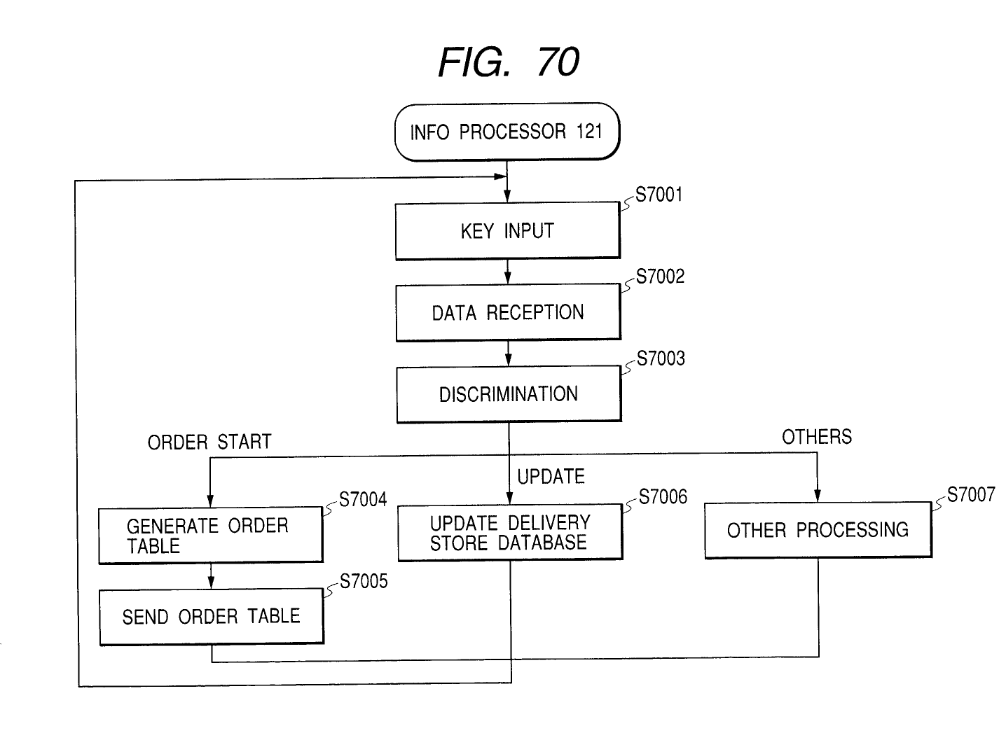

In this embodiment 6, regarding the processing in the order table creation processing, in the information processing means 121 of the equipment manufacturer portal server, as shown in FIG. 70, after key input, data receiving, discrimination processing instructions (steps S7001, 7002, and 7003), an order start request notification is received from the communication information equipment is received and order table creation processing (step S7004) is executed. After the order table is created, the processing that sends the created order table to the communication information equipment is performed by order table sending processing (step S7005). FIG. 70 is an operation flowchart of embodiment 6 of the consumable goods online shopping system according to the present invention.

Further, delivery store database updating processing is performed by delivery store database update processing (step S7006) and another necessary processing is performed (step S7007).

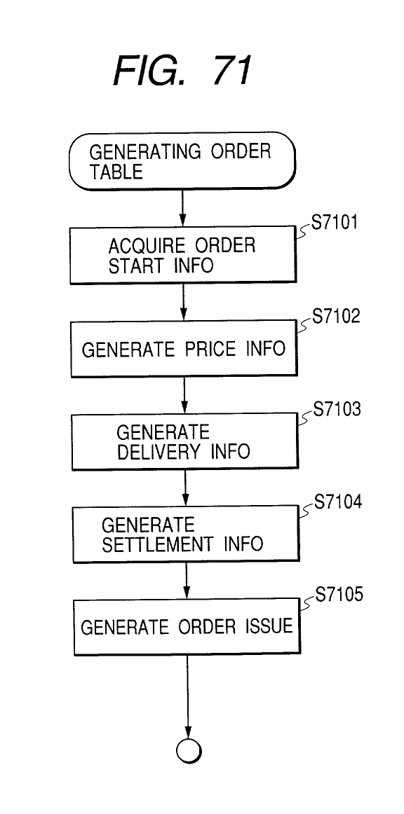

In the order table creation processing, as shown in FIG. 71, acquisition processing (step S7101) of the order start information sent from the communication information equipment is performed by the order table start information acquisition processing. FIG. 71 is an operation flowchart of embodiment 6 of the consumable goods online shopping system according to the present invention.

Next, the information portion regarding the production information in the order table, such as merchandise price information and inventory information is created based on the acquired start information by price information portion creation processing (step S7102).

Then the information about the delivery method is created as the delivery information portion by delivery information creation processing (step S7103).

Next, the setting area of the information necessary for performing the electronic settlement processing is created by electronic settlement information portion creation processing (step S7104) as the electronic settlement information portion. Finally, the area in which an order issue instruction is given and the area in which a coupon ticket issuing instruction is given are created by the order issue portion by the order issue portion creation processing (step S7105).

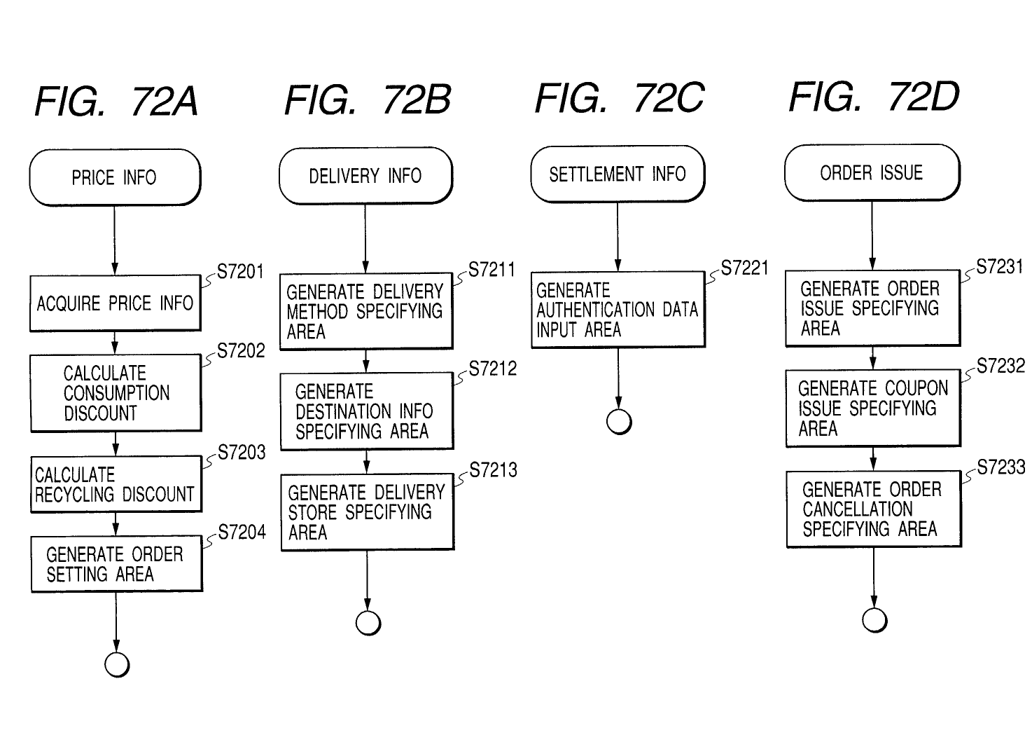

For the price information portion creation processing, as shown in FIG. 72A, first, the consumable goods price database 129 by price information acquisition processing (step S7201) is retrieved based on the machine type information in the order start information and processing that acquires the price information and inventory information of the consumable goods that correspond to the machine type information is performed. Next, processing that calculates consumption discount information is performed by consumption discount calculation processing (step S7202) based on the consumption amount of the consumable goods in the order start information. Subsequently, processing that acquires the number of recovery cartridges stored in the mail address database 126 and calculates the discount that matches the number of recovery cartridges as the recycling discount information by recycling discount calculation processing (step S7203) based on the mail address written to the owner information in the order start information.

Then finally, the order setting area is created by order setting area creation processing (step S7204) based on the price information, inventory information, consumption discount information, and recycling discount information obtained by each of the processing.

Besides, since the price information acquired by the price information acquisition processing is acquired in the sequence sorted in the price order on the consumption goods price database, the price information portion to be created is created in the state sorted according to the price.

Further, when there is a specification in the connection information to the mail order center in the order start information, the acquisition processing of the price information and inventory information in which priority is given to the specified mail order center in the price information acquisition processing is performed and the price information of the order table to which priority is given to the specified mail order center is created.

In the delivery information portion creation processing, as shown in FIG. 72B, first, processing (step S7212) that creates the specification area in which a delivery method, such as mailing, conveyance, store-based delivery can be specified as the specification of the delivery method is performed by delivery method specification area creation processing. Then processing (step S7211) that creates the destination information specification area required when the delivery method is the mailing and conveyance is performed by destination information specification area creation processing. Subsequently, processing that creates the delivery store specification area required when the delivery method is the store-based delivery is performed by the delivery store specification area creation processing (step S7213). Then the specification area obtained by each of the processing is created as the delivery information portion.

Besides, at creation of the destination information specification area, the postal number, address, name, and telephone number written to the owner information in the order start information are set as default values by destination information default setting processing.

Further, at the creation of the delivery store specification area, such setting that can preferentially specify the store which is doing business in the delivery area as a default is performed by store information default setting processing by specifying the delivery area from the postal number, address, and telephone number and retrieving the delivery store database 127 from the specified area information.

Regarding the delivery store database 127, in the information processing means 121 of the portal server, as shown in FIG. 70, delivery store database update processing (step S7006) is executed according to the delivery store database update instruction of the portal server administrator and the latest data is always updated and registered by the input work of the portal server administrator.

In the electronic settlement information portion creation processing, as shown in FIG. 72C, the processing that creates the area to which the authentication data required when an electronic settlement is performed in the electronic settlement server of a financial company by authentication data input area creation processing (step S7221) and the authentication data input area created by the authentication creation processing is created as the electronic settlement information portion.

In the order issue portion creation processing, as shown in FIG. 72D, first, processing that creates the area in which the activation of the mail order issue instruction can be specified is performed by order issue specification area creation processing (step S7231). Then processing that creates the area in which the activation of the coupon ticket issuing instruction can be specified is performed by coupon ticket issuing specification area creation processing (step S7232). Finally, processing that creates the area to which the mail order issue cancellation can be reported is performed by mail order cancellation specification area creation processing (step S7233). Then the specification area created by these processing is created as the order issue portion. FIGS. 72A to 72D are operation flowcharts of embodiment 6 of the consumable goods online shopping system according to the present invention.

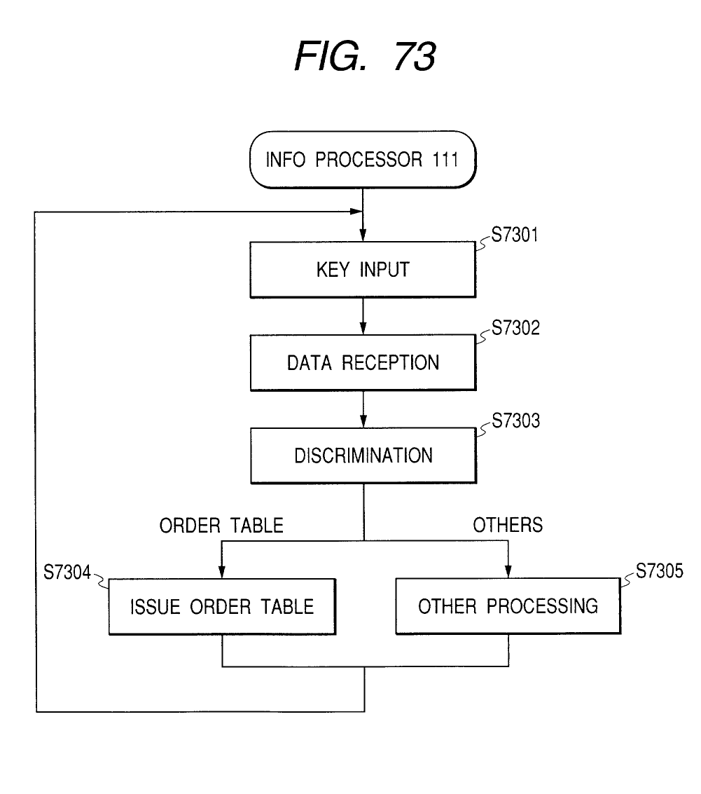

On the other hand, regarding the processing in the order issue processing of embodiment 1, in the information processing means 111 of the communication information equipment, as shown in FIG. 73, after key input, data processing, and discrimination processing instructions (steps S7301, 7302, and 7303), the order table sent from the side of the portal server is received by the order table sending processing, and order table order issue processing (step S7304) is performed together with another necessary processing (step S7305) is performed. FIG. 73 is an operation flowchart of embodiment 6 of the consumable goods online shopping system according to the present invention.

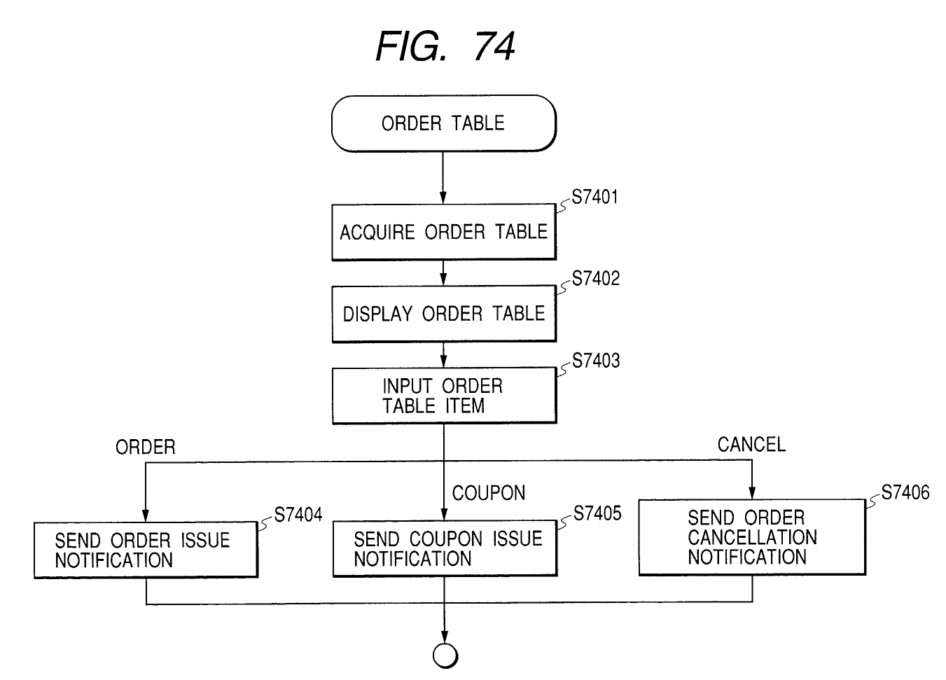

In the order table order issue processing, as shown in FIG. 74, first, order table acquisition processing (step S7401) that acquires the received order table is performed and then processing that displays the acquired order table on the screen is performed by the order table display processing (step S7402). Subsequently, the data necessary for the order table on the displayed screen is input by order table item input processing (step S7403).

Then when processing that performs an order issue and a coupon ticket issuing instruction is performed and an order issue instruction is given, processing that sends the order table to which the order issue notification and necessary data are input to the portal server of the equipment manufacturer is performed by order issue notification sending processing (step S7404). When the coupon ticket issuing instruction is given, processing that sends the coupon ticket issuing notification and order table to the portal server of the equipment manufacturer by coupon ticket issuing notification sending processing (step S7405). When an order cancellation instruction is given, processing (step S7406) that requests order cancellation processing (step S7406) is performed by order cancellation notification sending processing. FIG. 74 is an operation flowchart of embodiment 6 of the consumable goods online shopping system according to the present invention.

According to the processing flow described above, in this embodiment, the portal server of the equipment manufacturer receives an order start request notification, creates an order table of consumable goods based on the individual price of the accumulated consumable goods, and can present it to the communication information equipment. At this time, an order table for online shopping in which the discount of merchandise is explicitly displayed at the creation of the order table and the input of authentication information is enabled so that an regional store, such as a convenience store, can be specified and an electronic settlement is enabled for the delivery method of the merchandise can be created. Further, such order table that can also perform the ticket issuing instruction of only the discount coupon ticket can be created by providing the coupon ticket issuing specification area to the user who does not use online shopping.

On the other hand, in the communication information equipment to which the presentation of the order table is given, the order issue of the consumable goods and the cancellation of the coupon ticket issuing and order issue are enabled by inputting data only to the necessary item of the presented order table. Accordingly, an operation advantage in the order issue operation of extremely-high-degree-of-freedom, clear, simple consumable goods can be offered to the user.

(Embodiment 7)

The embodiment 7 of the consumable goods online shopping system according to the present invention is described below with reference to the drawings.

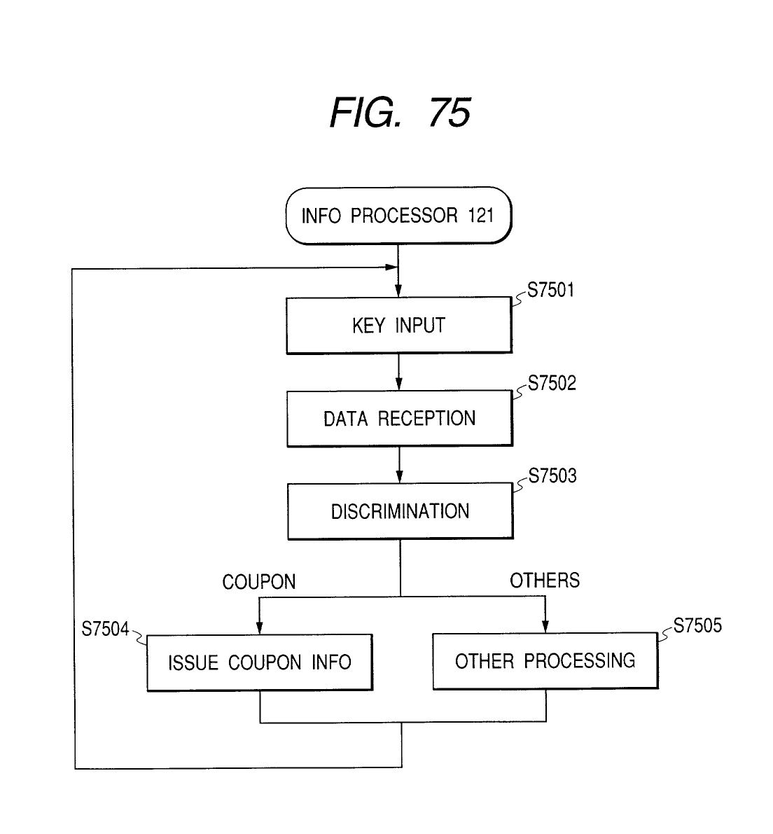

In this embodiment 7, regarding the processing in the order issue processing of embodiment 1, in the information processing means 121 of the portal server of the equipment manufacturer, after key input, data receiving, and discrimination processing instructions (steps S7501, 7502, and 7503), as shown in FIG. 75, a coupon ticket issuing notification sent by the coupon ticket issuing notification sending processing of embodiment 6 is received and coupon information ticket issuing processing (step S7504) is executed together with another necessary processing (step S7504). FIG. 75 is an operation flowchart of embodiment 7 of the consumable goods online shopping system according to the present invention.

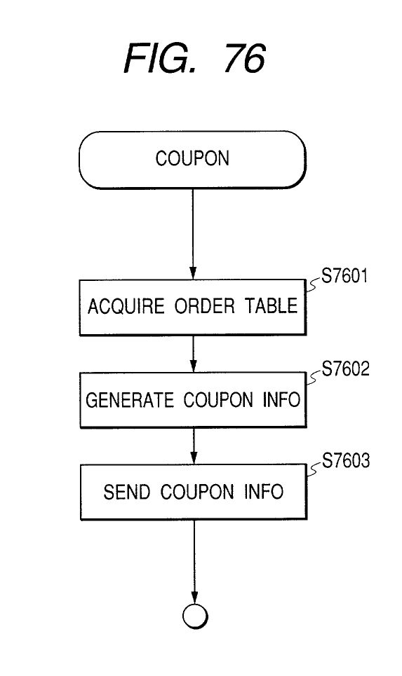

In the coupon information ticket issuing processing, as shown in FIG. 76, first, the order table sent together with the coupon ticket issuing notification is acquired (step S7601) by the order table acquisition processing. Then processing that performs the generation of the coupon information based on the consumption discount information and recycling discount information provided in the price information portion of the acquired order table is performed by coupon information generation processing (step S7602) and processing (step S7603) that sends this generated coupon information to the communication information equipment 110 by the coupon information processing is performed. Further, as another form of the coupon information generated by the coupon information generation processing in step S7603, the form in which the coupon information consists of the consumption discount (or discount rate) calculated based on the consumption amount discount information, recycling discount (or discount rate) calculated based on the recycling discount information, and the additional discount information the consumable goods trader provides is also assumed. FIG. 76 is an operation flowchart of embodiment 7 of the consumable goods online shopping system according to the present invention.

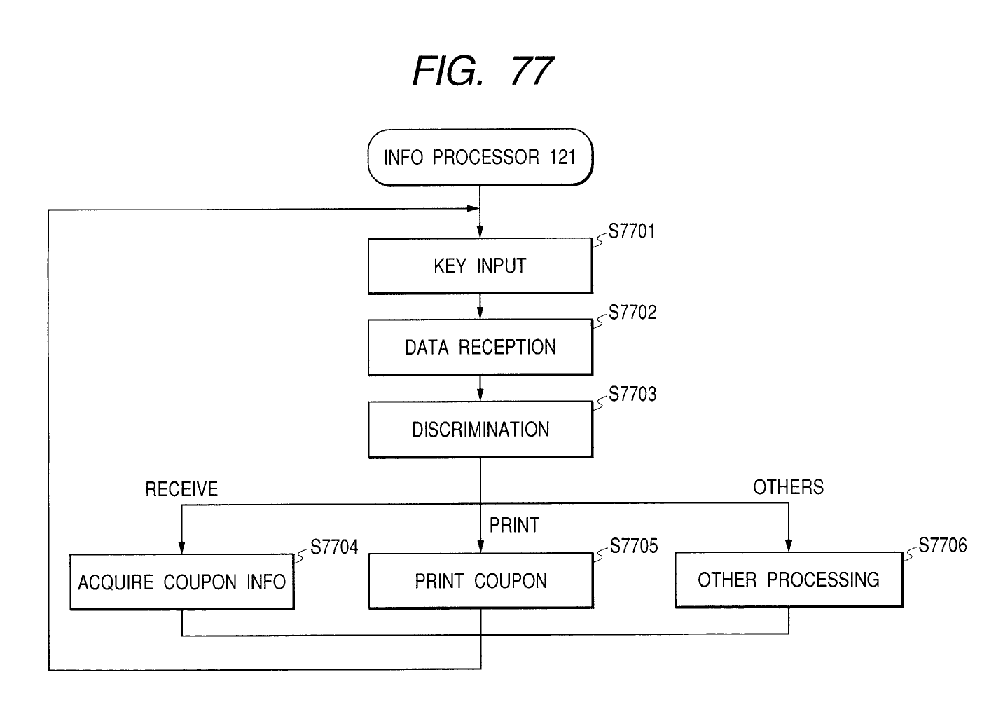

On the other hand, in the information processing means 111 of the communication information equipment, as shown in FIG. 77, after key input, data receiving, and discrimination processing instructions (steps S7701, 7702, and 7703), the sent coupon information is received by the coupon information sending processing, coupon information acquisition processing (step S7704) is performed, and processing that stores the received coupon information in the storage area of the equipment is performed. FIG. 77 is an operation flowchart of embodiment 7 of the consumable goods online shopping system according to the present invention.

Further, together with another necessary processing (step S7706), coupon ticket printing processing (step S7705) is executed according to the coupon ticket printing instruction of the operator and coupon ticket printing processing is performed. FIG. 77 is an operation flowchart of embodiment 7 of the consumable goods online shopping system according to the present invention.

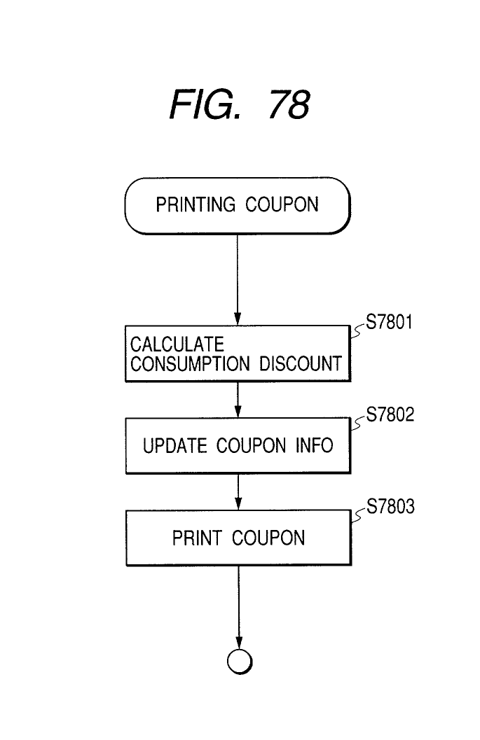

In the coupon ticket printing processing, as shown in FIG. 78, by the consumption discount calculation processing (step S7801) described in embodiment 5, first, a consumption discount is calculated in accordance with the consumption amount previously stored in the equipment. Then the coupon information generated from the consumption amount discount and the coupon information stored in the storage area are compared by coupon information update processing (step S7802), processing that changes the coupon information in the storage area to the coupon information that is advantageous for the discount, and processing (step S7803) that prints the coupon information stored in the storage area as the coupon ticket by the coupon ticket printing issue processing is performed. For example, when the information, such as the recycling discount information (the number of consumable goods recovered by users), is controlled and updated at the side of the portal server, it becomes more economical information (total discount information including the consumption amount discount, recycling discount, and discount of which the period is limited) to which the recycling discount information controlled by the portal server is added, and the user (communication information equipment) can obtain more economical coupon information. Further, on the contrary, when the communication information equipment stores the discount information of which the period is limited that can receive a more economical discount than an ordinary case, ordinary discount information is sent from the portal server to the communication information equipment and the coupon information of the communication information equipment is updated. FIG. 78 is an operation flowchart of embodiment 7 of the consumable goods online shopping system according to the present invention.

According to the processing flow described above, in this embodiment, the portal server of the equipment manufacturer can construct such system that sends discount coupon ticket information to the user communication information equipment against the user who desires the ticket issuing of only the coupon ticket and enables the coupon ticket issuing processing by the communication information equipment, and a price advantage can be offered to the user who does not use the mail order.

Further, when a coupon ticket can also be issued in the communication information equipment and the calculated discount is more advantageous than the discount stored in the storage area of the equipment, a price advantage can be offered to the user who seldom requests the issue of the coupon ticket by giving priority to the discount stored in the storage area of the equipment. Further, by clearing the area in which the coupon information of the communication information equipment is stored, at shipment, priority can always be given to the calculated consumption discount and a price advantage can also be offered to the user who does not connect the network. For example, the user can print the coupon ticket to which the recycling discount information updated in the portal server is added and can receive a more advantageous discount more efficiently as described above. Even if there is no discount based on recycling discount information when the recycling discount information is added, the user can get a discount coupon ticket with discount based on consumption amount at least. In this way, the user can get coupon tickets corresponding to various situations.

(Embodiment 8)

The embodiment 8 of the consumable goods online shopping system according to the present invention is described with reference to the drawings.

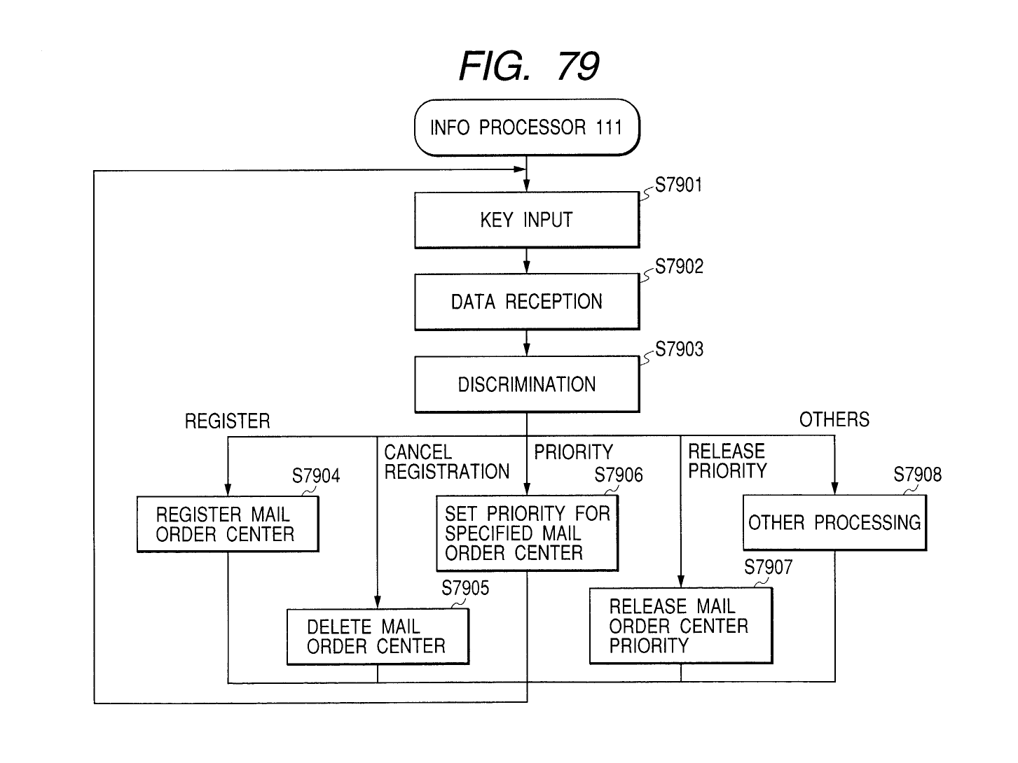

For this embodiment 8, regarding the processing in the order issue processing of embodiment 1, in the information processing means 111 of the communication information equipment, as shown in FIG. 79, when a mail order center registration instruction is given according to the user input instruction after key input, date receiving, and discrimination processing instructions (steps S7901, 7902, and 7903), mail order center registration processing (step S7904) that specifies a specific mail order center from a plurality of mail order centers provided in the price information portion of the order table that is displayed by the order table display processing of embodiment 6 is executed. When a mail order center registration deletion instruction is given, mail order center registration deletion processing (step S7905) that registers and then deletes the specific mail order center from the mail order center registered in the registration memory is executed.

Further, when a mail order center priority specification instruction is given according to the user input instruction, mail order center specification processing (step S7906) that preferentially specifies a specific mail order center from a plurality of mail order centers registered in the registration memory is executed. When a mail order center priority specification release instruction is given, mail order center specification release processing (step S7907) that releases priority specification is executed and another necessary processing (step S7908) is executed. FIG. 79 is an operation flowchart of embodiment 8 of the consumable goods online shopping system according to the present invention.

Besides, regarding the mail order center to which priority specification is given, in the order start information generation processing described in embodiment 4, the order start information is incorporated as the connection information to the mail order center to which the priority specification is given. In the price information acquisition processing described in embodiment 6, the acquisition processing of the price information and stock information in which priority is given to the specified mail order center is performed and the creation of the order table in which priority is given to the specified mail order center is performed.

According to the processing flow described above, in this embodiment, a mail order center registration function, a mail order center registration deletion function, a mail order center specification function, and a mail order center specification release function are provided in the communication information equipment. Then a specific mail order center can preferentially be selected at all times by being able to store and register a plurality of the mail order centers selected with the registration function in the storage area of the equipment and by being able to specify the specific mail order center from a plurality of mail order centers stored and registered with the specification function and a choice advantage over the selection of a merchandise supplier can be offered to the user.

(Embodiment 9)

The embodiment 9 of the consumable goods online shopping system according to the present invention is described below with reference to the drawings.

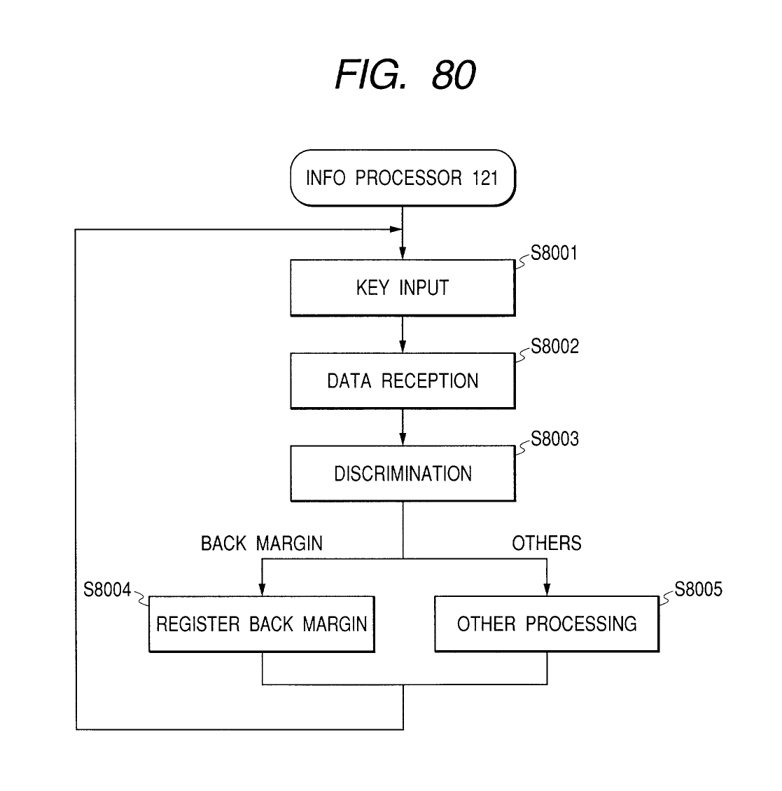

In this embodiment 9, regarding the processing in the order issue processing of embodiment 1, in the information processing means 121 of the portal server of the equipment manufacturer, as shown in FIG. 80, processing that registers the information of the brokerage and discount fee which match handling amount decided according to the arrangement with each mail order center is previously performed by back margin registration processing (step S8004) at the side of the manufacturer according to the data input of the portal sever administrator together with another necessary processing (step S8005) after key input, data receiving, and discrimination processing instructions (steps S8001, 8002, and 8003). FIG. 80 is an operation flowchart of embodiment 9 of the consumable goods online shopping system according to the present invention.

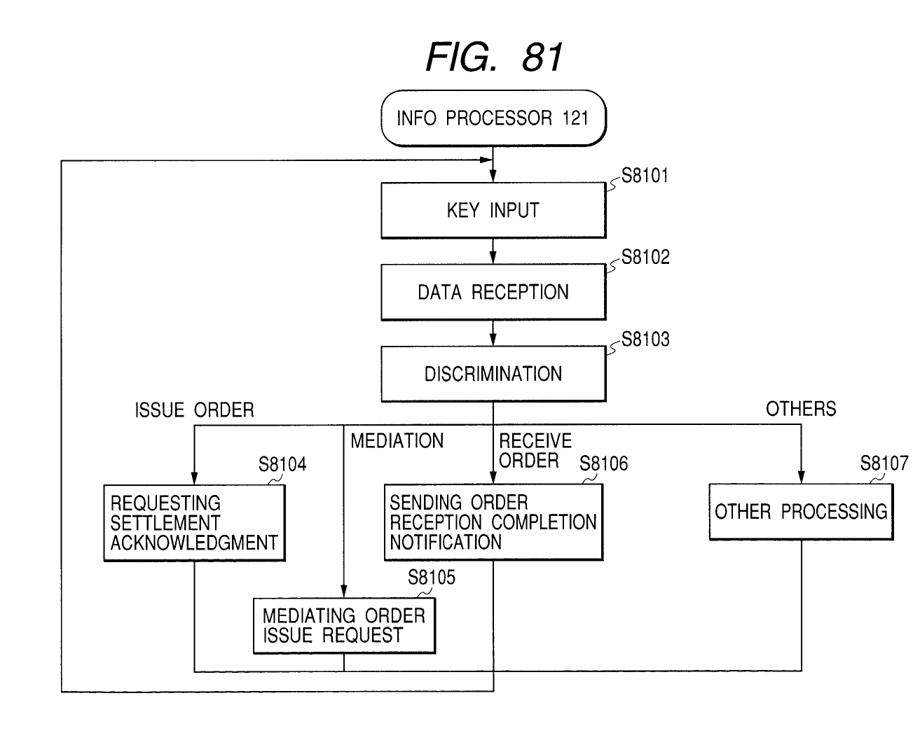

Subsequently, when the information of the brokerage and discount that match this handling amount, in the information processing means 121 of the portal server of the equipment manufacturer, as shown in FIG. 81, after key input, data receiving, and discrimination processing instructions (steps S8101, 8102, and 8103), an order issue notification from the communication information equipment 110 is received, acknowledgment information is created based on the authentication data that is input to the order table, and electronic settlement acknowledgment request processing (step S8104) that performs an acknowledgment request of the electronic settlement for the order issue merchandise to the specified mail order center is performed to the electronic settlement sever 130 of a financial company.

Since electronic settlement processing is executed in the electronic settlement server 130 by the electronic settlement acknowledgment request processing and the result of the electronic settlement processing is sent to the side of the portal server as acknowledgment result notification information, this acknowledgment result notification information is received. In the portal server, order issue request mediation processing (step S8105) that performs mediation of an order issue to the mail order center server 140 is executed.

When the order issue request mediation processing is executed, a mediation order issue of the order table to the mail order center server 140 is performed. Since this order issue is received and a received order acknowledgment notification is sent from the side of the mail order center, the order received acknowledgment notification is received and processing that issues an order issue completion notification to the communication information equipment 110 is performed by received order completion notification sending processing (step S8106). Further, another necessary processing (step S8107) is also performed.

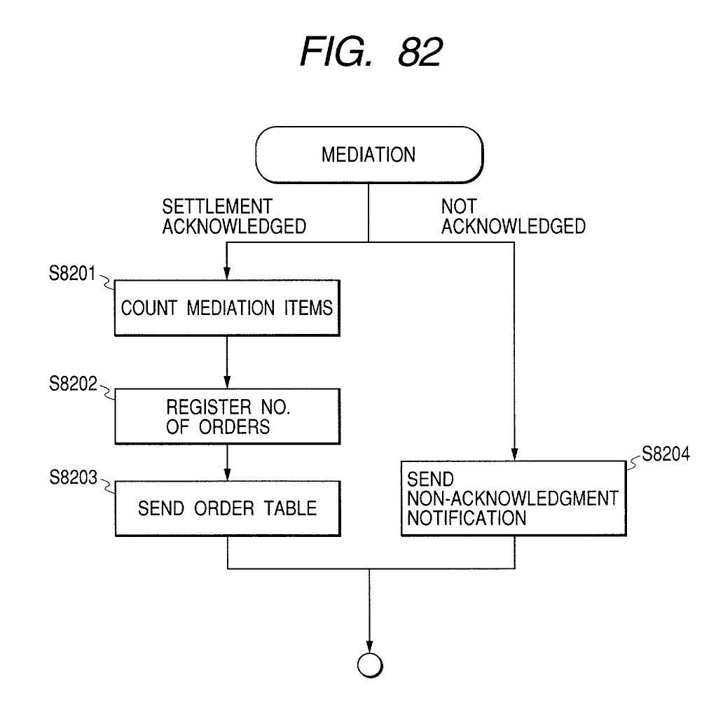

In the order issue request mediation processing, as shown in FIG. 82, when the acknowledgment result notification information from the electronic settlement server 130 is discriminated and an electronic settlement is acknowledged, number of mediation items counting processing (step S8201) that counts the number of mediation items for each mail order center and processing that registers the number of orders counted by the number of mediation items counting processing in the mail order center registration information database 128 for each male order center together with the order table of the order of which the order issue request is received. Subsequently, processing that sends the order table of which the order issue is received to the male order center server 140 is performed by order issue request order table sending processing (step S8203).

Further, when no electronic settlement is acknowledged, processing (step S8204) that sends an electronic settlement not-acknowledged notification to the communication information equipment 110 is performed by electronic settlement not-acknowledged notification processing. FIG. 82 is an operation flowchart of embodiment 9 of the consumable goods online shopping system according to the present invention.

Besides, the number of orders that is counted by the number of mediation items counting processing and registered in the mail order center registration information database 128 by the order issue request registration processing is referred to as occasions demand and used when the value based on the number of orders is calculated. For example, in the settlement processing of embodiment 1, the number of orders is referred to for calculating the brokerage paid from the side of the mail order center and is referred to for calculating the discount paid to the mail order center in accordance with the number of mediation items.

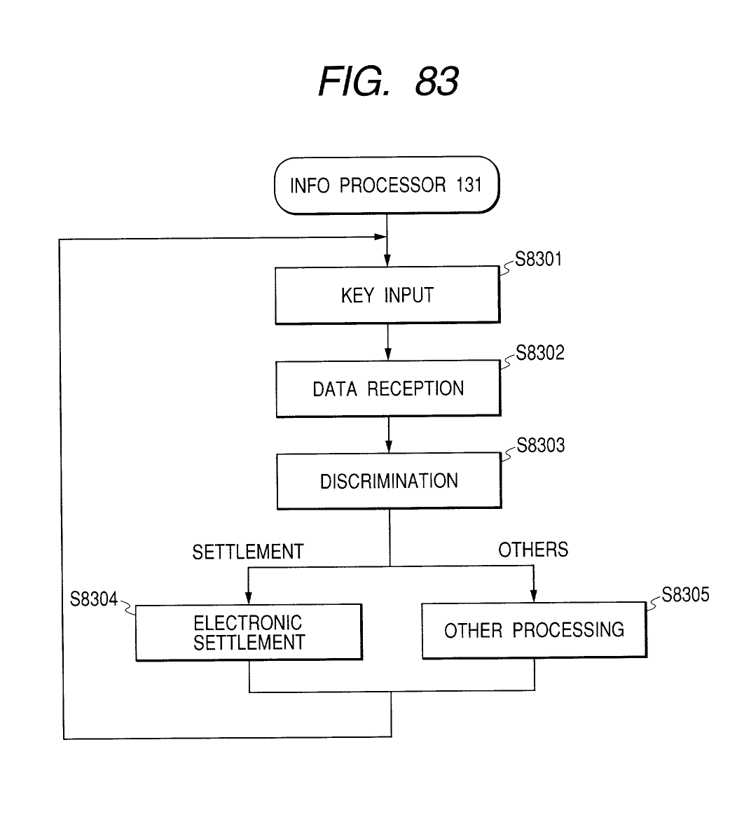

Further, in the information processing means 131 of the electronic settlement server of the financial company, as shown in FIG. 83, the electronic settlement acknowledgment request from the portal server 120 of the equipment manufacturer is received, and after key input, data receiving, and discrimination processing instructions (steps S8301, 8302, and 8303), electronic settlement processing (step S8304) is performed together with another necessary processing (step S8305). FIG. 83 is an operation flowchart of embodiment 9 of the consumable goods online shopping system according to the present invention.

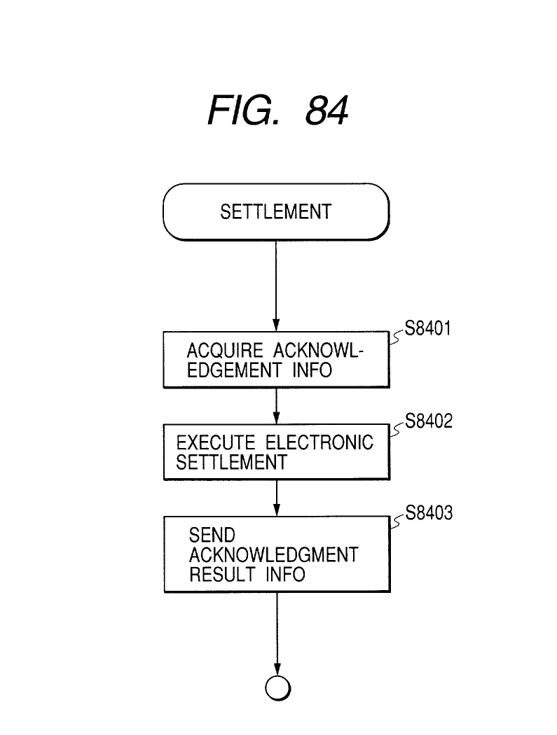

In the electronic settlement processing, as shown in FIG. 84, processing that acquires acknowledgment information is performed by the acknowledgment information acquisition processing (step S8401) and processing (step S8402) that executes an electronic settlement by the electronic settlement execution processing based on the information registered on the acquired acknowledgment information and electronic settlement database. After the execution processing, processing (step S8402) that sends the result of the electronic settlement to the portal server as acknowledgment result notification information. FIG. 84 is an operation flowchart of embodiment 9 of the consumable goods online shopping system according to the present invention.

When further details of the electronic settlement execution processing (electronic settlement processing) is described, for the electronic settlement server, in the acknowledgment information acquisition processing (step S8401), the acknowledgment information including the authentication data (for example, a card number of a credit card and a personal indication number that corresponds to the card number) of a consumable goods purchaser that the portal server receives from the communication information equipment 11 and an amount claimed (a price of merchandise) to a financial company (credit company) is acquired. Then in the electronic settlement execution processing (step S8402), the review of the consumable goods purchaser is performed based on the acquired authentication data. For example, when it is confirmed that a burglary of the card is not reported to the police, the card owner is the person himself or herself, and a payer has his or her solvency, this result is generated as the acknowledgment result notification information. Subsequently, the payment (transfer instruction to the predetermined account of the portal server) of the money that matches the amount claimed is performed from the electronic settlement server to the portal server. Further, when it is confirmed that an incorrect card is used or the payment is disabled, the payment of the money is not performed and the acknowledgment result notification information indicating an acknowledgment rejection is generated. Then the processing that sends this generated acknowledgment result notification information to the portal server is performed by the electronic settlement acknowledgment result information notification processing (step S8403). Besides, for the money that the card company pays, the card company collects the money from the consumable goods purchaser on the responsibility of the card company.

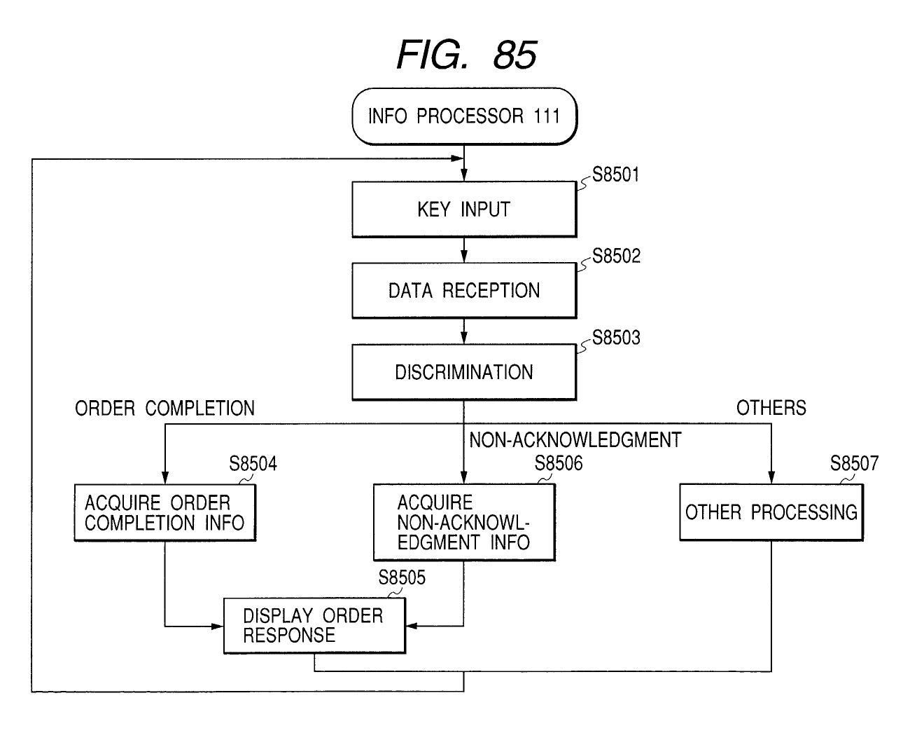

Further, in the information processing means 111 of the communication information equipment, as in shown in FIG. 85, when an order issue completion information is received from the portal server of the equipment manufacturer after key input, data receiving, and discrimination processing instructions (steps S8501, 8502, and 8503), processing that acquires order issue completion information is performed by the order issue completion information acquisition processing and processing that displays this acquired order issue completion information by order issue response display processing (step S8505) is performed. When an electronic settlement not-acknowledged notification is received from the portal server, electronic settlement not-acknowledged information is acquired by electronic settlement not-acknowledged information acquisition processing (step S8506) and processing that displays this acquired electronic settlement not-acknowledged information is performed by the order issue response display processing. Further, another necessary processing (step S8507) is performed. FIG. 85 is an operation flowchart of embodiment 9 of the consumable goods online shopping system according to the present invention.

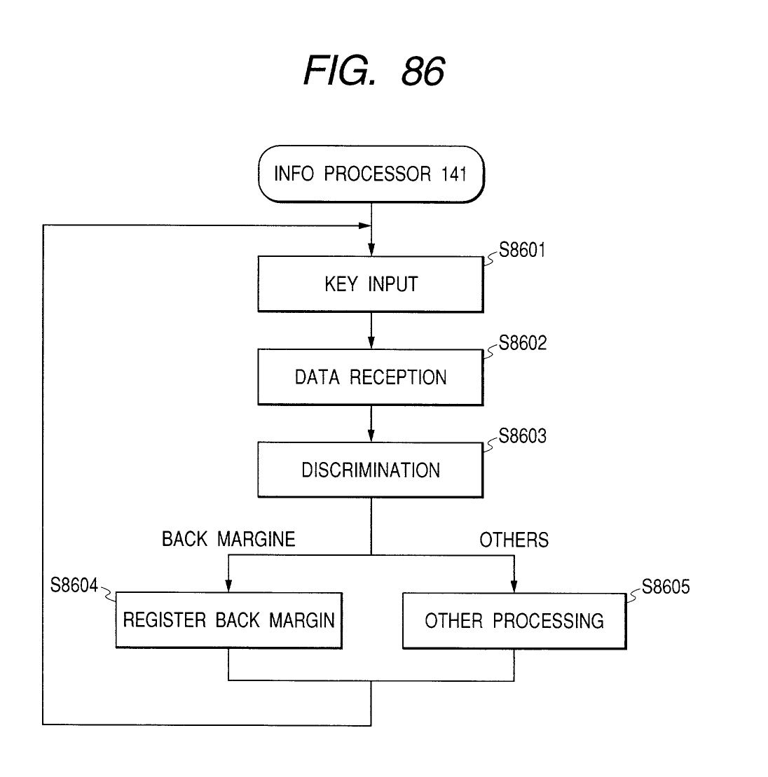

On the other hand, also in the information processing means 141 of each mail order center server, as shown in FIG. 86, processing (step S8604) that registers the information of the brokerage and discount that match handling amount, previously decided by the arrangement with the manufacturer by the data input of the server administrator of each mail order center after key input, data receiving, and discrimination processing instructions (steps S8601, 8602, and 8603) in the storage area of the server is performed by the back margin processing at the side of the mail order center side. Further, another necessary processing (step S8605) is performed. FIG. 86 is an operation flowchart of embodiment 9 of the consumable goods online shopping system according to the present invention.

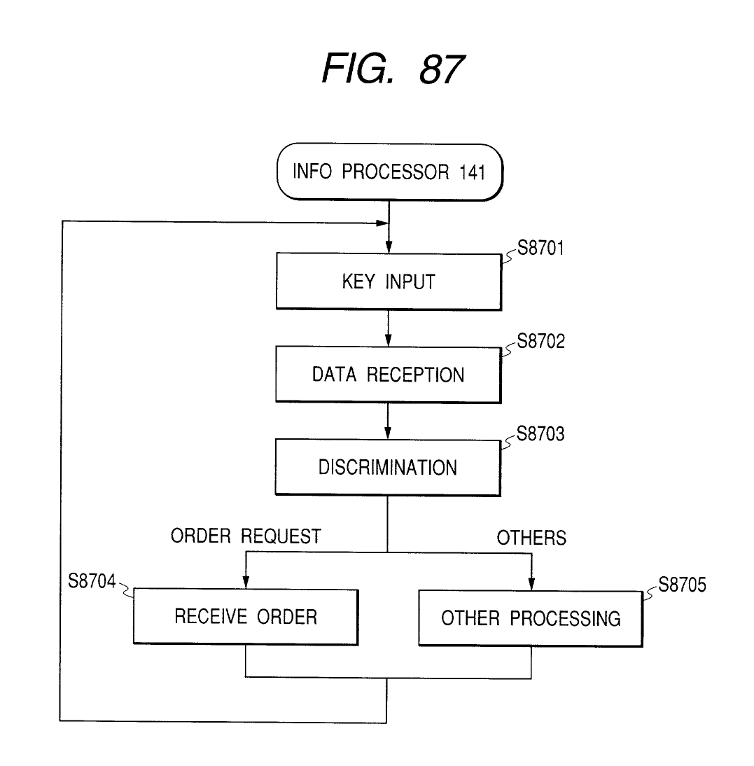

Then when the information about the brokerage and discount that matches this handling amount, in the information processing means 141 of the mail order center server, as shown in FIG. 87, after key input, data receiving, and discrimination processing instructions (steps S8701, 8702, and 8703), an order issue request from the portal server 120 of the equipment manufacturer is received together with another necessary processing (step S8705) and received order processing (step S8704) is executed. FIG. 87 is an operation flowchart of embodiment 9 of the consumable goods online shopping system according to the present invention.

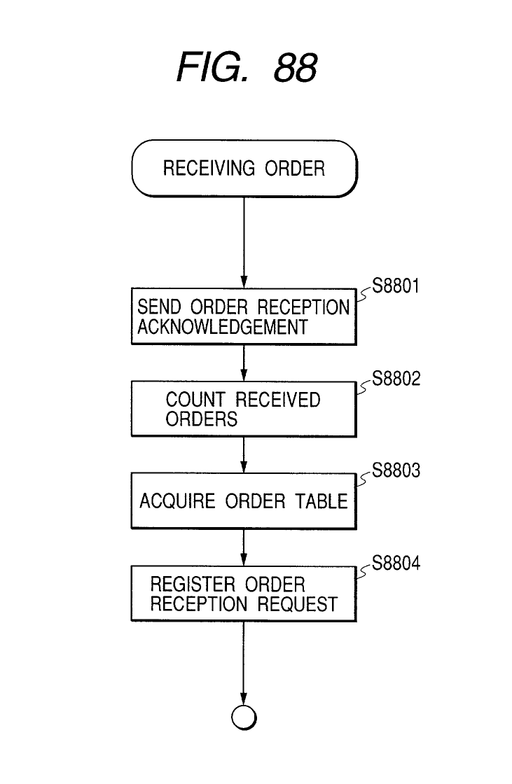

In the order received processing, as shown in FIG. 88, when a received order request is received, order received acknowledgment notification processing (step S8801) that sends a received order acknowledgment notification to the portal server 120 is performed. Subsequently, the number order issue requests ordered from the portal server 120 of the equipment manufacturer is counted as the number of received orders by number of received orders counting processing (step S8802). Then an order table of the order of which the order issue is received is acquired by order table acquisition processing (step S8803). Subsequently, processing that registers the number of received orders counted by the number of received orders counting means and the acquired order table in the order table database 148 by received order request registration (step S8804) is performed. FIG. 88 is an operation flowchart of embodiment 9 of the consumable goods online shopping system according to the present invention.

Besides, the number of received orders counted by the number of received orders counting processing and registered in the order table database by the received order request registration processing is also referred to as occasions demand and used when the value based on the number of received orders is calculated. For example, in the settlement processing of embodiment 1, the number of received orders is referred to for calculating the brokerage paid to the equipment manufacturer by the brokerage calculation processing at the side of the mail order center and is referred to for calculation the discount fee paid from the side of the equipment manufacturer in accordance with the number of orders by the received order discount calculation processing at the side of the mail order center.

According to the processing flow described above, in this embodiment, the portal server of the equipment manufacturer can construct a system so that the order issued from the side of the communication information equipment can be ordered to the specified specific mail order center and a profit advantage due to the brokerage to the mail order center can be offered to the equipment manufacturer.

Further, a system can also be constructed by providing a function that counts and accumulates the order issue amount to the mail order center at the side of the portal server of the equipment manufacturer so that the discount of the brokerage that matches the handling amount to each mail order center can be given and a profit advantage due to a discount can be offered to the mail order center.

(Embodiment 10)

The embodiment 10 of the consumable goods online shopping system according to the present invention is described below with reference to the drawings.

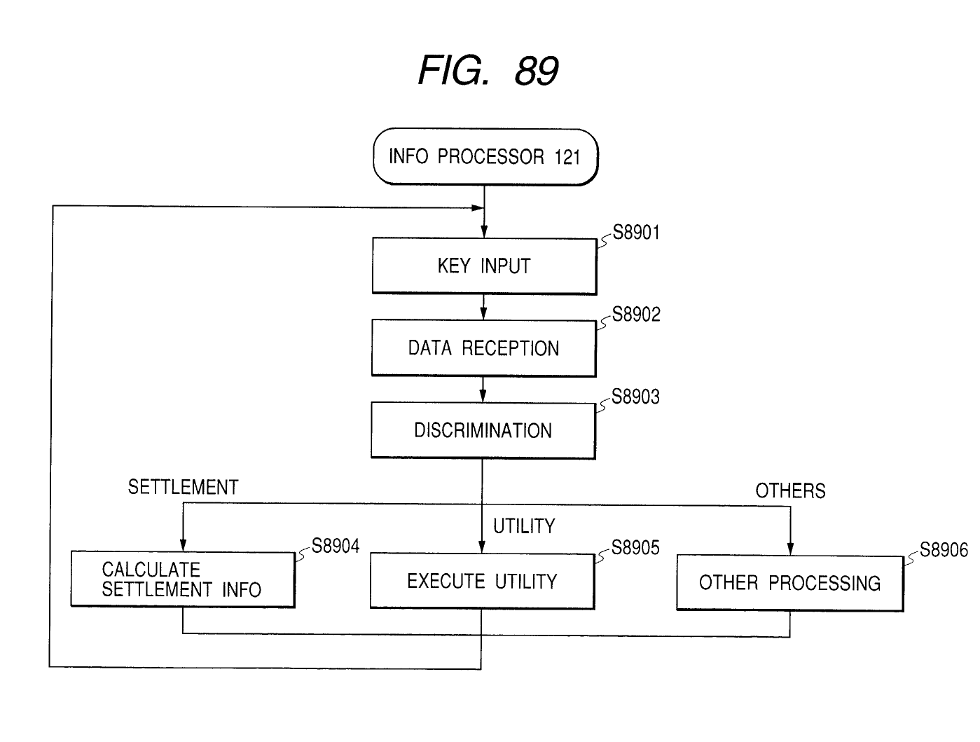

In this embodiment 10, regarding the processing at the side of the portal server in the settlement processing of embodiment 1, in the information processing means 121 of the portal server of the equipment manufacturer, as shown in FIG. 89, after input key, data receiving, and discrimination processing instructions (steps S8901, 8902, and 8903), in addition to utility execution processing (step S8905) and another necessary processing (step S8906), settlement information calculation processing (step S8904) at the side of the manufacturer that calculates monthly settlement information for each mail order center on a monthly settling day or according to the instruction of the server administrator is executed. FIG. 89 is an operation flowchart of embodiment 10 of the consumable goods online shopping system according to the present invention.

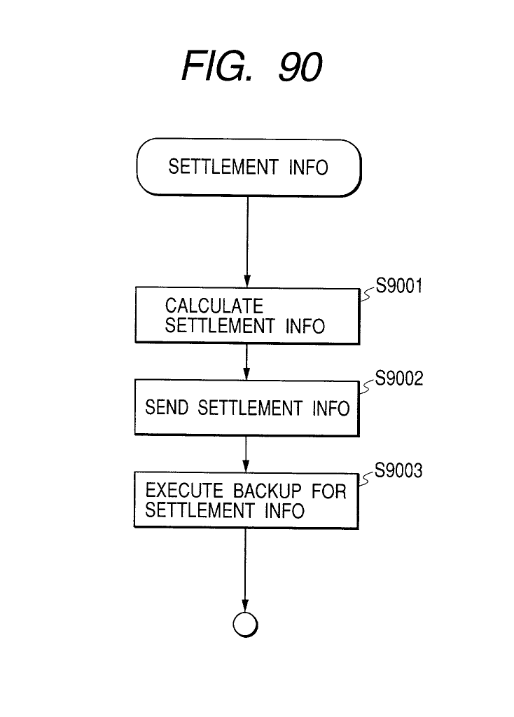

In the settlement information calculation processing, as shown in FIG. 90, first, monthly settlement information calculation processing is performed by settlement information calculation execution processing (step S9001) and then settlement information sending processing at the side of the manufacturer that sends the calculated settlement information to each mail order center is performed by settlement information sending processing (step S9002). Subsequently, processing that backs up all of the settlement information total, settlement information, and order table handled within a settling month in the backup area of the mail order center registration information database 128 for each mail order center by settlement information backup processing (step S9003) and processing that clears the number of monthly order issue items and an order issue order table is performed when the settlement information is backed up. FIG. 90 is an operation flowchart of embodiment 10 of the consumable goods online shopping system according to the present invention.

First, shown in FIG. 89, in the communication information processing 121 of the portal server of equipment manufacturer, settlement information utility processing (step 8905) at the side of the manufacturer that prints and deletes the information backed up in the backup area is also performed according to the instruction of the portal server administrator.

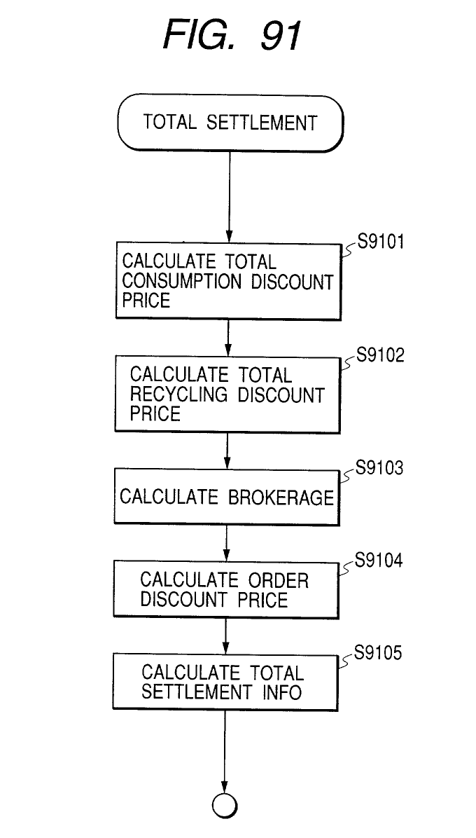

Besides, in the settlement information calculation processing at the side of the manufacturer, as shown in FIG. 91, consumption discount price total calculation processing (step S9101) at the side of the manufacturer that calculates the consumption discount price total recorded in the order table to all the order tables of the mail order center specified in the mail order center registration information database 128 as settlement information is performed. Subsequently, recycling discount total price calculation processing (step S9102) at the side of the manufacturer that calculates the total of the recycling discount price recorded in the order table as the settlement information is performed. Next, brokerage calculation processing (step S9103) at the side of the manufacturer that calculates the brokerage paid from the side of the mail order center in accordance with the number of orders counted according to the procedure described in embodiment 9 and recorded in the mail order center registration information database 128 and then order issue discount calculation processing (step S9104) at the side of the manufacturer that calculates the discount fee paid to the mail order center in accordance with the number of orders as the settlement information. Finally, settlement information total calculation processing (step S9105) at the side of the manufacturer that calculates the value in which an order issue discount price is subtracted from the total of a consumption discount price, a recycling discount price, and order issue brokerage as the settlement information total is performed. FIG. 91 is an operation flowchart of embodiment 10 of the consumable goods online shopping system according to the present invention.

According to the processing flow described above, in this embodiment, the portal server of the equipment manufacturer can automate part of accounting processing by providing a function that calculates the settlement information of the transaction between it and the mail order center on a monthly settling day and a profit advantage due to a reduction of personnel expenses can be offered to the equipment manufacturer.

(Embodiment 11) The embodiment 11 of the consumable goods online shopping system according to the present invention is described below with reference to the drawings.

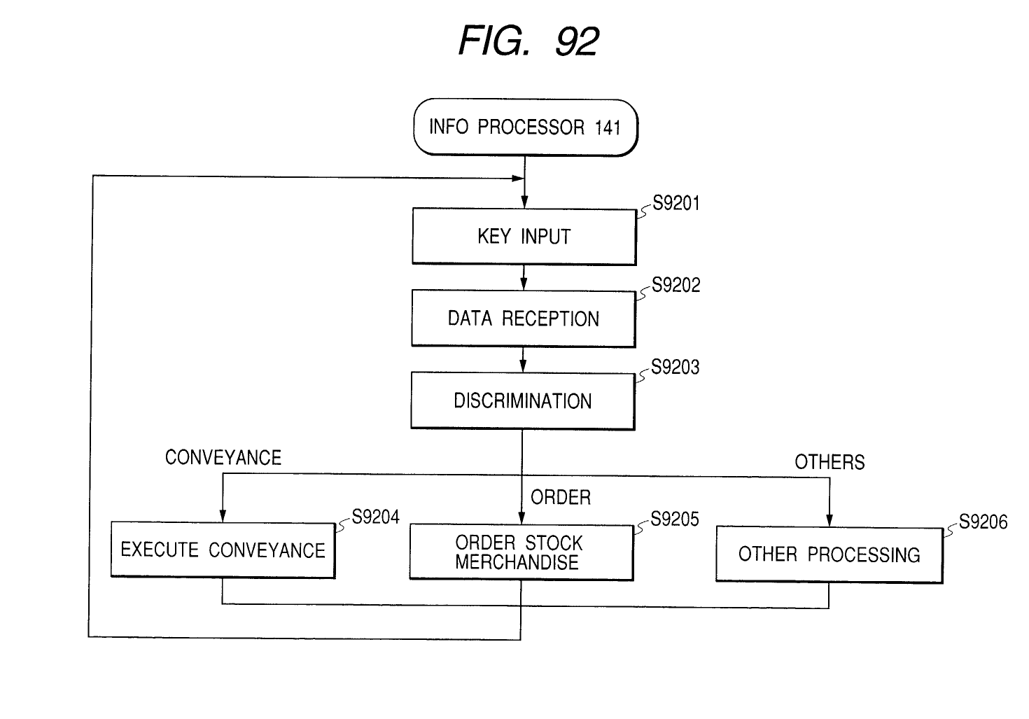

In this embodiment 11, regarding the processing in the order delivery processing of embodiment 1, in the information processing means 141 of each server of a mail order center, as shown in FIG. 92, after key input, data receiving, and discrimination processing instructions (steps S9201, 9202, and 9203), when a conveyance procedure execution instruction is given according to the instruction of the server administrator, conveyance procedure processing (step S9204) is executed. When a stock order issue instruction is given, the input processing of an order table is performed by stock order issue processing (step S9205) and processing that performs the order issue of a stored merchandise is executed to the portal server of the equipment manufacturer based on this order table. Further, another necessary processing (step S9206) is also be performed. FIG. 92 is an operation flowchart of embodiment 11 of the consumable goods online shopping system according to the present invention.

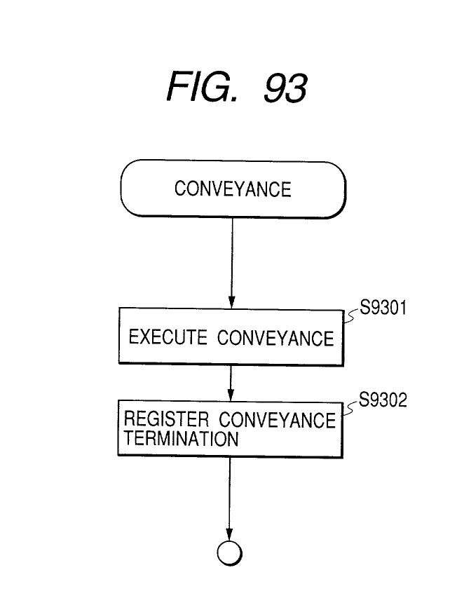

Regarding conveyance procedure processing, as shown in FIG. 93, merchandise conveyance procedure execution processing (step S9301) that performs the conveyance procedure of merchandise to the order table in which the conveyance procedure registered in the order table database 148 is not terminated based on the delivery method specified in the order table and conveyance procedure termination registration processing (step S9302) that registers conveyance procedure termination in the order table database to the order table in which the merchandise conveyance procedure is terminated. FIG. 93 is an operation flowchart of embodiment 11 of the consumable goods online shopping system according to the present invention.

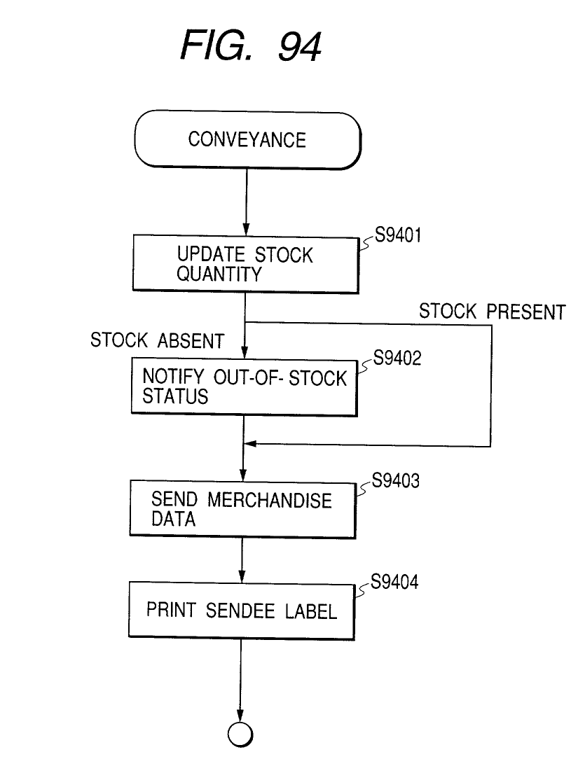

In the merchandise conveyance procedure execution processing, as shown in FIG. 94, first, processing (S9401) that performs the update of the stock quantity in the merchandise database 146 in accordance with the number of received orders is executed by merchandise stock quantity update processing, and out-of-stock notification processing (step S9402) that reports the information of no stock remaining quantity to the server administrator of the mail order center is performed by the update processing when the stock quantity is exhausted.

Then, processing that sends the merchandise data updated in the merchandise database 146 to the portal server 120 of the equipment manufacturer by merchandise data sending processing (step S9403) is performed and subsequently, sendee label printing processing (step S9404) that prints the postal number, address, and name of a sendee on a label paper based on the owner information of an order table. FIG. 94 is an operation flowchart of embodiment 11 of the consumable goods online shopping system according to the present invention.

Besides, in this embodiment, an example in which when the stock quantity is exhausted by the merchandise stock quantity update processing, the result is reported to the server administrator by the out-of-stock notification processing and an order issue of stored merchandise is performed according to the input instruction of the server administrator which receives this notification is shown. However, the order issue of the stored merchandise can be performed simultaneously with the detection of no stock quantity by executing stored merchandise order issue processing based on the previously customized order table instead of the out-of-stock notification processing.

According to the processing flow described above, in this embodiment, the mail order center server can automate part of conveyance processing by providing a function that receives an order from the portal server and performs a merchandise conveyance procedure using the delivery method specified in an order table, a function that creates a sendee address label based on the owner information written to the order table, and a function that performs merchandise inventory control at the conveyance of merchandise, and a profit advantage due to a reduction of personnel expenses can be offered to the mail order center.

(Embodiment 12)

The embodiment 12 of the consumable goods online shopping system according to the present invention is described below with reference to the drawings.

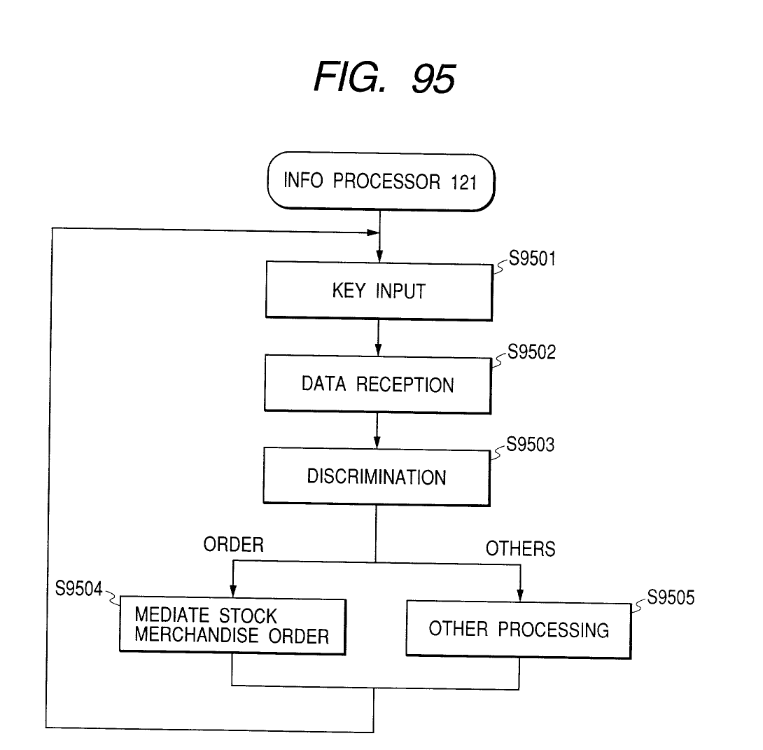

For this embodiment 12, in the information processing means 121 of the portal server of the equipment manufacturer, as shown in FIG. 95, after key input, data receiving, and discrimination processing instructions (steps S9501, 9502, and 9503), a stored merchandise order issue request issued by the stored merchandise order issue processing is received, stored merchandise order issue mediation processing (step S9504) is executed, and processing that mediates an order issue of the stored merchandise of which the received order is received and sends an order table to the merchandise control center server 160 of the consumable goods is performed. Further, another necessary processing (step S9505) is also performed. FIG. 95 is an operation flowchart of embodiment 12 of the consumable goods online shopping system according to the present invention.

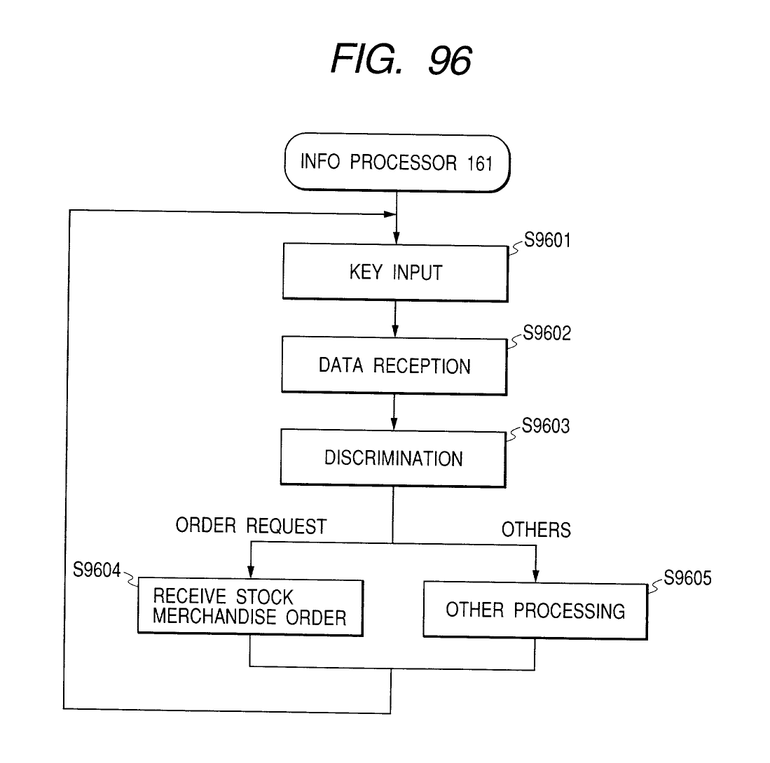

Further, in the information processing means 161 of the merchandise control center server of the consumable goods, as shown in FIG. 96, after key input, data receiving, and discrimination processing instructions (steps S9601, 9602, and 9603), a stored merchandise order issue request mediated by the stored merchandise order issue mediation processing is received together with another necessary processing (step S9605) and stored merchandise received order processing is performed by stored merchandise received order processing (step S9604) is performed. FIG. 96 is an operation flowchart of embodiment 12 of the consumable goods online shopping system according to the present invention.

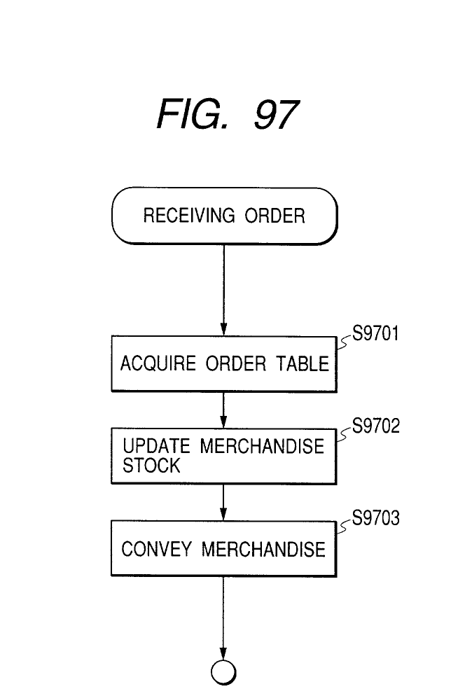

In the stored merchandise received order processing, as shown in FIG. 97, an order table of stored merchandise is acquired by stored merchandise order table acquisition processing (step S9701) and merchandise inventory update processing (step S9702) that updates the merchandise inventory control database 166 in which consumable goods merchandise inventory control information is recorded based on the acquired order table is executed. Subsequently, processing (S9703) that conveys stored merchandise of which the received order is received to the mail order center of which the order issue is given is performed. FIG. 97 is an operation flowchart of embodiment 12 of the consumable goods online shopping system according to the present invention.

According to the processing flow described above, in this embodiment, a mail order center enables the order issue of stored merchandise to the consumable goods merchandise control center via the portal server of the equipment manufacturer when the stored merchandise is exhausted and can offer an operation advantage in the stored merchandise order issue operation to the mail order center.

(Embodiment 13)

The embodiment 13 of the consumable goods online shopping system according to the present invention is described below with reference to the drawings.

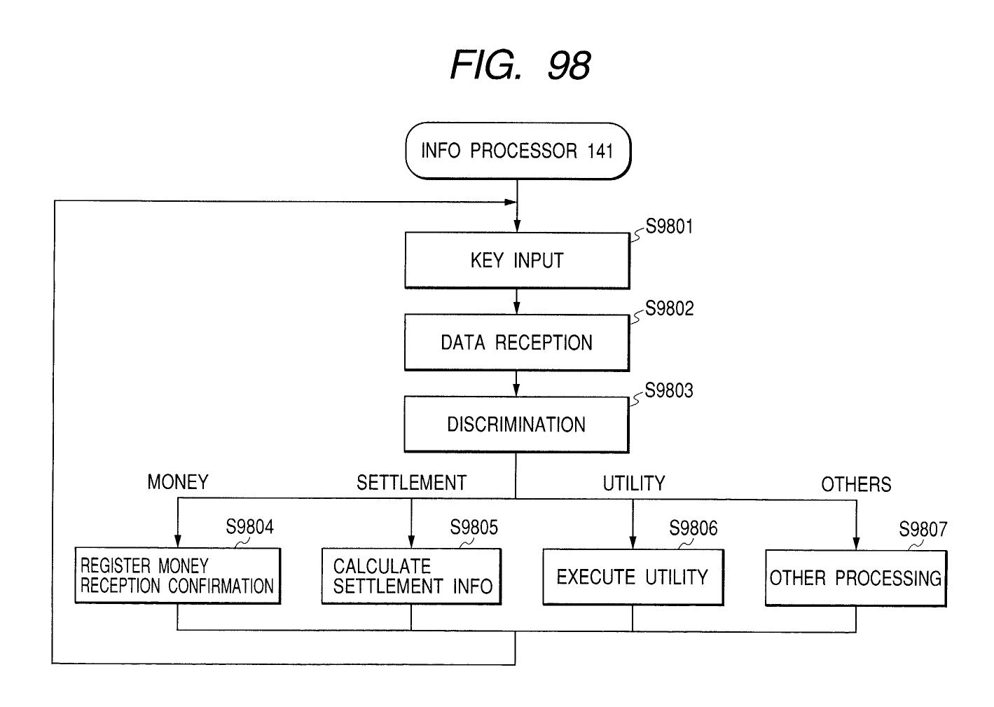

In this embodiment 13, regarding the processing at the side of the mail order center server in the settlement processing of embodiment 1, in the information processing means 141 of the mail order center, as shown in FIG. 98, when a money-received confirmation information registration instruction is given on a monthly settling day or according to the instruction of the server administrator after key input, data receiving, and discrimination processing instructions (steps S9801, 9802, and 9803), processing that adds money-received confirmation information to an order table in which the money received to an order is confirmed by money-received confirmation information registration processing (step S9804). When a settlement calculation instruction is given, processing that calculates monthly settlement information is performed by settlement information calculation processing (step S9805). Further, utility execution processing (step S9806) and other processing (step S9807) are also executed. FIG. 98 is an operation flowchart of embodiment 13 of the consumable goods online shopping system according to the present invention.

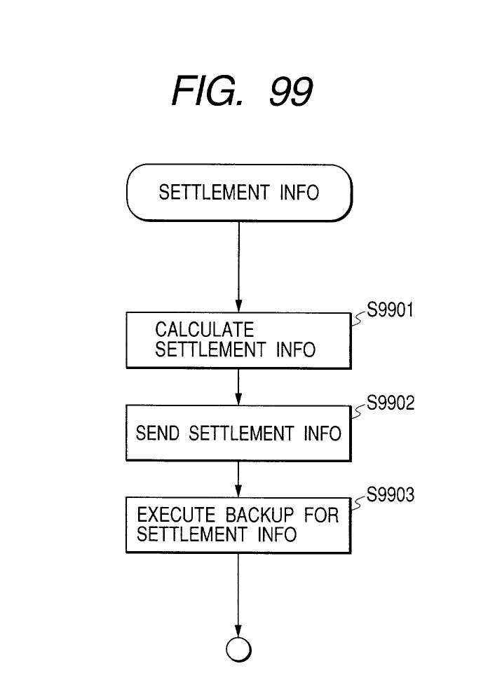

In the settlement information calculation processing at the side of mail order center, as shown in FIG. 99, first, monthly settlement information calculation processing is executed by settlement information calculation execution processing (step S9901) and then processing that sends the calculated settlement information to the equipment manufacturer portal server 120 by settlement information sending processing (step S9902) at the side of the mail order center is performed. Finally, processing that (step S9903) that backs up all of the settlement information total, settlement information, and received order table handled within a settling month in the backup area in the order table 148 by settlement information backup processing and processing that clears a received order table to which the number of monthly received orders and money-received confirmation information are added and of which the settlement processing is terminated when the settlement information is backed up. FIG. 99 is an operation flowchart of embodiment 13 of the consumable goods online shopping system according to the present invention.

Further, as shown in FIG. 98, in the information processing means 141 of the equipment manufacturer, settlement information utility processing (step S9806) that prints and deletes the information backed up in the backup area according to the instruction of the portal server administrator is also performed.

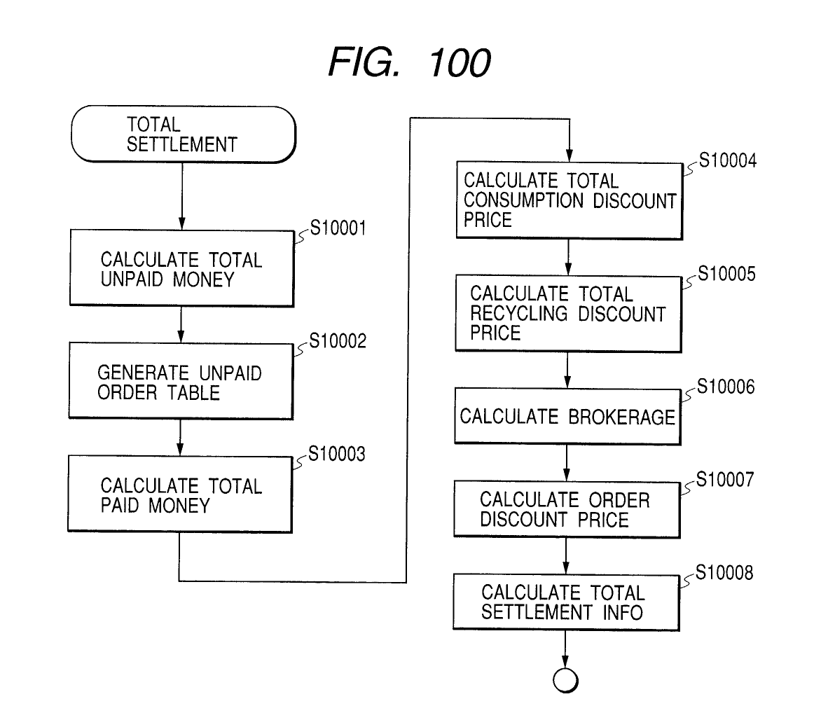

Besides, in the settlement information calculation processing at the side of mail order center, as shown in FIG. 100, first, processing that calculates the total of a money-not-received order table to which money-received confirmation information is not added to all the monthly received order tables registered in the order table database 148 by money-not-received total calculation processing (step S10001) and then processing that creates a list of money-not-received order tables by money-not-received order table list creation processing (step S10002). Subsequently, processing that calculates the total of the merchandise price of a money-received order table to which money-received confirmation information is added as the money-received total by money-received total calculation processing (step S10003) is performed. Then processing that calculates the total of the consumption discount price stored in the order table as the settlement information by consumption discount price total calculation processing (step S10004) at the side of the mail order center. Subsequently, processing that calculates the total of the recycling discount price recorded in the order table by recycling discount price total calculation processing (step S10005) at the mail order center is performed. Then processing that calculates the brokerage paid to the side of the equipment manufacturer in accordance with the number of orders as the settlement information by brokerage calculation processing (step S10006) at the side of the mail order center. Subsequently, processing that calculates the discount fee paid to the mail order center in accordance with the number of mediation items as the settlement information by received order discount calculation processing (step S10007) at the side of the mail order center is performed. Finally, settlement information total processing (step S10008) at the side of the mail order center that calculates the value in which a received order discount price is subtracted from the total of a consumption discount price, a recycling discount price, and order issue brokerage as settlement information total is executed. FIG. 100 is an operation flowchart of embodiment 13 of the consumable goods online shopping system according to the present invention.

According to the processing flow described above, in this embodiment, the mail order center sever can automate part of accounting processing by providing a function that calculates the settlement information of the transaction and the selling information generated between it and the equipment manufacturer on a settling day and can provide the mail order center for a profit advantage due to a reduction of personnel expenses.

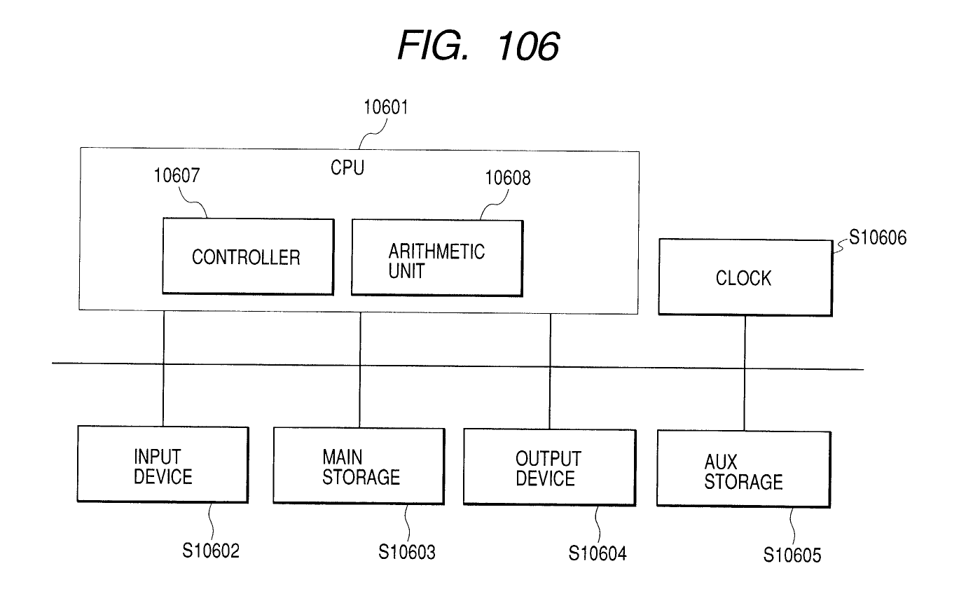

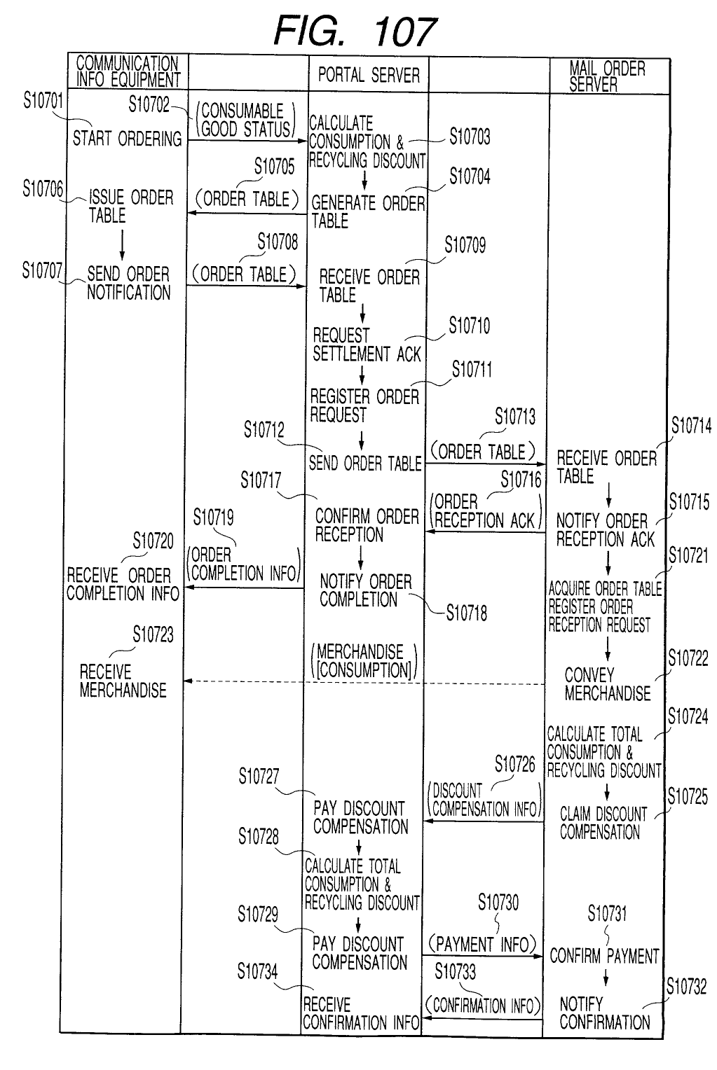

The further details of the processing described in FIG. 100 are described here using FIG. 107. In this case, each processing of FIG. 107 is realized by allowing the CPU (central processing unit) provided in the main body of the processing to execute the processing that is based on the program code stored in nonvolatile-related storing means that is connected to a local device or in a readable form from the local device. Further, each equipment configuration is the same configuration as the typical configuration of the information processor shown in FIG. 106 described later.

FIG. 107 is a drawing showing the processing of the transfer (sending and receiving) of various information regarding the consumable goods online shopping between the respective units of a personal computer or the communication information equipment that corresponds to a printing device having the function that is equivalent to the personal computer, a portal server, and a mail order server. In this case, the communication information equipment corresponds to the communication information equipment 110 of FIG. 1, the portal server corresponds to the portal server 120 of the equipment manufacturer 120 of the equipment manufacturer of FIG. 1, and the mail order center server corresponds to the mail order server 140 of FIG. 1. Further, the portal server is assumed to be a server installed by a manufacturer that manufactures a combined machine equipped with an ink jet type printer, an electrophotographic printer, a facsimile system, a copier, a printer function, and a scanner function. For the mail order center server, a description is given assuming such retail store having no IT assets that can perform centralized control of business machines via the Internet or the like, respectively. The portal server and the mail order server are not limited to this case. For example, the portal server may be acceptable if it is not only the manufacturer but also the person who is in the position to operate the server having the same function as the portal server.

First, in step S10701, the same order start processing as that described in the steps S6505 and S6603 of embodiment 4 and in FIG. 67 is performed by the communication information equipment and the consumable goods online shopping is started.

Next, in step S10702, the order start information including the discount information, such as the recycling discount information about the discount (consumption discount information) for the use of status of consumable goods and the discount for the cooperation of user recycling, is sent from the communication information equipment to the portal server via a predetermined communication line, such as the Internet.

In the portal server, in the step S10702, the sent order start information is received and in step S10703, a consumption discount fee is calculated as the point of the use of status of the consumable goods by recycling discount fee calculation processing (step S7202) described in embodiment 6. In step S10703, by the recycling discount fee calculation processing (step S7203) of embodiment 6, a recycling recovery point is acquired based on the owner information in the order start information and processing that calculates a recycling discount fee that matches the recovery point is executed.

In step S10704, an order table is created based on the discount fee that is based on such calculated point and in step S10705, processing that sends the created order table to the communication information equipment is executed by the order table sending processing (step S7005) described in embodiment 6.

On the other hand, in the communication information equipment that receives the information of this order table, the order table order issue processing (step S7304) of embodiment 6 executed in step S10706 is executed and necessary data input is performed. Subsequently, in steps S10707 and S10708, processing that sends the order table to which the necessary data is input to the portal server by the order issue notification sending processing (step S7405) of embodiment 6 is executed in accordance with an order issue instruction.

At the side of the portal server, in step S10709, the sent order table is received based on the processing of the information processing means 121 of the portal server described in embodiment 9 and in step S10710, the electronic settlement acknowledgment request processing (step S8104) is performed. This result is received and in step S10711, the order issue request mediation processing (step 8105) of embodiment 9 is performed. In the order issue request mediation processing, processing that registers the order table of an order of which the order issue request is received in the mail order center registration information database is performed in the order issue request registration processing (step S8202) and subsequently, in step S10712, processing (step S10713) that sends the order table of which the order issue request is received to the mail order center is performed by the order issue request order table sending processing (step S8203).

In the mail order center server, based on the information processing 141 of the mail order center server described in embodiment 9, the sent order table is received (step S10714) and the received order processing of embodiment 9 is performed. In the received order processing, in step S18015, the processing (step S10716) that sends a received order acknowledgment notification to the portal server is performed by the received order acknowledgment notification sending processing (step S8801). Subsequently, in step S10721, the order table of which the received order is given is acquired by the order table acquisition processing (step S8803) and processing (step S10721) that registers the acquired order table in the order table database is performed by the received order request registration processing (step S8804).

At the side of the portal server, the received order acknowledgment notification sent from the side of the mail order server is received (step S10716) and received order confirmation is performed (step S10717). Processing that sends a received order completion notification to the communication information equipment is performed (step S18019) according to the received order completion notification (step S8106) of embodiment 9.

Then in the communication information equipment, received order completion information (step S10719) sent from the portal server is received by the received order completion information receiving processing of step S10720 and the received order completion of an order issue of which the order issue is given can be confirmed.

On the other hand, regarding the forwarding order procedure of merchandise, in merchandise conveyance procedure processing (step S10722) of the mail order center server, an order table stored in the order database is acquired according to the conveyance procedure (step S9204) of embodiment 11 and the conveyance procedure of merchandise (consumable goods) is performed based on the contents of this acquired order table, and then the forwarding of merchandise is performed toward the user (owner of communication information equipment). The merchandise forwarded in this manner is delivered to the user and reception of merchandise is performed (step S10723).

By repeating the processing flow described above, the consumable goods online shopping is continuously enabled.

Further, the payment procedure for the point compensation (consumption discount or recycling discount) that matches the use of status of the consumable goods that are accumulated while the consumable goods online shopping described above is repetitively being repeated and paid from a manufacturer (portal server) to a retail store (mail order center server) is performed according to the following processing flow.

First, at the side of the mail order center server, the total of the discount amount of an order table of which the order issue is given within the period in the order table base is calculated (step S10724) periodically (for example on a monthly settling day) and processing that sends the calculated result to the side of the portal server as reduced compensation claim information is performed (step S10725) using the discount price total calculation processing (step 10004) at the side of the mail order center of embodiment 13 and the recycling discount price total calculation processing (step S10005) at the side of the mail order center.

At the side of the portal server, the discount compensation claim information is received (step S10726) and the discount compensation payment procedure processing of step S10727 is performed. Processing that calculates the total of the discount of an order table of which the received order is given within the period for the mail order center server of which the claim is received in the mail order center registration information database is performed using the consumption discount price total calculation processing (step S9101) at the side of the manufacturer of embodiment 10 and the recycling discount price total calculation processing (step S9102) at the side of the manufacturer, as shown in step S10728. Then when it is confirmed that the calculated discount total amount and the discount total amount in the received discount compensation claim information are compared and the result matches, the payment to the claimed discount compensation is performed and the processing that sends (step S10730) it to the mail order center server as discount compensation payment information is performed. Hereupon, in the processing of step S10730, the mail order center server receives the discount compensation payment information and confirms a discount compensation payment condition in step S10731. If the payment condition can be confirmed, processing that reports the acceptance confirmation information of step S10733 to the side of the portal server according to the acceptance confirmation notification of step S10732 and at the side of the portal side, it can be confirmed that the compensation payment procedure is completed by receiving this acceptance confirmation information (step S10734).

Besides, the user's owner information sent from the communication information equipment to the side of the portal server is executed by the owner information registration processing of embodiment 2.

Further, the number of recovery cartridges acquired when the recycling discount of embodiment 6 is stored in the mail address database in the portal server by the recovery cartridge registration processing of embodiment 14 and can be referred to.

In the 13th embodiment, a second consumable goods trader who is a retail store can use the server having the IT function that a first consumable goods trader who handles the consumable goods of a manufacturer and can control the status of use of the consumable goods, and the second consumable goods trader can provide the user for the consumable goods at a reduced price that matches the status of use of the consumable goods used in a printing device that is controlled using the server function.

Further, the user can purchase the merchandise that the second consumable goods trader, such as a retail store, offers from his or her terminal device via a predetermined Internet purchase screen at a discount price based on the point that is described when it is controlled by the portal server. On the other hand, since the second consumable goods trader can receive a cash back or predetermined incentive that matches the discount amount when he or she makes a reduction to the customer using the service the portal server offers, sales promotion can easily be executed regarding the sales of the consumable goods.

Further, as a further form, the portal server comprises control means that associates and stores the user and the predetermined consumable goods trader (or the second consumable goods trader), and such form that associates the applicable condition of the service for each customer with the predetermined consumable trader and controls it is assumed. It is assumed that the portal server decides the compensation (cash back or predetermined incentive) of each consumable goods trader in accordance with the utilization condition of the service against the sales for each predetermined consumable goods trader controlled by the control means. Besides, this status of use, as described above, can correspond to the recovery condition of consumable goods or the amount of the consumable goods used.

Thus, in the present invention, not only online shopping is constructed but also a mechanism that is advantageous for the portal server, mail order center server, and user respectively can be offered. For example, the portal server can advance the sales promotion of a retail store against the retail store by using the mechanism of the discount that matches the consumption amount of the consumable goods. In particular, when the supplier of the portal server is a manufacturer that manufactures the consumable goods, an appeal for products of its own company is facilitated to the retail store.

Further, as for the retail store, since the retail store can receive the compensation that matches a discount service applied to the user from the portal server, the discount service can easily be applied to the user.

Further, as for the user, since such condition in which various services could not be received from extremely a part of sales stores having the conventional IT assets changes and the user can receive discount services even in various retail stores, the selection range of the retail store increases and the condition becomes more convenient.

(Embodiment 14)

The embodiment 14 of the consumable goods online shopping system according to the present invention is described below with reference to the drawings.

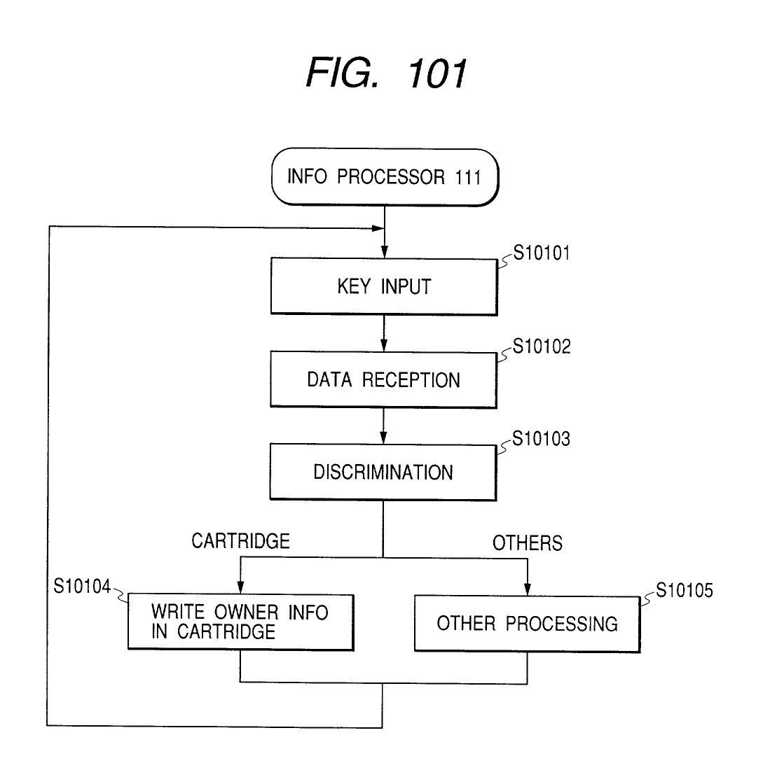

In this embodiment 14, regarding the processing in the recovery cartridge registration processing of embodiment 1, in the information processing means 111 of the communication information equipment, as shown in FIG. 101, when the consumable goods are of a cartridge type and there is the area in which owner information is recorded at the side of the cartridge after key input, data receiving, and discrimination processing instructions (steps S10101, 10102, and 10103), owner information cartridge write processing (step S10104) that stores owner information even in the storage area at the side of the cartridge is performed together with another necessary processing (step S10105). FIG. 101 is an operation flowchart of embodiment 14 of the consumable goods online shopping system according to the present invention.

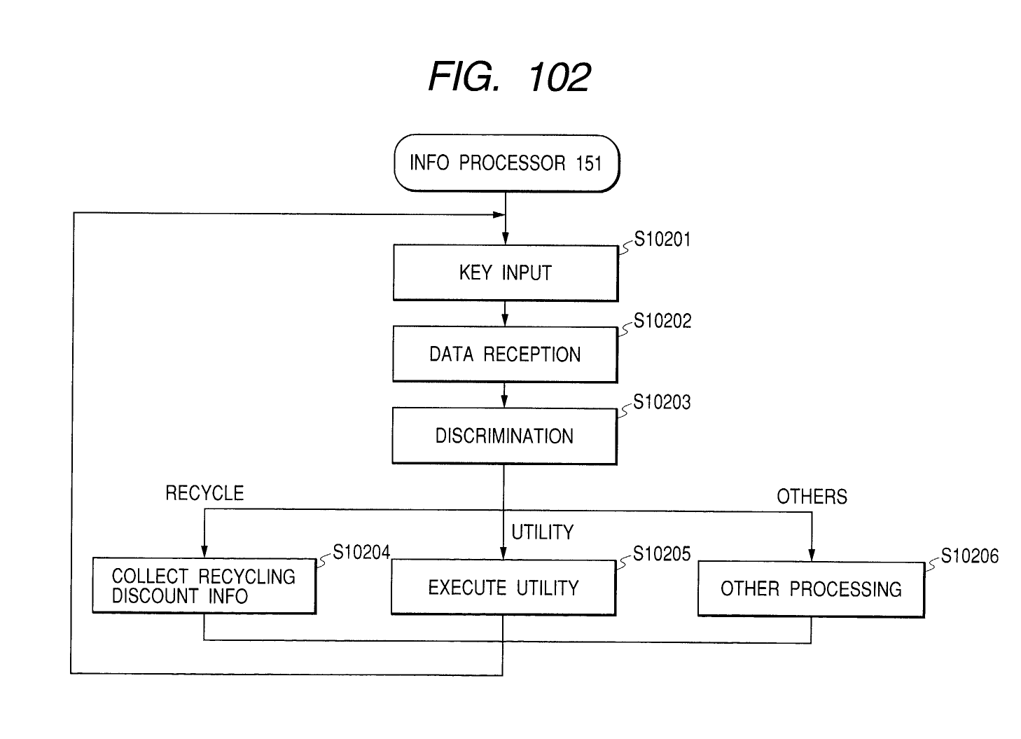

On the other hand, in the information processing means 151 of the consumable goods recycling center server, as shown in FIG. 102, when a recycling discount information collection instruction is given according to the input instruction of the server administrator after key input, data receiving, and discrimination processing instructions (steps S10201, 10202, and 10203), recycling discount information collection processing (step S10204) is executed together with another necessary processing (step S10206). When a utility execution instruction is given, utility execution processing (step S10205) is executed. FIG. 102 is an operation flowchart of embodiment 14 of the consumable goods online shopping system according to the present invention.

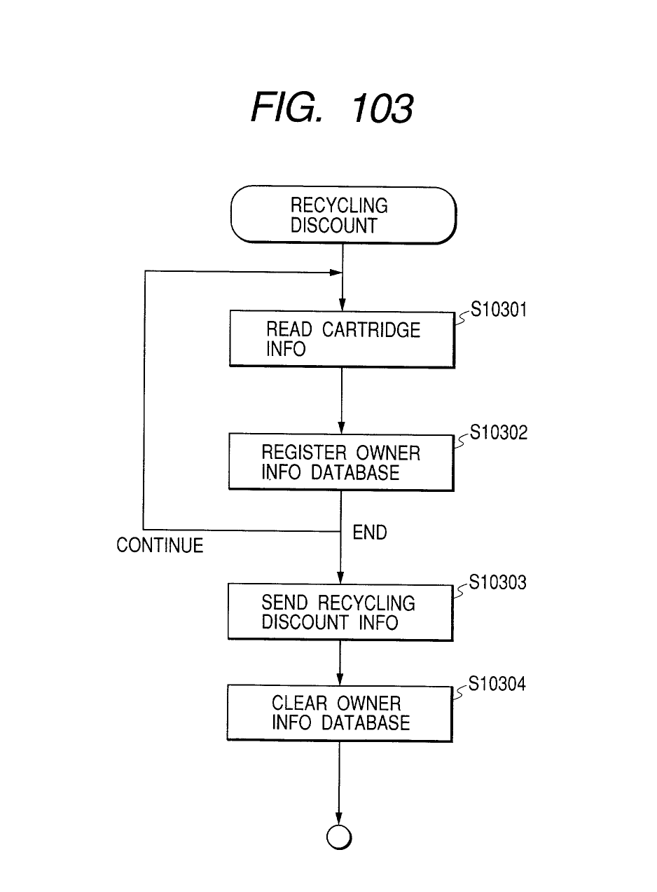

In the recycling discount information collection processing, as shown in FIG. 103, cartridge owner information reading processing (step S10301) that reads the owner information stored in the storage area of the recovered cartridge and owner information management database registration processing (step S10302) that acquires mail address information from the read owner information and registers it in the owner information management database 157 are repetitively repeated by the cartridge information reader 156 until the read processing by the reader is terminated. Then, after the read processing is terminated, the mail address information and recovery cartridge information (for example, the number of recovered cartridges controlled for each user) stored in the owner information management database 157 as recycling discount information is sent to the portal server 120 of the equipment manufacturer by recycling discount information sending processing (step S10303). After the sending processing is performed by the recycling discount information sending processing, processing that clears the sent mail address information and recovery cartridge information in the owner information management database 157 from the owner information management database is executed by owner information management database clearing processing (step S10304). FIG. 103 is an operation flowchart of embodiment 14 of the consumable goods online shopping system according to the present invention.

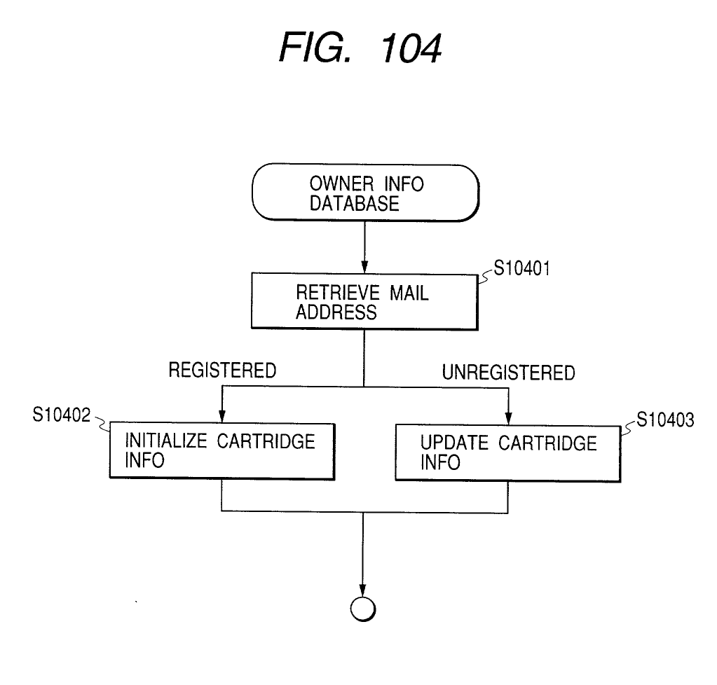

In the owner information management database registration processing, as shown in FIG. 104, the owner information management database 157 is retrieved by mail address retrieval processing (step S10401) based on the mail address information in the owner information read by the cartridge owner information read processing. When a mail address is not registered, recovery cartridge information initialization processing (step S10402) that sets recovery cartridge information to 1 and registers it in the owner information management database 157 together with the mail address information. When the mail address is registered, processing that performs recovery cartridge information update processing (step S10403) that increments (counts up) and updates the recovery cartridge information in the database is executed. FIG. 104 is an operation flowchart of embodiment 14 of the consumable goods online shopping system according to the present invention.

Besides, in the utility execution processing, processing that displays, prints, and deletes the contents of owner information management database is executed according to the instruction of the server administrator.

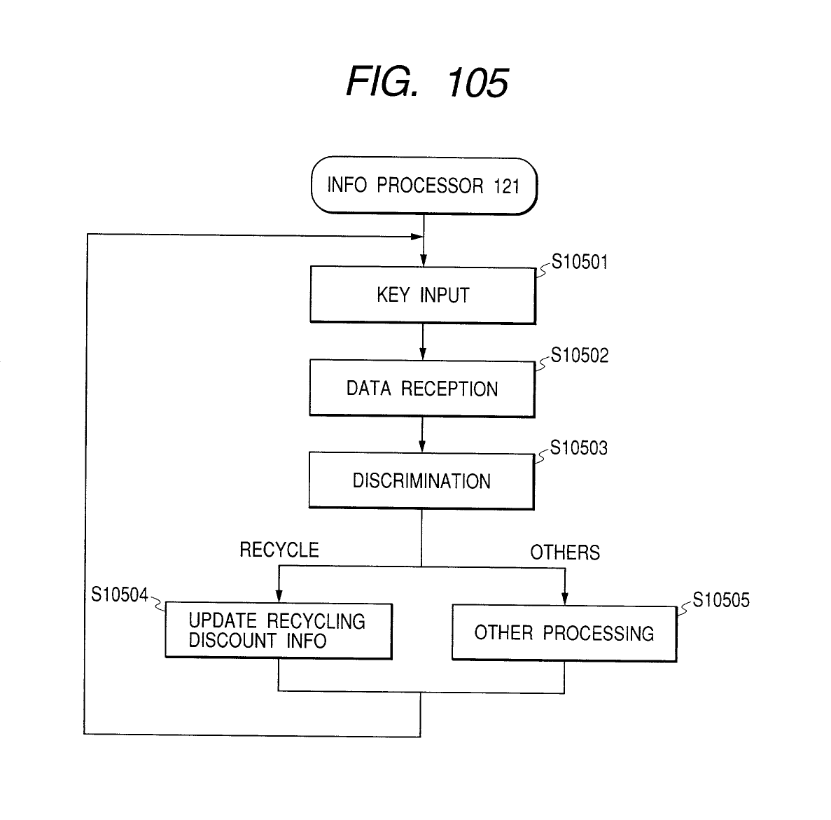

Further, in the information processing means 121 of the portal server of the equipment manufacturer, as shown in FIG. 105, after key input, data receiving, and discrimination processing instructions (steps S10501, 10502, and 10503), the recycle discount information consisting of mail address information and recovery cartridge information sent by the recycling discount information sending processing is received and recycling discount information update processing (step S10504) is executed. FIG. 105 is an operation flowchart of embodiment 14 of the consumable goods online shopping system according to the present invention.

In the recycling discount information update processing, processing that retrieves the mail address database 126 based the received mail address information and adds the received recovery cartridge information to the recovery cartridge information that corresponds to matching mail address information and deletes it is executed.

Thus, a recycling discount price can be calculated in accordance with the number of cartridges in which the recovery cartridge information recorded in the mail address database 126 is referred to and recovered in the recycling discount calculation processing described in embodiment 6.

According to the processing flow described above, when a system that includes the recycling use of consumable goods is constructed as a business model, a consumable goods recovery path is established, and the recycling processing of the cartridge recovered in a recycling plant is performed, the system can purchase the consumable goods against the order from the specified owner user in accordance with a recycling discount providing the function for recording equipment owner information in the cartridge of the consumable goods in the communication information equipment, acquiring the owner information recorded in the recovered cartridge in the recycling plant, sending the acquired information and the number of recovery cartridges to the portal server of the equipment manufacturer, specifying an owner user of the equipment manufacturer in the portal server of the equipment manufacturer. A price advantage can be offered to the owner user of the recovery cartridge and an environmental advantage can be offered to the earth.

(Embodiment 15)

The embodiment 15 of the consumable goods online shopping system according to the present invention is described below.

In this embodiment 15, the communication information equipment 110 described in the embodiment has the configuration in which electronic equipment A having the function that performs the consumption execution and the remaining quantity detection of consumable goods and electronic equipment B having the function that performs processing required for performing online shopping offered by the present invention. The electronic equipment A executes each processing of the printing processing, consumable goods consumption execution processing, consumable goods remaining quantity detection processing, and electronic equipment connection processing that performs the connection of the equipment in order to perform the transfer of necessary information between it and the electronic equipment B described in the communication information equipment 110, and the electronic equipment B executes each processing of the information processing, screen display processing, key input/pointing processing, communication processing, and the electronic equipment connection processing that performs the connection of the equipment in order to perform the transfer of the necessary information between it and the electronic equipment A. According, all the embodiments can be executed according to the connection forms of the electronic equipment and the electronic equipment B.

According to the configuration of the processing described above, in this embodiment, the communication information equipment can obtain the quite same effect even for the replacement according to the configuration of the equipment in which the electronic equipment having the communication function through the network and the electronic equipment that consumes consumable goods, for example, like a printer connected to a computer, the configuration of the equipment in which the printer information can be handled by the computer including the configuration in which the consumption of the consumable goods is performed in the communication information equipment.

The internal configuration of the communication information equipment 110 that consumes consumable goods, the portal server to which data is sent from the communication information equipment 110, the electronic settlement server 130 that the settlement of the transaction performed in the communication information equipment 110, the mail order center server 140 for mail-ordering the consumable goods, the recycling plant server 150 installed in the merchandise control center of the consumable goods, and the merchandise control center server 160 that interconnect via the network 100 is described here with reference to FIG. 106. FIG. 106 is an internal block diagram of the communication information equipment used in each embodiment of the consumable goods online shopping system according to the present invention, and shows a typical configuration of an information processor.

Further, except the communication information equipment 110, the internal configuration of the portal server 120 to which data is sent from the communication information equipment 110, the electronic settlement server 130 that performs the settlement of the transaction performed in the communication information equipment 110, the mail order center server 140 for mail-ordering consumable goods, the recycling plant server 150 installed in the recycling plant of the consumable goods, and the merchandise control center server 160 installed in the merchandise control center of the consumable goods has the same configuration as the case where it is described with reference to FIG. 106.

As shown in FIG. 106, the communication information equipment 110 comprises a CPU (central processing unit) 10601, an input device 10602, a main storage unit 10603, an output device 10604, an auxiliary storage unit 10605, and a clock device 10606.

The CPU 10601 is a component considered as an alias processor and comprises an arithmetic unit 10608 that performs the operation processing of digital data at the central part of the communication information equipment 110 and a controller 10607 that sends an instruction to the arithmetic unit 10608 and each device in a system and controls the operation.

The controller 10607 reads the data input from the input device 10602 and a previously assigned procedure (for example, program and software) in the main storage unit 10603 in accordance with the timing of a clock the clock device 10606 issues, and sends an instruction to the arithmetic unit 10608 based on these read contents and makes it perform operation processing. The result of this operation processing is sent to internal equipment and external equipment, such as the main storage unit 10603, the output device 10604, and the auxiliary storage unit 10605 based on the control of the controller 10607.

The input device 10602 is a component for inputting various data, and for example, a keyboard, a mouse, a pointing device, a touch panel, a mouse pad, a CCD camera, a card reader, a paper tape reader, and a magnetic tape unit are considered.

The main storage unit 10603 is a component considered as an alias memory, and in the processor and the internal storage unit, this component indicates all of the addressable storage space used for executing an instruction. This main storage unit 10603 mainly consists of semiconductor memory elements. It stores and holds the input program and data and reads this stored and held data to a register, for example, in accordance with the instruction of the controller 10607.

Further, the semiconductor memory elements that form the main storage unit 10603 consist of a RAM (random access memory) and a ROM (read only memory).

The output device 10604 is a component for outputting an operation result of the arithmetic unit 10608, and for example, the component corresponds to a CRT, a plasma display panel, a liquid crystal display, other display devices, a printing device, such as a printer, and an audio output device.

Further, the auxiliary storage unit 10605 is a component for compensating the storage capacity of the main storage unit 10603, and for example, the component corresponds to a floppy disk, a hard disk, a CD-ROM, a CD-R, CD-W, and a MO in a magnetic disk drive, an optical disk unit, and a semiconductor disk unit.

Besides, the various programs that make the communication information equipment 110 that consumes the consumable goods of this embodiment, the portal server 120 to which data is sent from the communication information equipment 110, the electronic settlement server 130 that performs the settlement of the transaction performed in the communication information equipment 110, the mail order center server 140 for mail-ordering the consumable goods, the recycling plant server 150 installed in the recycling plant of the consumable goods, and the merchandise control center server 160 installed in the merchandise control center of the consumable goods execute processing are stored (recorded) in at least either the main storage unit 10603 or the auxiliary storage unit 10605.

Further, the number of the main storage units 10603 and the auxiliary main units 10605 is not limited to one each, but may be optional. As the number of these main storage units 10603 and auxiliary storage units 10605 increases, the fault resistance of the communication information equipment 110 will be improved.

Accordingly, the recording medium that records the program for making the communication information equipment and each server execute processing corresponds to at least either the main storage unit 10603 or the auxiliary storage unit 10605.

### EFFECT OF THE INVENTION

As described above, according to the present invention, a mechanism that centralizes all processing flows in online shopping, for example, in accordance of the processing flow of each embodiment, and realizes an online shopping system that is advantageous for each of users, portal server providers, mail order server administrators in the online shopping can be offered.

What is claimed is:

1. A consumable goods online shopping system that comprises communication information equipment that consumes consumable goods, a portal server to which data is sent from said communication information equipment, an electronic settlement server that performs the settlement of the transaction performed in said communication information equipment, a mail order center server for mail-ordering the consumable goods, a recycling plant server installed in a recycling plant of the consumable goods, and a merchandise control center server installed in a merchandise control center of the consumable goods that interconnect via a network, comprising:
said communication information equipment including,
first information processing means that performs processing of various information in the communication information equipment, first screen display means that displays information-processed information on the screen, first input means that inputs information necessary for information processing, first printing means that prints information-processed contents, first communicating means that communicates the information-processed contents via the network, first consumable goods consumption executing means that executes processing which consumes the consumable goods, and first consumable goods remaining quantity detecting means that detects a remaining quantity of the consumable goods,
said portal server including,
second information processing means that performs the processing of various information in the portal server, second display means that displays the information-processed information on the screen, second input means that inputs the information necessary for information processing, second printing means that displays the information-processed information on the screen, a second mail order address database in which a mail address and recovery cartridge information of the communication information equipment connected to the portal server are stored, a second delivery store database in which delivery stores of the consumable goods are stored, a second mail order center registration information database in which the information of a mail order center that is connected to the portal server and in which an order issue of the consumable goods is given, and a second consumable goods price database in which individual merchandise price information is stored for each mail order center,
said electronic settlement server including,
third information processing means that performs an electronic settlement based on authentication information input from the first input means on said communication processing equipment, third screen display means that displays the information-processed information, third input means that inputs the information necessary for information processing, third printing means prints the information-processed contents, third communicating means for communicating the information necessary for performing the electronic settlement, and a third electronic settlement database in which the data necessary for performing the electronic settlement is stored,
said mail order center server including,
fourth information processing means that performs the processing of various information in the mail order center server, fourth screen display means that displays the information-processed information on the screen, fourth input means that inputs the information necessary for information processing, fourth printing means that prints the information-processed contents, fourth communicating means that communicates the information-processed contents via the network, a fourth merchandise database in which the data of the merchandise necessary for receiving the mail order including the price and the stock quantity of the consumable goods controlled in the mail order center, a fourth customer management database in which the customer information of the customer of which the order request is given, and a fourth order table database for storing the order table to which an order is given,
said recycling plant server including,
fifth information processing means that performs the processing of various information in the recycling plant server, fifth screen means that displays the information-processed information on the screen, fifth input means that inputs the information necessary for information processing, fifth printing means that prints the information-processed contents, fifth communicating means that communicates the information-processed contents via the network, a fifth cartridge information reader that reads the owner information stored in the storage area of the cartridge recovered in the recycling plant, and a fifth owner information management database in which the number of recovery cartridges and the owner information are linked and stored; and
said merchandise control center server including,
sixth information processing means that performs the processing of various information in the merchandise control center server, sixth screen display means that displays the information-processed information on the screen, sixth input means that inputs the information necessary for the information processing, sixth printing means that prints the information-processed contents, fifth communicating means that communicates the information-processed contents via the network, and a sixth merchandise inventory control database in which the merchandise inventory control information of the consumable goods is recorded.

2. The portal server to which data is sent from said communication information equipment connected to the communication information equipment that consumes the consumable goods, the electronic settlement server that performs the settlement of the transaction performed in said communication information equipment, the mail order center server for mail-ordering the consumable goods, the recycling plant server installed in the recycling plant of the consumable goods, and the merchandise control center server installed in the merchandise control center of the consumable goods via the network, further comprising:
information processing means that performs the processing of various information in the portal server;
screen display means that displays the information-processed information;
input means that inputs the information necessary for information processing;
communicating means that communicates the information-processed contents via the network;
a mail address database in which the mail address and recovery cartridge information of the communication information equipment connected to the portal server are stored;
a delivery store database in which delivery stores of the consumable goods are stored for each area;
a mail order center registration information database in which the information of the mail order center that is connected to the portal server and in which the order issue of the consumable goods is given; and
a consumable goods price database in which the individual merchandise price information is stored for each mail order center.

3. The portal server according to claim 2, wherein said information processing means comprises:
mail address notification means that receives a mail address acquisition request issued by mail address automatic registering means of the communication information equipment, retrieves said mail address database, allocates and reports an unregistered empty mail address as the mail address of the communication information equipment to which a request is given; and
automatic mail address allocation means that automatically allocates the empty mail address for the allocation of the mail address; and
empty mail address retrieving means for supporting allocation by a portal server administrator.

4. The portal server according to claim 3, wherein said information processing means comprises:
mail order center information registering means that registers the information about an order issue destination of the order table in a mail order center registration database,
consumable goods price data registering means that receives the price information and stock information of the consumable goods merchandise that are periodically sent from said consumable goods mail order center server stored in a second mail order center registration database; and
price information sorting means that sorts the price information for each area genre-classified for each consumable goods merchandise in the price order and associates and stores the price information and a mail order center name at the update of said consumable goods price database.

5. The portal server according to claim 4, wherein said information processing means comprises:
order start information acquiring means that receives order start information sent from the side of the communication information equipment and acquires the order start information; and
consumption discount calculating means that calculates a discount which matches a consumption amount of the consumable goods in the acquired order start information.

6. The portal server according to claim 5, wherein said information processing means comprises:
order table creating means that creates an order table based on the order start information acquired by said order start information acquiring means; and
order table sending means that sends the created order table to said communication equipment,
said order table creating means including,
price information portion creating means that creates a price information portion of the order table;
delivery information creating means that creates a delivery information portion of the order table;
electronic settlement information portion creating means that creates an electronic settlement information portion of the order table; and
order issue portion creating means that creates an order issue portion of the order table,
said price information portion creating means including,
price information acquiring means that retrieves the second consumption goods price database based on machine type information in the order start information and acquires the price information and stock information of the consumable goods that match the machine type information;
said consumption amount discount calculating means that calculates discount information which matches the consumption amount of the consumable goods; and
recycling discount calculating means that acquires the number of recovery cartridges stored the second mail address database and calculates the discount information which matches the number of recovery cartridges, and
said information processing means
creates the price information portion for each mail order center according to the price information, stock information, consumption amount discount information, recycling discount information, and the number of orders setting area obtained by each of the processing, acquires the price information acquired by the price information acquiring means in the sequence sorted in the price order on the consumable goods database, creates the price information portion sorted in the state according to the price, and creates the price information portion of the order table in which priority is given to the specified mail order center when there is specification in the connection information to said mail order center server in the order start information,
said delivery information portion creating means including,
delivery method specification area creating means that creates a specification area which can specify a delivery method including at least any one of mailing, conveyance, and store-based delivery as the specification of the delivery method;
destination information specification area creating means that creates a destination information store specification area necessary for the mailing and conveyance; and
delivery store specification creating means that creates a deliver store specification area necessary for the stored-based delivery,
the specification area obtained by each of said means is created as the delivery information portion,
at creation of said destination information specification area, at least one of a postal number, an address, a name, and a telephone number written to the owner information in the order start information is set a fault value,
at the creation of said delivery store specification area, by store information default setting means, a delivery area is specified from the postal number, address, and telephone number, a second delivery store database is retrieved from specified regional information, and a store that is doing business in the delivery area is set so that it can preferentially specified as a default,
regarding the second delivery store database, the latest data is always updated and registered by the control of the portal server administrator,
said electronic settlement information portion creating means comprises authentication data input area creating means that creates an area to which authentication data is input required for performing the electronic settlement in said electronic settlement server and creates the authentication data input area created by the authentication data input area creating means,
the order issue portion creating means including,
order issue specification area creating means that creates the area in which the activation of a mail order issue instruction can be specified, and
coupon ticket issuing specification area creating means that creates an area in which the activation of a coupon ticket issuing specification area can be specified, and
the specification area created by said coupon ticket issuing specification area creating means is created as an order issue portion.

7. The portal server according to claim 6, wherein said information processing means comprises:
coupon ticket issuing notification receiving means that receives the sent coupon ticket issuing notification;
coupon packet issuing processing means that receives the coupon ticket issuing and the order table and performs the ticket issuing of the coupon information based on the consumption discount information and the recycling discount information provided in the price information portion of the order table; and
coupon information sending means that sends the ticket-issued coupon information to the communication information equipment.

8. The portal server according to claim 7, wherein said information processing means comprises:
back margin registering means at the side of the manufacturer that registers the information about the brokerage and discount fee that match the handing amount decided according to the arrangement with each mail order center by the data input of the portal server administrator;
order issue notification receiving means that receives a received order notification from the communication information equipment;
electronic settlement acknowledgment requesting means that receives the received order notification, creates acknowledgment information based on the authentication data input to the order table, sends it to said electronic settlement server, and performs an electronic settlement acknowledgment request for order issue merchandise to the specified mail order center;
order issue request mediation means that receives acknowledgment result notification information from said electronic settlement server and performs mediation to the mail order center server;
received order acknowledgment notification receiving means that receives a received order acknowledgment notification from the mail order center server; and
received order completion notification sending means that receives the received order acknowledgment notification and issues an order issue completion notification to the communication information equipment,
said received order request mediation means including,
number of mediation items counting means that counts the number of mediation items for each mail order center when the electronic settlement is acknowledged according to the acknowledgment notification information from said electronic settlement server;
order issue request registering means that registers the number of orders counted by the number of mediation items counting means in the second mail order registration information database for each mail order center together with the order table of the order of which the order issue request is received;
order issue request order table sending means that sends the order table of which the order request is received to the mail order center; and
electronic settlement not-acknowledged notification means that sends an electronic settlement not-acknowledged notification to said first communication information equipment when the electronic settlement is not acknowledged, and
the information processing means of said portal server including,
brokerage calculating means at the side of the manufacturer that calculates the brokerage paid to the side of the mail order center side in accordance with the number of orders that is counted by said number of mediation items counting means and registered in the mail order registration information database by said order issue request registering means; and
order issue discount calculating means that calculates the discount paid to the mail order center in accordance with the number of mediation items.

9. The portal server according to claim 8, wherein the information processing means of said portal server comprises:
settlement information calculating means at the side of the manufacturer that calculates monthly settlement information for each mail order center at a monthly settling day or according to the instruction of the server administrator;
settlement information sending means at the side of the manufacturer that send the calculated settlement information to each mail order center;
settlement information backup means at the side of the manufacturer that backs up all of the settlement information total, settlement information, and order table handled within a settling month to the backup area in said second mail order center registration information database;
settlement information clearing means at the side of the manufacturer that clears the number of orders issued within a predetermined period and an issued table order when the settlement information is backed up by said settlement information backup means at the side of the manufacturer; and
settlement information utility means at the side of the manufacturer that prints and deletes the information backed up in the backup area according to the instruction of the portal server administrator, and
said settlement information calculating means at the side of the manufacturer including:
consumption discount price total calculating means at the side of the manufacture that calculates the total of the consumption discount price recorded in the order table as the settlement information for all the order table tables of the mail order center specified in said mail order center registration information database;
recycling discount price total calculating means at the side of the manufacturer that calculates the total of the recycling discount price recorded in the order table as the settlement information;
said brokerage calculating means that calculates the brokerage paid from the side of the mail order center in accordance with the number of orders as the settlement information;
said order issue discount calculating means at the side of the manufacturer that calculates the discount fee paid to the mail order center in accordance with the number of mediation items as the settlement information; and
settlement information total calculating means at the side of the manufacturer that calculates the value in which the order issue discount price is subtracted from the total of the consumption discount price, recycling discount price, and order issue discount as the settlement information total.

10. The portal server according to claim 9, wherein said information processing means comprises:
stored merchandise order issue receiving means that receives the stored merchandise order issue of which the order issue is given by said stored merchandise order issue means; and
stored merchandise order issue mediation means that mediates the order issue of the stocked merchandise of which the received order is given and sends the order table to the merchandise control center server of the consumable goods.

11. The electronic settlement server that performs the settlement of the transaction performed in said communication information equipment that is connected to the communication information equipment that consumes the consumable goods, the portal server to which data is sent from said communication information equipment, the mail order center server for mail-ordering the consumable goods, the recycling plant server installed in the recycling plant of the consumable goods, and the merchandise control center server installed in the merchandise control center of the consumable goods via the network, comprising:
information processing means that performs the electronic settlement based on the authentication information input from the input means on said communication information equipment;
screen display means that displays the information-processed information; input means that inputs the information necessary for information processing;
printing means that prints the information-processed information;
communicating means for communicating the information for performing the electronic settlement; and
electronic settlement data base in which the data required for performing the electronic settlement is stored.

12. The mail order center server for mail-ordering the consumable goods that is connected to the communication information equipment, the portal server to which data is sent from said communication information equipment, the electronic settlement server that performs the settlement of the transaction performed in said communication information equipment, the recycling plant server installed in the recycling plant of the consumable goods, and the merchandise control center server installed in the merchandise control center of the consumable goods through the network, comprising:
information processing means that performs the processing of various information in the mail order center server;
screen display means that displays the information-processed information on the screen;
the input means that inputs the information necessary for information processing;
the printing means that prints the information-processed contents;
the communicating means that communicates the information-processed contents;
the merchandise database in which the data of the merchandise necessary for receiving the mail order including the price and the stock quantity of the consumable controlled in the mail order center;
the customer management database in which the customer information of the customer in which the order request is given; and
the fourth order table database for storing the order table to which the order is given.

13. The recycling plant server installed in the recycling plant of the consumable goods that is connected to the communication information equipment that consumes the consumable goods, the portal server to which data is sent from said communication information equipment, the electronic settlement server that performs the settlement of the transaction performed in said communication information equipment, the mail order center server for mail-ordering the consumable goods, and the merchandise control center server installed in the merchandise control center of the consumable goods, comprising:
the information processing means that performs the processing of various information in the recycling plant server;
the screen display means that displays the information-processed information;
the input means that inputs the information necessary for information processing;
the communicating means that communicates the information-processed contents via the network;
the cartridge information reader that reads the owner information stored in the storage area of the cartridge recovered to the recycling plant; and
the owner information management database in which the number of cartridges and the owner information are linked and stored.

14. The recycling plant server according to claim 13, wherein said communication information equipment comprises:
cartridge owner information reading means that reads the owner information stored in the storage memory of the recovered cartridge;
owner information management database registering means that acquires the mail address information from the read owner information and registers it in said owner information management database;
recycling discount information sending means that periodically sends the mail address information and the recovery cartridge information registered in the owner information management database to the portal server of the equipment manufacturer as the recycling discount information;
owner information management database clearing means that clears the sent mail address information and the recovery cartridge information in said owner information management database from the owner information management database after the sending processing is performed by said recycling discount information sending means; and
owner information management database utility means that displays, prints, and deletes the contents in the owner information management database according to the instruction of the server administrator;
said owner information management database utility means including,
recovery cartridge information initialization means that sets the recover cartridge information to 1 and registers it in said fifth owner information management database together with the mail address information when the mail address information in the owner information read by said cartridge owner information reading means is not registered in said owner information management database; and
recovery cartridge information update means that increments (counts up) the recovery cartridge information in the database when the mail address information is not registered in said owner information management database.

15. The server that controls status of use of said consumable goods the first consumable goods trader who handles the consumable goods, further comprising:
calculating means that receives the status of use of the consumable goods used in a printing device via a predetermined communication line and calculates a point against a customer in accordance with the received status of use; and
compensation deciding means that decides compensation that is based on a reduced price, paid to said second consumable goods trader in accordance with the fact that said customer purchases the merchandise the second consumable goods trader offers at said reduced price that is based on said point via a predetermined purchase screen.

16. The server according to claim 15, further comprising:
registering means that registers a price list the second consumable goods trader offers in an acceptance storage portion via said predetermined line;
distributing means that distributes the price information registered by said registering means to a communicable terminal unit via said predetermined communication line; and
calculating means that calculates the discount price that matches the price information distributed by said distributing means and the point calculated by said calculating means.

17. The server according to claim 16, wherein said control means comprises control means said customer and said consumable goods trader are associated and stored, controls the applicable condition of said service for each of said customer as the utility condition of the service for each of said consumable goods trader, and said deciding means decides said compensation in accordance with the utilization condition of the service for each said consumable goods trader by said control means.

18. The server according to claim 15, wherein said status of use is the recovery condition of said consumable goods or the amount of said consumable goods used.

19. A consumable goods online shopping method applied to the consumable goods online shopping system that comprises communication information equipment that consumes consumable goods, the portal server to which data is sent from said communication information equipment, the electronic settlement server that performs the settlement of the transaction performed in said communication information equipment, the mail order center server for mail-ordering the consumable goods, the recycling plant server installed in the recycling plant of the consumable goods, and the merchandise control center server installed in the merchandise control center of the consumable goods that interconnect via the network, comprising:
the first information processing step that performs the processing of various information in the communication information equipment, the first screen display step that displays information-processed information on the screen, the first key input/pointing step that inputs the information necessary for information processing with a key/by a pointing device on the screen, the first printing step that prints information-processed information, the first communication step that communicates the information-processed contents via the network, the first consumable goods consumption execution step that executes the processing which consumes the consumable goods, the first consumable goods remaining quantity detection step that detects the remaining quantity of the consumable goods, in said communication information equipment;
the second information processing step that performs the processing of various information in the portal server, the second screen display step that displays information-processed information on the screen, the second key input/pointing process that inputs the information necessary for information processing with the key or by the pointing device on the screen, the second printing step that prints information-processed contents, the second communication step that communicates information-processed contents via the network, the twenty-first storage step that stores the mail address and recovery cartridge information of the communication information equipment connected to the portal server in the second mail address database, the twenty-second storage step that stores the delivery store of the consumable goods in the second delivery store database for each area, the twenty-third storage step that stores the information of the mail order center that is connected to the portal server and in which the order issue of the consumable goods is given in the second mail order center registration information database, the twenty-fourth storage step that stores individual merchandise price information in the second consumable goods price database for each mail order center, in said portal server;
the third information processing step that performs the electronic settlement based on the authentication information input according to the first processing input on said communication information equipment, the third screen display step that displays information-processed information on the screen, the third key input/pointing step that inputs the information necessary for information processing with the key or by the pointing device on the screen, the third printing step that prints information-processed contents, the third communication step for communicating the information necessary for performing the electronic settlement, the third storage step that stores the data necessary for performing the electronic settlement, in said electronic settlement server;
the fourth information processing step that performs the processing of various information in the nail order center server, the fourth screen display step that displays information-processed on the screen, the fourth key input/pointing step that inputs the information necessary for information processing with the key or by the pointing device, the fourth printing step that prints information-processed contents, the fourth communication step that communicates the information-processed contents via the network, the 41st storage step that stores the merchandise data necessary for the mail order including the price and the stock quantity controlled in the mail order center in the fourth merchandise database, the 42nd storage step that stores the customer information of the customer of which order is requested in the fourth customer management database, the 43rd storage step the order table of which the order is given in the fourth order table database, the fifth information processing step that performs the processing of various information in the recycling plant server, in said mail order center server;
the fifth screen display step that displays information-processed information on the screen, the fifth key input/pointing step that inputs the information necessary for information processing with the key or by the point device on the screen, the fifth printing step that prints information-processed contents, the fifth communication step that communicates the information-processed information contents via the network, the fifth cartridge owner reading step that reads the owner information stored in the storage area of the cartridge recovered in a recycling plant, the fifth cartridge information reading step that links and stores the number of recovery cartridges and the owner information, in said recycling plant server; and
the sixth information processing step that performs the processing of various information in the merchandise control center server, the sixth screen display step that displays information-processed information on the screen, the sixth key input/pointing step that inputs the information necessary for information processing, the sixth printing step that prints information-processed contents, the sixth communication step that communicates the information-processed contents via the network, and the sixth merchandise inventory step that records the merchandise inventory control information of the consumable goods, in said merchandise control center.

20. The online shopping method by the server that controls the status of use of said consumable goods the first consumable goods that handles the consumable goods offers, further comprising:
calculation step that receives the status of use of the consumable goods used in the printing device via the predetermined communication line; and
compensation decision step that decides the compensation based on said discount price, paid to said second consumable goods trader in accordance with the fact that said customer purchases the merchandise the second consumable goods trader offers at the discount price based on said point via the predetermined communication line.

21. A program for realizing the consumable goods online shopping system that comprises communication information equipment that consumes consumable goods, the portal server to which data is sent from said communication information equipment, the electronic settlement server that performs the settlement of the transaction performed in said communication information equipment, the mail order center server for mail-ordering the consumable goods, the recycling plant server installed in the recycling plant of the consumable goods, and the merchandise control center server installed in the merchandise control center of the consumable goods that interconnect via the network, wherein the program the computer execute:
the first information processing step that performs the processing of various information in the communication information equipment, the first screen display step that displays information-processed information on the screen, the first key input/pointing step that inputs the information necessary for information processing with the key/by the pointing device on the screen, the first printing step that prints information-processed information, the first communication step that communicates the information-processed contents via the network, the first consumable goods consumption execution step that executes the processing which consumes the consumable goods, the first consumable goods remaining quantity detection step that detects the remaining quantity of the consumable goods, in said communication information equipment;
the second information processing step that performs the processing of various information in the portal server, the second screen display step that displays information-processed information on the screen, the second key input/pointing process that inputs the information necessary for information processing with the key or by the pointing device on the screen, the second printing step that prints information-processed contents, the second communication step that communicates information-processed contents via the network, the 21st storage step that stores the mail address and recovery cartridge information of the communication information equipment connected to the portal server in the second mail address database, the 22nd storage step that stores the delivery store of the consumable goods in the second delivery store database for each area, the 23rd storage step that stores the information of the mail order center that is connected to the portal server and in which the order issue of the consumable goods is given in the second mail order center registration information database, the twenty-fourth storage step that stores individual merchandise price information in the second consumable goods price database for each mail order center, in said portal server;
the third information processing step that performs the electronic settlement based on the authentication information input according to the first processing input on said communication information equipment, the third screen display step that displays information-processed information on the screen, the third key input/pointing step that inputs the information necessary for information processing with the key or by the pointing device on the screen, the third printing step that prints information-processed contents, the third communication step for communicating the information necessary for performing the electronic settlement, the third storage step that stores the data necessary for performing the electronic settlement, in said electronic settlement server;
the fourth information processing step that performs the processing of various information in the nail order center server, the fourth screen display step that displays information-processed on the screen, the fourth key input/pointing step that inputs the information necessary for information processing with the key or by the pointing device, the fourth printing step that prints information-processed contents, the fourth communication step that communicates the information-processed contents via the network, the 41st storage step that stores the merchandise data necessary for the mail order including the price and the stock quantity controlled in the mail order center in the fourth merchandise database, the 42nd storage step that stores the customer information of the customer of which order is requested in the fourth customer management database, the 43rd storage step the order table of which the order is given in the fourth order table database, the fifth information processing step that performs the processing of various information in the recycling plant server, in said mail order center server;
the fifth screen display step that displays information-processed information on the screen, the fifth key input/pointing step that inputs the information necessary for information processing with the key or by the point device on the screen, the fifth printing step that prints information-processed contents, the fifth communication step that communicates the information-processed information contents via the network, the fifth cartridge owner reading step that reads the owner information stored in the storage area of the cartridge recovered in a recycling plant, the fifth cartridge information reading step that links and stores the number of recovery cartridges and the owner information, in said recycling plant server; and
the sixth information processing step that performs the processing of various information in the merchandise control center server, the sixth screen display step that displays information-processed information on the screen, the sixth key input/pointing step that inputs the information necessary for information processing, the sixth printing step that prints information-processed contents, the sixth communication step that communicates the information-processed contents via the network, and the sixth merchandise inventory step that records the merchandise inventory control information of the consumable goods, in said merchandise control center.

22. The program executed by the server that controls the status of use of said consumable goods the first consumable goods trader who handles the consumable goods offers, wherein the program makes the computer execute:
calculating means that receives the status of use of the consumable goods used in the printing device via the predetermined communication line and calculates the point against the customer in accordance with the received status of use; and
compensation deciding means that decides compensation that is based on the reduced price, paid to said second consumable goods trader in accordance with the fact that said customer purchases the merchandise the second consumable goods trader offers at said reduced price that is based on said point via the predetermined purchase screen.

23. A recording medium of which the contents can be read, in which a program code for realizing the consumable goods online shopping system is stored, and that comprises communication information equipment that consumes consumable goods, the portal server to which data is sent from said communication information equipment, the electronic settlement server that performs the settlement of the transaction performed in said communication information equipment, the mail order center server for mail-ordering the consumable goods, the recycling plant server installed in the recycling plant of the consumable goods, and the merchandise control center server installed in the merchandise control center of the consumable goods that interconnect via the network, comprising:
the first information processing step that performs the processing of various information in the communication information equipment, the first screen display step that displays information-processed information on the screen, the first key input/pointing step that inputs the information necessary for information processing with the key/by the pointing device on the screen, the first printing step that prints information-processed information, the first communication step that communicates the information-processed contents via the network, the first consumable goods consumption execution step that executes the processing which consumes the consumable goods, the first consumable goods remaining quantity detection step that detects the remaining quantity of the consumable goods, in said communication information equipment;
the second information processing step that performs the processing of various information in the portal server, the second screen display step that displays information-processed information on the screen, the second key input/pointing process that inputs the information necessary for information processing with the key or by the pointing device on the screen, the second printing step that prints information-processed contents, the second communication step that communicates information-processed contents via the network, the 21st storage step that stores the mail address and recovery cartridge information of the communication information equipment connected to the portal server in the second mail address database, the 22nd storage step that stores the delivery store of the consumable goods in the second delivery store database for each area, the 23rd storage step that stores the information of the mail order center that is connected to the portal server and in which the order issue of the consumable goods is given in the second mail order center registration information database, the twenty-fourth storage step that stores individual merchandise price information in the second consumable goods price database for each mail order center, in said portal server;
the third information processing step that performs the electronic settlement based on the authentication information input according to the first processing input on said communication information equipment, the third screen display step that displays information-processed information on the screen, the third key input/pointing step that inputs the information necessary for information processing with the key or by the pointing device on the screen, the third printing step that prints information-processed contents, the third communication step for communicating the information necessary for performing the electronic settlement, the third storage step that stores the data necessary for performing the electronic settlement, in said electronic settlement server;
the fourth information processing step that performs the processing of various information in the nail order center server, the fourth screen display step that displays information-processed on the screen, the fourth key input/pointing step that inputs the information necessary for information processing with the key or by the pointing device, the fourth printing step that prints information-processed contents, the fourth communication step that communicates the information-processed contents via the network, the 41st storage step that stores the merchandise data necessary for the mail order including the price and the stock quantity controlled in the mail order center in the fourth merchandise database, the 42nd storage step that stores the customer information of the customer of which order is requested in the fourth customer management database, the 43rd storage step the order table of which the order is given in the fourth order table database, the fifth information processing step that performs the processing of various information in the recycling plant server, in said mail order center server;
the fifth screen display step that displays information-processed information on the screen, the fifth key input/pointing step that inputs the information necessary for information processing with the key or by the point device on the screen, the fifth printing step that prints information-processed contents, the fifth communication step that communicates the information-processed information contents via the network, the fifth cartridge owner reading step that reads the owner information stored in the storage area of the cartridge recovered in a recycling plant, the fifth cartridge information reading step that links and stores the number of recovery cartridges and the owner information, in said recycling plant server; and
the sixth information processing step that performs the processing of various information in the merchandise control center server, the sixth screen display step that displays information-processed information on the screen, the sixth key input/pointing step that inputs the information necessary for information processing, the sixth printing step that prints information-processed contents, the sixth communication step that communicates the information-processed contents via the network, and the sixth merchandise inventory step that records the merchandise inventory control information of the consumable goods, in said merchandise control center.

24. The recording medium of which the contents can be read by the computer, in which the program code for storing the program code read by the server that controls the status of use of said consumable goods the first consumable goods that handles the consumable goods offers, wherein the recording medium stores the program and executes:
calculating means that receives the status of use of the consumable goods used in the printing device via the predetermined communication line and calculates the point against the customer in accordance with the received status of use; and
compensation deciding means that decides compensation that is based on the reduced price, paid to said second consumable goods trader in accordance with the fact that said customer purchases the merchandise the second consumable goods trader offers at said reduced price that is based on said point via the predetermined purchase screen.
